(19) United States
(12) Patent Application Publication
(10) Pub. No.: US 2011/0074552 A1
(43) Pub. Date: Mar. 31, 2011

(54) APPARATUS AND METHOD FOR ADVANCED COMMUNICATION IN LOW-POWER WIRELESS APPLICATIONS

(75) Inventors: JOHN PETER NORAIR, Palo Alto, CA (US); NIKOLA CARGONJA, San Carlos, CA (US); JOSEPH S. M HO, Sunnyvale, CA (US)

(73) Assignee: Savi Technology, Inc.

(21) Appl. No.: 12/893,790

(22) Filed: Sep. 29, 2010

Related U.S. Application Data
(60) Provisional application No. 61/246,615, filed on Sep. 29, 2009.
(60) Provisional application No. 61/320,382, filed on Apr. 2, 2010.

(51) Int. Cl. H04Q 5/22

(52) U.S. Cl. 340/10.1

(57) ABSTRACT

A low power device is presented. In some embodiments, the low power device communicates with other devices utilizing transport channels defined from combinations of a plurality of physical channels. In some embodiments, the low power device communicates with other devices utilizing packets that includes a preamble, a header with a sync and frame info, and a frame. The frame, for example, can be a wake-up frame, a request frame, a response frame, or one or more data frames. In some embodiments, the wake-up frame can include a count-down integer indicating the number of wake-up frames before a request frame is sent. In some embodiments, arbitration may be utilized between devices responding to a request. In some embodiments, specific requests commands can be included in the request frame and corresponding response frames are responsive to the commands.

### RELATED APPLICATIONS

The present disclosure claims priority to U.S. Provisional Patent Ser. No. 61/246,615, filed on Sep. 29, 2009, and to U.S. Provisional Patent Ser. No. 61/320,382, filed on Apr. 2, 2010, both of which are herein incorporated by reference in their entirety.

### BACKGROUND

1. Technical Field

Embodiments of the present invention relate to communications in low-power wireless applications.

2. Description of the Related Arts

Low-power wireless devices such as, for example, radio frequency (RF) tags have been in use for some time. Radio-frequency identification (RFID) systems typically include interrogators that communicate with tags. Tags are typically attached to an article such as a shipping container or a package that is being shipped. The interrogator, then, can inventory the articles that are within its range.

Generally, an RFID tag system will include a number of tags that are attached to an asset such as a piece of inventory or a shipping asset. RFID tags include a transceiver to transmit and receive signals as well as a processor to process incoming signals from an interrogator and provide responses to the interrogator. As such, an interrogator can poll the tags that are within its range. The interrogator, then, can monitor tags as they arrive or leave an area of interest. The reader, then, periodically polls the tags within its range. Alternatively, tags can be monitored as they transit a particular area. The bandwidth of the interrogator and its range limits the number of tags that can be monitored by any given reader.

Additionally, tags have limited power sources. Active tags are typically powered by a battery, which may be depleted with frequent use. To solve this problem, tags can have active and inactive modes of operation. Therefore, tags need to operate in a power efficient and power saving mode. Some current interrogator and tag systems conform to ISO 18000-7, referred to as Mode 1 tags. However, there is a limit to the capabilities of such a system.

Therefore, what is needed is a communication system that preserves the power in a low-power device while providing for monitor of a high number of such devices.

### SUMMARY

In accordance with the present invention, a device can include a memory capable of storing data and program instructions; a processor coupled to the memory; and a transceiver coupled to the processor to receive digital data and control signals, the control signals including a transport channel signal, the transceiver coupled to transmit data over one or more transport channels, the transport channels being defined as a combination of one or more physical channels chosen from a plurality of physical channels. A method of communicating with another device according to some embodiments includes defining one or more transport channels as combinations of a plurality of physical channels; and transmitting or receiving signals on the one or more transport channels.

A device according to some embodiments may include a transceiver capable of communicating wirelessly with other devices; a processor coupled to a memory and to the transceiver, the processor operating such that the device is in one of one or more regimes, the one or more regimes chosen from a group consisting of a gateway regime, a subcontroller regime, and an endpoint regime. A method of operating a low power device according to some embodiments of the present invention includes operating in one of one or more regimes, the one or more regimes chosen from the group consisting of a gateway regime, a subcontroller regime, and an endpoint regime.

A device according to some embodiments can include a processor coupled to a memory; and a transceiver coupled to the processor, wherein the device wirelessly communicates with other devices utilizing packets, wherein each of the packets includes a preamble, a header that includes a sync and a frame info, and a frame. A method of communicating with a device includes exchanging packets from the device, the packet including a preamble, a header that includes a sync and frame info, and a frame.

A device according to some embodiments can include a processor coupled to a memory; and a transceiver coupled to the processor, wherein the device wirelessly communicates with other devices utilizing packets, wherein each of the packets includes a preamble, a header that includes a sync and a frame info, and a frame, the packets being characterized as a request packet that includes a request frame, a response packet that includes a response frame, or a data packet that includes one or more data frames.

A device according to some embodiments can include a processor; a memory coupled to the processor, wherein the memory stores data elements and programming; and a transceiver coupled to the processor, the transceiver allowing wireless communications with one or more other devices.

A device according to some embodiments can include a processor coupled to a memory; a transceiver that wirelessly communicates with one or more other devices, wherein the device transmits and receives packets that include frames to the one or more other devices, the frames including request frames or response frames and that include: a header that includes a protocol ID, a frame length, device flags, and a session ID; a command code that includes an extension flag, a sleep flag, a routing type, and an opcode; and a routing template consistent with the routing type.

A method of activating a RFID device from a sleep state according to some embodiments includes receiving a wake-on signal on a wake-on radio; transitioning the RFID device to a listen state or a transmit state in response to the wake-on signal.

A method of activating an RFID device from a hold state according to some embodiments of the invention includes transitioning to a listen state if the hold state is asynchronous and a previous state was a transmit or receive state; transitioning to an idle state if the hold state is asynchronous and the previous state was a listen state; transitioning to a listen state if the hold state is asynchronous and a timeout condition has occurred or transitions to an idle state if the hold state is synchronous and the timeout condition has occurred; transitioning to a transmit state if a hold period has expired and the hold state is synchronous; and transitioning to a listen state if a hold period has expired and a wake-up frame is detected.

A method of performing a dialog between a requesting RFID device and one or more responding RFID devices according to some embodiments of the invention includes the requesting RFID device providing a chain of wake-up packets and transmitting a request frame in a request packet on one of a plurality of transport channels; the responding RFID devices activating upon receipt of a wake-up frame from the chain of wake-up packets and receiving the request packet; the responding RFID devices each transmitting a response packet to the requesting RFID device.

A method of receiving data from a responding device according to some embodiments includes sending a request frame to the responding device; receiving a response frame from the responding device; receiving one or more data frames from the responding device; and acknowledging receipt of the one or more data frames.

A method of transmitting data to a responding device according to some embodiments includes sending a request frame to the responding device; receiving a response frame from the responding device; sending one or more data frames to the responding device; and receiving an acknowledgement from the responding device.

These and other embodiments are further described below with reference to the following figures.

### BRIEF DESCRIPTION OF THE DRAWINGS

FIG. 1(a) illustrates an RFID system according to some embodiments of the present invention.

FIG. 1(b) illustrates RFID devices as shown in FIG. 1(a) operating in various regimes according to some embodiments of the present invention.

FIG. 2 illustrates a reader according to some embodiments of the present invention.

FIG. 3 illustrates a device according to some embodiments of the present invention.

FIG. 4 illustrates a transceiver according to some embodiments of the present invention.

FIG. 5 illustrates the spectral density of some defined transport channels with respect to the physical channels.

FIG. 6 illustrates an embodiment of a forward error correction block that can be utilized in encoding according to some embodiments of the present invention.

FIG. 7 illustrates an embodiment of a data whitening block that can be utilized in encoding according to some embodiments of the present invention.

FIG. 8(a) illustrates an embodiment of a state diagram associated with operation of a hold state according to some embodiments of the present invention.

FIGS. 8(b) and 8(c) illustrate embodiments of state diagrams illustrating operation of a wakeup operation according to some embodiments of the present invention.

FIG. 9 illustrates an embodiment of a state machine associated with an endpoint regime according to some embodiments of the present invention.

FIG. 10 illustrates an embodiment of a state machine associated with a subcontroller regime.

FIG. 11 illustrates an embodiment of a state machine associated with a gateway regime.

FIG. 12 illustrates an embodiment for a packet structure for frame packet types according to some embodiments of the present invention.

FIG. 13 illustrates a packet train for a wakeup frame according to some embodiments of the present invention.

FIG. 14 illustrates both a request frame packet and a response frame packet according to some embodiments of the present invention.

FIG. 15 illustrates a data frame packet according to some embodiments of the present invention.

FIG. 16 shows an example state diagram for scheduled wakeup events according to some embodiments of the present invention.

FIG. 17 shows an example of a state diagram for non-arbitrated channel collision avoidance according to some embodiments of the present invention.

FIG. 18 shows an example of a state diagram for arbitrated channel collision avoidance according to some embodiments of the present invention.

FIG. 19 shows the timing of arbitrated channel collision avoidance according to some embodiments of the present invention.

FIGS. 20(a) through 20(d) illustrate dialog routing types according to some embodiments of the present invention.

FIGS. 20(e) and 20(f) illustrate an extended dialog with unicast and multicast routing, respectively.

FIG. 21(a) illustrates a request and response frame according to some embodiments of the present invention.

FIG. 21(b) illustrates an error response frame according to some embodiments of the present invention.

FIG. 21(c) illustrates a data frame according to some embodiments of the present invention.

FIG. 21(d) illustrates an embodiment of a mode 2 frame protocol header.

FIG. 21(e) illustrates an embodiment of a mode 2 frame protocol command code.

FIG. 21(f) illustrates an embodiment of a command extension byte for a mode 2 frame protocol command code.

FIGS. 22(a) and 22(b) illustrate embodiments of a broadcast request template and broadcast response template, respectively.

FIGS. 23(a) and 23(b) illustrate embodiments of a unicast request template and a unicast response template, respectively.

FIGS. 24(a) and 24(b) illustrate embodiments of a multicast initial request template and a multicast arbitration request template, respectively.

FIGS. 25(a) and 25(b) illustrate embodiments of an anycast request template and an anycast response template, respectively.

FIGS. 26(a) and 26(b) illustrate embodiments of an inventory from device ID request and response, respectively.

FIGS. 27(a) and 27(b) illustrate embodiments of an inventory from UDB element request and response, respectively.

FIGS. 28(a) and 28(b) illustrate embodiments of a collection of UDB element request and response, respectively.

FIGS. 29(a) and 29(b) illustrate embodiments of a collection of UDB type request and response, respectively.

FIGS. 30(a), 30(b), and 30(c) illustrate embodiments of an announcement of UDB element request, an announcement of UDB type request, and an announcement response, respectively.

FIGS. 31(a) and 31(b) illustrate embodiments of a request data frame and a propose data frame dialog sequence, respectively.

FIG. 31(c) illustrates an embodiment of a state diagram of a data frame dialog.

FIGS. 32(a) and 32(b) illustrate embodiments of a request data frame and a corresponding response frame, respectively.

FIGS. 32(c) and 32(d) illustrate embodiments of a propose data frame and a corresponding response frame, respectively.

FIGS. 32(e) and 32(f) illustrate embodiments of an acknowledge data frame and a corresponding response frame, respectively.

FIGS. 33(a) and 33(b) illustrate embodiments an authentication frame and a corresponding response frame, respectively.

FIGS. 34(a) and 34(b) illustrate embodiments of an encapsulated UDB protocol command structure and an encapsulated UDB protocol response, respectively.

FIGS. 35(a), 35(b), and 35(c) illustrate embodiments of an UDB element data group, an UDB type data group, and an UDB privileges data group, respectively.

FIGS. 36(a), 36(b), and 36(c) illustrate embodiments of an encapsulated RDB protocol command structure sector access request, an encapsulated protocol command structure for a privilege code request, and a corresponding response, respectively.

FIGS. 37(a) and 37(b) illustrate embodiments of an RDB element data group and an RDB privileges data group, respectively.

In the figures, elements given the same designation have the same or similar functions.

### DETAILED DESCRIPTION OF EMBODIMENTS

The figures and the following description relate to some embodiments by way of illustration only. It should be noted that from the following discussion, alternative embodiments of the structures and methods disclosed herein will be readily recognized as viable alternatives that may be employed without departing from the principles of the embodiments described herein.

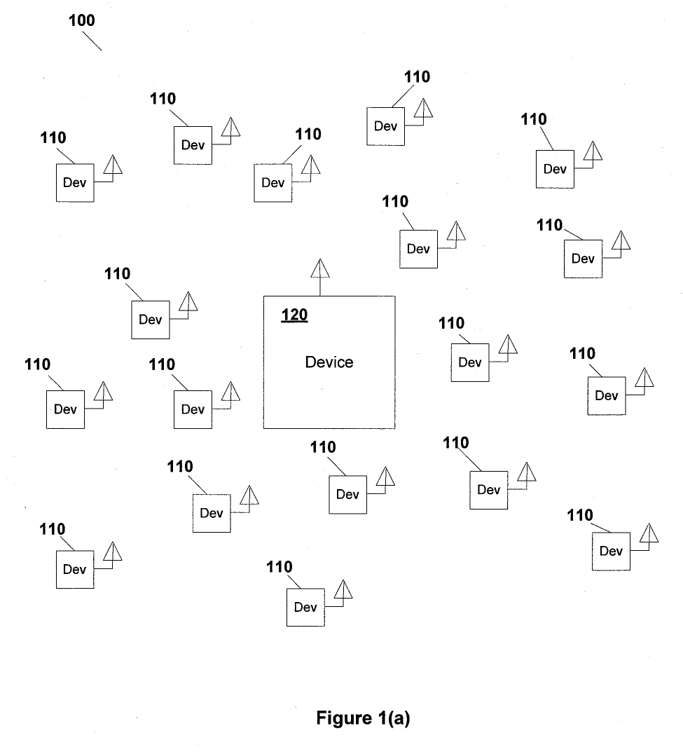

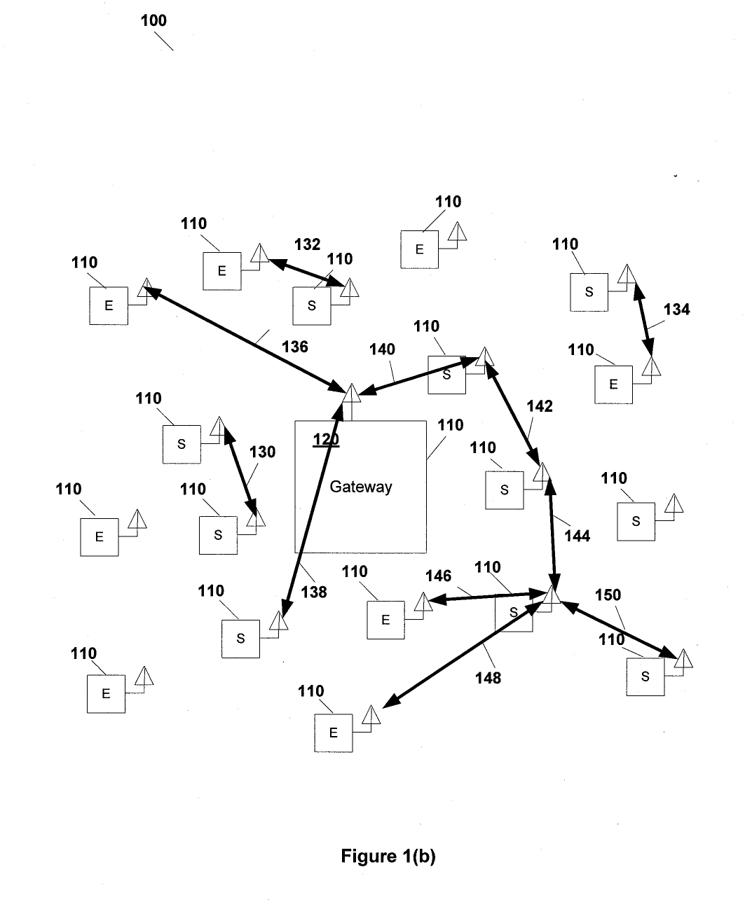

FIG. 1(a) illustrates a RFID system 100 according to some embodiments of the present invention. As shown in FIG. 1(a), any number of devices 110 can be located in an area, where one of devices 110 is a reader 120. Reader 120 is one of devices 110 that performs the function of a reader. Reader 120 communicates with one or more of devices 110 wirelessly in order to read or write information from the one or more devices 110. In some embodiments, reader 120 communications with the one or more devices 110, and devices 110 communicate with one another, utilizing a multi-channel system. Furthermore, various modulations can be utilized, for example Frequency Shift Keying (FSK) or Gaussian Filtered Frequency Shift Keying (GFSK). In general, any suitable modulation method can be utilized. Filtering can be utilized in order to limit the energy of each channel to its band and to provide a good power-spectral-density (PSD). Embodiments utilizing GFSK are capable of both limiting the out-of-band power and providing good PSD in the band.

Although specific examples of aspects of system 100 and of devices 110 are provided below, specific examples are provided only to facilitate better understanding of aspects of the present invention. It is to be understood that other arrangements than those specifically described can be implemented while remaining within the scope of this disclosure.

In general, devices 110 in system 100 can be described in terms of a Physical Layer (the PHY layer) that is controlled according to certain protocols by a Media Access Control layer (the MAC layer). The PHY layer enables the transmission of data bits over the radio frequency band, and describes the actual hardware and functioning of each of devices 110. The MAC layer describes the controls of the PHY layer, enables multiple devices and functions to share the same PHY layer, and typically is embodied in software that is executed by a processor on device 110. In addition to the PHY layer and the MAC layer, system 100 is further described in terms of data elements and protocols that are supported by devices 110.

In the PHY layer, some embodiments of the present invention operate within the 433.05 to 434.79 MHz band corresponding to the ISM Region 1 band and the FCC band. In some embodiments, a dynamic transport channel system utilizing a plurality of physical channels help to increase throughput and allow the inclusion of more devices 110 in system 100. The operating band can be sliced into smaller physical channels. For example, the ISM Region 1 band can be partitioned into a plurality, for example 6 or 8, physical channels. A transport channel refers to a combination of one or more physical channels utilize to carry data. Multiple physical channels can be combined into a transport channel in order to achieve higher data rates.

Modulation schemes that result in small side lobes and good detectability can be utilized. For example, some embodiments of the present invention can utilize a filtered frequency shift keying modulation (FSK), for example Gaussian FSK (GFSK). Other modulation such as amplitude shift keying (ASK), and minimum shift keying (MSK) can be utilized. Small sidelobes are important for systems that utilize multiple transport channels.

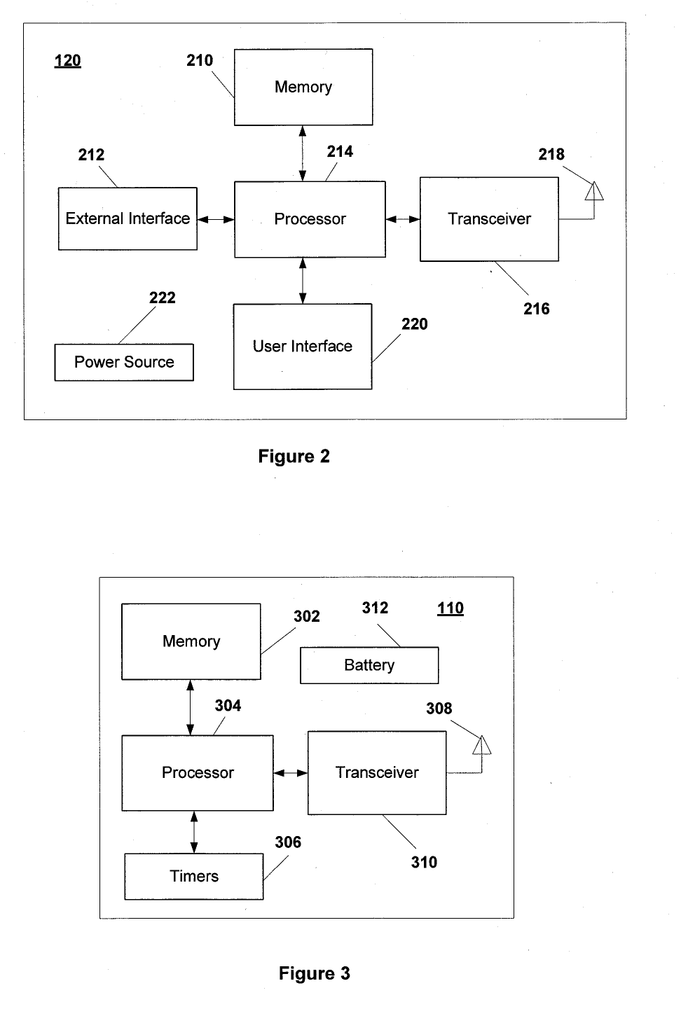

FIG. 2 illustrates an embodiment of a device 110 that can be utilized as a reader 120 according to some embodiments of the present invention. As shown in FIG. 2, reader 120 can utilize a processor 214, which may be a microcontroller, coupled to a transceiver 216. Transceiver 216 receives digital data from processor 214, modulates and encodes the digital data according to the modulation and encoding schemes, and transmits that data through antenna 218. Transceiver 216 also receives signals from antenna 218 and demodulates and decodes the received signals to provide digital data to processor 214. As shown in FIG. 214, processor 214 is coupled to memory 210. Memory 210 can be volatile memory, non-volatile memory, or a combination of volatile and non-volatile memory. As such, memory 210 can be utilized to store programming for processor 214 as well as storing data according to the programming.

Processor 214 may also be coupled to a user interface 220 or an external interface 212. User interface 220 may provide visual and audio signals to a user that convey information regarding the status of reader 120, the presence of devices 110, or the contents of data received from devices 110. External interface 212 can be coupled to another device in order to download data stored in memory 210, provide data that is to be uploaded to one or more of devices 110, update programming of processor 214, or otherwise reconfigure reader 120. Reader 120 is powered by power source 222, which can be a battery in the case of a handheld device or may be a coupling to an external power source such as a stationary reader.

Several modes of operation can be utilized for communications between reader 120 and devices 110. For example, normal and turbo modes can be utilized. In FSK modulation, the frequency difference Δf between the higher and lower frequencies is related to the bit rate that is transmitted by the band. In general, Δf=β(Bit_Rate) where β is the modulation index. In general, larger β results in much lower bit-error rates (BER). However, lower β results in the ability to transmit much higher Bit-Rates for a given frequency deviation. As an example, in some embodiments in normal mode the modulation index can be about 1.8, while in turbo mode the modulation index can be about 0.5. The operative lower limit for β is 0.5, resulting in noisy transmission of data with a resulting high BER. Tables 1 and 2 below provide some example performance parameters for particular examples of normal and turbo mode operation according to some embodiments of the present invention.

TABLE 1
Normal Mode

| Parameter | Min | Typical | Max | Units |
|---|---|---|---|---|
| FSK Modulation Index β | 1.8 | 1.8 | 1.8 | |
| GFSK Reference Bandwidth Time | 0.5 | 1.0 | 1.0 | |
| (BT) | | | | |
| FSK Frequency Deviation | 49 | 50 | 51 | kHz |
| Channel-Relative Carrier Frequency | f_{c} − 6 | f_{c} | f_{c} + 6 | kHz |
| NRZ Data Rate | 54.734 | 55.555 | 56.388 | kbps |
| Peak-to-Stopband Power | 30 | | | dB |
| Radiated Stopband power | | | −40 | dBm |
| Radiated Transmission Power | | 0 | 10 | dBm |

TABLE 2
Turbo Mode

| Parameter | Min | Typical | Max | Units |
|---|---|---|---|---|
| FSK Modulation Index β | 0.5 | 0.5 | 0.5 | |
| GFSK Reference Bandwidth Time | 0.5 | 1.0 | 1.0 | |
| (BT) | | | | |
| FSK Frequency Deviation | 49 | 50 | 51 | kHz |
| Channel-Relative Carrier Frequency | f_{c} − 3 | f_{c} | f_{c} + 3 | kHz |
| NRZ Data Rate | 196.00 | 200.00 | 204.00 | kbps |
| Peak-to-Stopband Power | 30 | | | dB |
| Radiated Stopband power | | | −50 | dBm |
| Radiated Transmission Power | | 0 | 10 | dBm |

A modulation index β=1.8 can have unique properties that give it the advantage of both narrow band and wideband FSK. Such a modulation has been utilized successfully for satellite communications where low power and long range are important objectives. The modulation index β=0.5 is a narrowband FSK that can be prone to interference, but allows for the maximum speed available. MSK modulation may do a bit better than FSK with modulation index β=0.5, about a 230 data rate, but may not be a great improvement.

FIG. 3 illustrates another example embodiment of device 110 according to some embodiments of the present invention. As shown in FIG. 3, device 110 includes a processor 304 coupled to a transceiver 310. Transceiver 310 receives digital data from processor 304, encodes and modulates that data for transmission, and transmits the encoded and modulated signal through antenna 308. Transceiver 310 also receives incoming signals through antenna 308, retrieves the digital data, and transmits the received data to processor 304. Processor 304 can be coupled to a memory 302. Memory 302 can be volatile memory, non-volatile memory, or a combination of volatile and non-volatile memory and stores programming and data for processor 304. Memory 302 can be of any size, depending on the overall functionality of device 110, and may include sufficient data storage memory to store information regarding the article to which device 110 may be attached.

As is further shown in FIG. 3, processor 304 may be coupled to one or more timers 306. Timers 306 can control wake-up signals for processor 304, waking device 110 up to check for incoming signals in a scan process. Device 110 is powered by a battery 312. In order to conserve power, device 110 remains in an inactive state until activated, or wakes up, as a response to a signal such as that from timers 306.

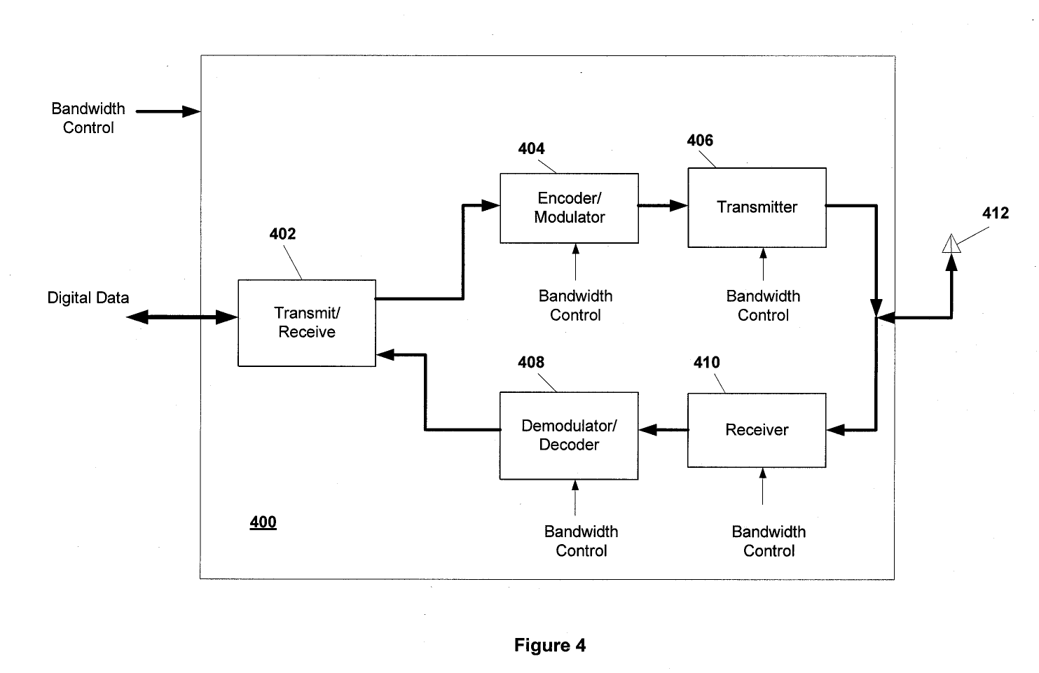

FIG. 4 illustrates an example transceiver 400 that can be utilized as transceiver 216 in reader 120 or as transceiver 310 in device 110. As shown in FIG. 4, data is received into transmit/receive multiplexer 402. Transmit/receiver 402 interfaces data between encoder/modulator 404 or demodulator/decoder 408 and a processor. In transmit mode, transmit/receive 402 receives data from a processor such as processor 214 of reader 120 or processor 304 of device 110 and presents it to encoder/modulator 404. In receive mode, transmit/receive 402 provides data to a processor such as processor 214 of reader 120 or processor 304 of device 110 from demodulator/decoder 408.

As discussed above, filtered FSK modulation is beneficial because it is similar to more conventional systems, or legacy systems. At 55.55 kcps, with modulation index of 1.8, the signal fits within a 216 kHz band and has good wide-band attributes. At 200 kcps, with modulation index of 0.5, the signal fits within a 432 kHz band, which is two adjacent 216 kHz bands. Further, Gaussian filter FSK (GFSK) is attractive because it is inexpensive to implement. In some embodiments, the particular modulation utilize in a given dialog may be dynamically chosen in device 110.

However, other modulations can be utilized, as discussed above. ASK utilizes a higher transmission power and does not offer a signal-to-noise ratio (SNR) as attractive as FSK, but is also rather inexpensive to implement. MSK is similar to GFSK with modulation index of 0.5, but has reduced inter-symbol interference. MSK modulation has slightly better stop-band attenuation as well. However, MSK has a higher complexity.

Quadrature phase shift keying (QPSK) may also be utilized and has a higher SNR and bandwidth efficiency than GFSK or MSK. However, QPSK has large sidelobes in the power distribution and is relatively costly to implement in terms of receive and transmit power.

In some embodiments, a single chip rate per packet can be utilized. In some embodiments, an encoding scheme is implemented in encoder 404. For example, encoder 404 may implement forward error coding (FEC) or PN9 data whitening. FEC and PN9 encoding may result in better coding gain than Manchester encoding in some embodiments, however some embodiments may utilize Manchester encoding, NRZ encoding, or 8b10b encoding. In some embodiments, an adaptive data rate can be utilized. For example, a single physical channel may be utilized for long range transport with high reliability while a double channel may be utilized for high speed short range. Encoding and adaptive data rate can allow better system performance for long and short range applications.

In transmit mode, transmit/receive 402 provides digital data to encoder/modulator 404. Encoder/modulator 404 then provides data to transmitter 406. Transmitter 406 provides signals that are transmitted through antenna 412.

In receive mode, signals from antenna 412 are provided to receiver 410, which provides data to demodulator/decoder 408. Demodulator/decoder 408 then provides the received digital data to transmit/receive 402 after performing a decoding process appropriate for the encoding performed in encoder/modulator 404.

The functions of transceiver 400 can be performed in software, hardware, or a combination of software and hardware. In some embodiments, transceiver 400 may include a separate processor to perform some of the functions of transceiver 400. In other embodiments, the same processor that controls the remainder of the device can also perform functions for transceiver 400. For example, in device 110 shown in FIG. 3, processor 304 can perform some of the functions described in transceiver 400 shown in FIG. 4 related to transceiver 310. Similarly, in receiver 120 shown in FIG. 2, some of the functions described as transceiver 210 may be performed by processor 214.

Transmitter 406 may utilize a number of physical channels to transmit signals through antenna 412. Table 3, for example, provides for eight physical channels in a 1.728 MHz range within the 433 MHz ISM band. The eight physical bands are each 216 kHz in width. The overall scope of the allowable frequency bands as well as the channels themselves may be regulated by different regulatory bodies. In general, any number of bands utilizing any range of frequencies can be utilized. Table 4 illustrates another allocation of physical bands in the 433 MHz ISM band. In the embodiment illustrated in FIG. 4, there are six physical channels with each channel having a width of 290 kHz. Some embodiment of the invention may include any number of physical channels. For example, seven channels can be defined in the 433 MHz ISM band with a width of about 248 kHz.

TABLE 3
216 kHz Physical Channel

| Physical Channel | Start Frequency (MHz) | End Frequency (MHz) |
|---|---|---|
| 1 | 433.056 | 433.272 |
| 2 | 433.272 | 433.488 |
| 3 | 433.488 | 433.704 |
| 4 | 433.704 | 433.920 |
| 5 | 433.920 | 434.136 |
| 6 | 434.136 | 434.352 |
| 7 | 434.352 | 434.568 |
| 8 | 434.568 | 434.784 |

TABLE 4
290 kHz Physical Channel

| Physical Channel | Start Frequency (MHz) | End Frequency (MHz) |
|---|---|---|
| 1 | 433.050 | 433.340 |
| 2 | 433.340 | 433.630 |
| 3 | 433.630 | 433.920 |
| 4 | 433.920 | 434.210 |
| 5 | 434.210 | 434.500 |
| 6 | 434.500 | 434.790 |

In addition to the physical channels, transmitter 406 and receiver 410 receive a signal Bandwidth Control that indicates a transport channel to be utilized. A transport channel is assigned the spectrum of one or more physical channels. A transport channel that utilizes more than one physical channel can support higher data rate than one that utilizes a single physical channel. Different transport channels can also support different modulation and coding schemes. As examples of the definition of transport channels with respect to physical channels, Table 5 defines a set of transport channels utilizing the physical channels defined in Table 3 and Table 6 defines a set of transport channels utilizing the physical channels defined in Table 4. In a transport of sequential messages, any transport channel can be utilized sequentially. For example, Transport channels 01 and 02 as defined in Table 5 may be utilized sequentially with transport channel 09.

TABLE 5
Transport Channel

| Transport Channel | Physical Channel |
|---|---|
| 0x00 | 4 + 5 |
| 0x01 | 1 |
| 0x02 | 2 |
| 0x03 | 3 |
| 0x04 | 4 |
| 0x05 | 5 |
| 0x06 | 6 |
| 0x07 | 7 |
| 0x08 | 8 |
| 0x09 | 1 + 2 |
| 0x0A | 2 + 3 |
| 0x0B | 3 + 4 |
| 0x0C | 4 + 5 |
| 0x0D | 5 + 6 |
| 0x0E | 6 + 7 |
| 0x0F | 7 + 8 |
| 0x10 | 4 + 5 |

TABLE 6
Transport Channel

| Transport Channel | Physical Channel |
|---|---|
| 0x00 | 1 + 2 |
| 0x01 | 1 |
| 0x02 | 2 |
| 0x03 | 3 |
| 0x04 | 4 |
| 0x05 | 5 |
| 0x06 | 6 |
| 0x09 | 1 + 2 |
| 0x0A | 2 + 3 |
| 0x0B | 3 + 4 |
| 0x0C | 4 + 5 |
| 0x0D | 5 + 6 |
| 0x10 | 3 + 4 |

In each definition of transport channel, the center frequency of the transport channel is the average frequency: (upper frequency of the highest physical channel+lower frequency of the lowest physical channel)/2. In some embodiments, use of channel 00 in a definition such as that provided in Table 5 may be avoided due to its overlap with transport channels 0C and 10. In some regulatory environments, usage of the band may be restricted, for example use of the 433 band may be restricted to a narrow area around 433.920 MHz, in which case the 00 transport channel may be utilized. In such cases, the outer regions of the 00 band may not be utilized. Despite the logical channel boundaries, power spectral density of normal transmitters may fall off considerably beyond about 70 kHz from the center frequency. As a result, the regulatory environments may be readily accommodated.

In some embodiments, one or more transport channels may be utilized to enable co-existence of legacy network channels. As such, in some embodiments systems may be able to utilize devices (e.g., tags) or readers that conform to earlier standards. Turbo modulation, such as that defined with respect to Table 2, for example, may utilize the larger bandwidth available with utilizing two adjacent physical channels.

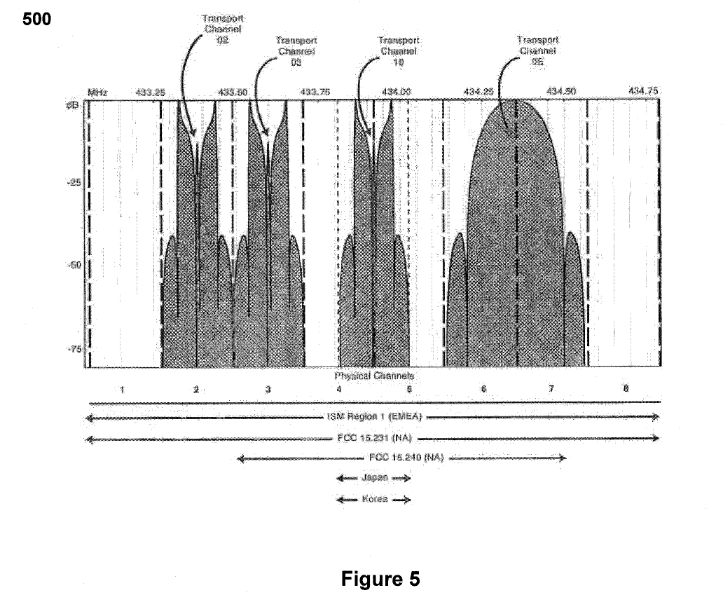

FIG. 5 illustrates an example power spectral density of some of the transport channels illustrated in Table 5. FIG. 5 illustrates physical channels 1 through 8 as illustrated in Table 3 and transport channels 0x02, 0x03, 0x10, and 0x0E. As shown in FIG. 5, there are six (6) active physical channels and four (4) active transport channels. The 0x10 channel can be utilized as a legacy channels with properties that are utilized in older devices. Transport channels 0x02 and 0x03 illustrate normal mode operation with FSK where the separated frequencies are shown. Transport channel 0x0E illustrates a turbo modulation spectrum, which has narrowband attributes of a more rounded spectrum with side-lobes. In some embodiments, moderate sidelobe-to-sidelobe interference can be acceptable and handled by data recovery 408.

In other words, the 433 MHz band can be sliced into physical channels. Each slice can be of an arbitrary width. As illustrated in Table 3, for example, the slices can be 216 kHz each, although Table 4 illustrates a system of physical channels each 290 kHz wide. Transport channels are defined in terms of combinations of physical channels. The transport channels are assigned identification codes, that can be utilized to support the communications throughout system 100. Each transport channel defined, and assigned an identification code, has a particular bandwidth, at a particular center frequency, and can support a particular transmission data rate. As discussed, some embodiments of the invention support multiple transport channels. In some embodiments, system 100 can be compatible with older systems that do not support multiple transport channels.

A physical channel bandwidth of 216 kHz is likely sufficient channel width for conducting, for example, a 55.55 kcps communication without adding too much interference in adjacent channels. Larger bandwidths can be achieved by defining transport channels to combine physical channels. Further, physical channels can be combined to provide for transport channels of larger bandwidth. Additionally, if other data rates (higher or lower) are sought, then the physical channel bandwidths and the transport channel definitions can be chosen accordingly.

As is further illustrated in FIG. 5, single physical channels can have very little overlap with neighboring physical channels. In an example utilizing a GFSK modulation with gaussian filter bandwidth time of 1.0, a ±50 kHz frequency deviation, 1 mW (0 dBm) of output power, and a data rate of 55.55 kcps, 99% of the power can be within 120 kHz bandwidth, that is +/−60 kHz from the center frequency. At 216 kHz bandwidth, that is +/−108 kHz from the center frequency, the attenuation is about 35 dB (−45 dBm). At 290 kHz bandwidth, that is +/−145 kHz from the center frequency, there is about a 50 db attenuation (−50 dBm). This results in low intersymbol interference. As another example with the same parameters but a 200 kcps chip rate, 99% of the power can be within 300 kHz of the center. At 432 kHz, there can be a 35 db attenuation (−50 dBm) and at 580 kHz there can be a 33 dB attenuation (−53 dBm). It is possible to decrease the sidelobes by decreasing the bandwidth time (BT) of the Gaussian filter, but this may result in higher intersymbol interference.

As described above, transport channels can be formed by single physical channels or by combining the bandwidth of two or more adjacent physical channels. Each of Tables 5 and 6 define transport channels with respect to single physical channels or by combinations of the bandwidths of adjacent physical channels. In some embodiments, physical channels can be defined by arbitrary combinations of physical channels. In such system, data may be transported in parallel fashion amongst the physical channels in a transport channel. In those embodiments, data is split into multiple data streams by the MAC layer and are sent amongst two or more physical channels and bonded. Transmitter 406, then, simultaneously transmits multiple physical layer signals that are coordinated with one another. In receiving such a transport channel, receiver 410 receives the multiple signals and demodulator/decoder 408 recovers the multiple data streams. Transmit/receive 402 then passes the multiple data streams to the MAC layer, which reconstructs the original data by combining the multiple data streams. Transmission of bonded data over a multiple of parallel channels includes splitting the received digital data amongst the parallel channels and transmitting the data on the channels. Receipt of a bonded set of parallel transported data over multiple physical channels includes, for example, receiving and recovering the digital data in each channel and reconstructing the original data from the recovered data.

As discussed above, there may be any number of physical channels. A set of transport channels can be defined based on defined combinations of the physical channels. There can be any number of transport channels, each with individual definitions of combinations of the available defined physical channels. For example, utilizing eight physical channels as shown in Table 3, seventeen transport channels can be defined as in Table 5. Other combinations may be added to the definitions in Table 5. As further shown in Tables 5 and 6, individual definitions of transport channels can be designated utilizing a hexadecimal transport channel identification, that can be set by the processor prior to transmission or receipt of a message and received by transmitter 406 and receiver 410. In tables 5 and 6, the transport channel ID is designated in hexadecimal notation.

Each frame of data that is transmitted can be encoded before transmission in encoder/modulator 404. Encoder/modulator 404 may include a number of supported encoding methods. In some embodiments, device 110 may dynamically select a particular encoding method from a list of supported coding methods.

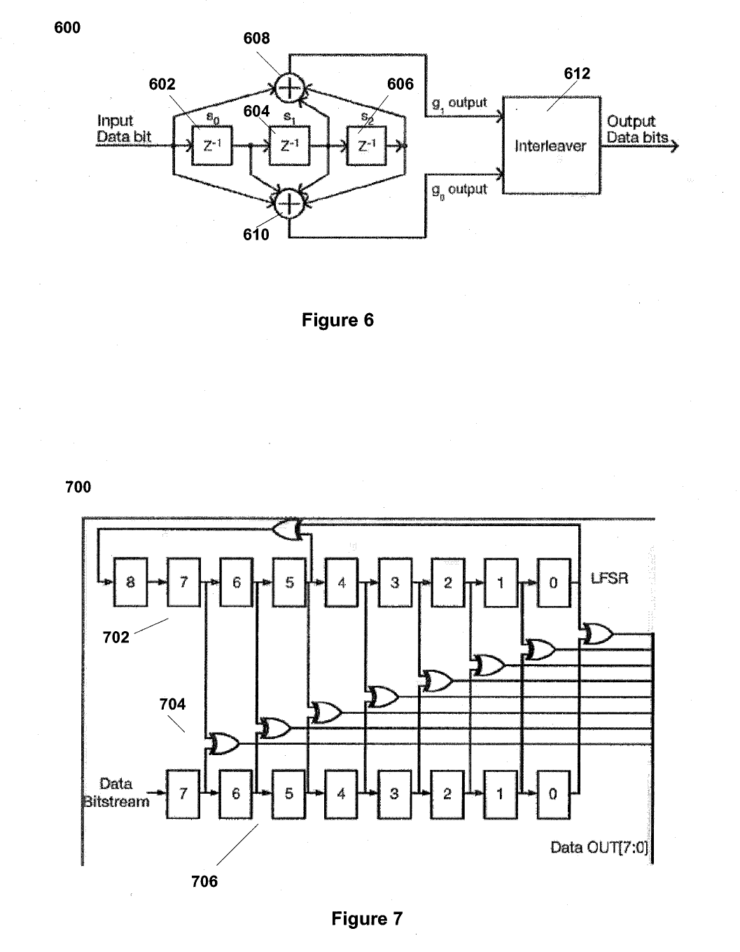

In some embodiments, encoder/modulator 404 can include an encoding mechanism to support forward error correction (FEC), an example of which is shown in FIG. 6. Although FIG. 6 illustrates a specific example of FEC encoding utilizing a ½ rate convolutional code with interleaving applied to the encoder output, other forward error correction encoding can be utilized. As shown in FIG. 6, an example FEC code 600 can include three delay memory registers 602, 604, and 606 coupled to two modular-2 adders 608 and 610. The results of adders 608 and 610 are input to an interleaver 612. In the embodiment shown in FIG. 6, output g₁ results from an impulse function of H₁(z)=1+z⁻²+z⁻³ and the output g₂ results from the function H₂(z)=1+z⁻¹+z⁻²+z⁻³. The correction code has a constraint length of four (4) and a polynomial (13, 17). Other convolution codes with other rates, impulse functions, and polynomials can be utilized. Interleaver 612, for example, can be a 4×4 matrix interleaver. The resulting output data bit stream has redundancy in order to reduce the error rate of the data stream when it is received by another receiver.

Such a ½ rate convolutional code encoder 606 with interleaver 612 can provide a 5+dB SNR gain, which yields an industry-leading signal robustness. This encoder design provides a data rate of 27.77 kbps with low bit error rate. Interleaver 612 can protect against bursty bit errors caused by signal fading. Further, FEC codes are widely supported.

When receiving a data bit stream that has been encoded with a FEC encoder such as FEC encoder 600 shown in FIG. 6, demodulator/decoder 408 may include a decoding counterpart. Such a decoder may include a trellis decoder, such as one using the Viterbi algorithm, to decode the convolution code implemented in encoder/modulator 404.

In some embodiments, encoder/modulator 404 may also implement techniques to randomize data in order to reduce the DC bias of the data frame, such as, for example, data whitening. FIG. 7 illustrates a data whitening algorithm 700 often referred to as PN9 encoding. In general, a seed polynomial is preloaded into a linear feedback shift register 702, which includes a linear array of shift register bits. As shown in FIG. 7, shift register 702 has nine bits, bits 0 through 8. The polynomial can be set as x⁸+x⁷+x⁶+x⁵+x⁴+x³+x²+x¹+x⁰. Data is shifted into shift register 706, bit-by-bit, while linear array shift register 702 shifts at the same rate. XOR array 704 performs an XOR operation, which is latched to the output data (Data Out [7:0]) once a full byte of data has been shifted into shift register 706.

Upon receipt of a data stream that has been whitened as shown in FIG. 7, demodulator/decoder 408 performs a symmetric operation to recover the data bit stream. In some embodiments, both encoding and decoding can be performed in software utilizing tables of pre-compiled values for shift register 702.

Other encoders that may be utilized include Manchester encoding, Block coding, Reed-Solomon encoding, and Turbo Codes. However, FEC 600 provides better error coding gain than does Manchester coding. Error correction encoding increases signal robustness by introducing redundancies into the data stream at the transmitter, which enables the correction of erroneous data bits at the receiver. Such encoding increases the chance that a given message is error free. Such coding can be complicated in implementation, but modern chips are highly sophisticated.

In a comparison of ½ rate FEC encoding, full rate encoding (NRZ), and Manchester encoding, the ½ rate FEC encoding performed very well. As discussed above with respect to FIG. 6, the FEC encoding method is modeled from the typical worst-case gain of a length 5 convolutional code with soft detection viterbi decoder, therefore actual performance is expected to be better. The channel model utilized in the study was a rayleigh flat-fading model, which is typical of both indoor and outdoor use. The receiver and modulation scheme is modeled as coherent FSK modulation. As such, the Manchester encoding results in 512 symbols in a 32 byte packet with a symbol error-rate ceiling of 1.95×10⁻³, a relative random packet loss (10-40 db SNR) of 3.45 (normalized to the FEC encoding data), and a required radio on-time for a successful transmission of 3.45 (normalized to the FEC encoding data). The NRZ encoding had 256 symbols in a 32 byte packet, a symbol error-rate ceiling of 1.95×10⁻³, a relative random packet loss of 3.1 (normalized to the FEC encoding data), and a required radio on time for successful transmission of 1.55 (normalized to the FEC encoding data). The FEC encoding had 512 symbols in a 32 byte packet, a symbol error rate ceiling of 1.95×10⁻³, a relative random packet loss of 1.0, and a required radio on-time for successful transmission of 1.0. From this data, NRZ encoding has advantages Manchester encoding because it takes fewer symbols (and time) to send the same data. FEC encoding has advantages over both because it provides encoding gain to the signal and a superior SNR. On average, non-FEC methods spend more than 3 times the number of packets in order to get one successfully transmitted.

The physical system described above can be controlled by a media access control (MAC) layer. The MAC layer can include functions and methodologies operating on devices 110 for data frame structuring, data encoding, collision avoidance, channel state monitoring, frame ordering, and frame routing. As such, the MAC features define the network architecture. Some communications options include, for example, a wake-on radio, carrier sense multiple access (CSMA) unsolicited beaconing (ACK or non-ACK), asynchronous collection of data, and synchronized slotted access (guaranteed time slots for communications between devices). Synchronized access is useful when communications between devices 110 has a high level of predictability.

The wake-on radio includes not just wake-up packet polling, but sensor alarms, scheduled wake-ups, and other forms of signaling a device 110 to wakeup. A wake-on radio is useful because an arbitrarily large number of devices can be present without utilizing a transport channel. Wake-on options also provide for low power optimizations for devices 110. Typically, device 110 transmits or receives packets after a wake-on event has occurred. A wake-on event can include sensor alarms, passive RFID message reception, active RF wakeups, or real-time scheduling via some protocol. As discussed in further detail below, an active RF wakeup involves device 110 periodically scanning transport channels to detect a wakeup packet. The advantages of an active wakeup process is that it allows devices 110 to spend as much time as possible in a low power state (e.g., sleep state or hold state), utilizing asynchronous request-response abilities are applicable to chaotic environments where synchronization is not possible or is impractical, and further asynchronous communications provide for deterministic worst case latency.

Devices 110 communicate with one another by exchanging packets of data that includes frame data. Several types of frames can be defined, including wakeup frames, request frames, response frames, and data frames. The receipt of wakeup frames is one of the wake-on radio modes that causes device 110 to become active. Packet types can be defined in terms of the payload frame data type included in the packet. Each of these frames are described in further detail below.

In some embodiments devices such as each of devices 110 and reader 120 as shown in FIG. 1(a) need not be defined strictly in terms of interrogators and tags, where an interrogator is a reader that polls devices and tags are devices that respond to the polling from readers. Instead, there may be a number of regimes in which each device such as each of devices 110 or each reader 120 can function. Further, device 110 may switch between regimes in accordance with a particular application.

The various regimes can include, for example, an endpoint regime (similar to a tag), a subcontroller regime (operationally between a reader and a tag), a gateway regime (similar to a reader), and a master gateway regime (similar to a fixed reader that simultaneously monitors a number of transport channels). This allows various network topologies to be supported. For example, a star topology can include devices 110 in gateway regime and endpoint regime. A tree topology can be formed from devices 110 operating in gateway regimes, subcontroller regime, and endpoint regime. Further, a mesh topology can be formed with devices 110 operating in gateway regime and subcontroller regime. Utilizing a tree topology, for example, the range of a device 110 operating in a gateway regime can be greatly extended. Other regimes may also be defined for operation of the devices identified in FIG. 1(a) as devices 110 and reader 120.

A device 110 that operates in an endpoint regime can be similar to that of a traditional tag. In the endpoint regime, device 110 spends most of its time in a low-power state. Once device 110 receives a wake-up event, it engages in a process of requesting reception and, usually, provides a response transmission.

A device 110 that operates in a subcontroller regime includes some of the functionality of both a traditional interrogator and a traditional tag. If device 110 is operating in the subcontroller regime, it can open and maintain a dialog with a device in the endpoint regime or other devices in the subcontroller regime. In some embodiments, if device 110 includes a subcontroller regime, then device 110 is also capable of operating in an endpoint regime.

A device 110 operating in a gateway regime includes much of the functionality of a reader and can behave much like a base-station. In FIG. 1(a), reader 120 is one of devices 110 operating in a gateway regime. A device 110 operating in the gateway regime is always on and actively receiving. In some embodiments, it may be powered from a wire-line power supply (i.e. from the power grid), however it may also be powered by a battery for a hand-held model, such as is shown in FIG. 2. A device 110 operating in the gateway regime (reader 120) may be coupled to a separate network in order to communicate and may be optimized to utilize the lowest latency channels and provide network arbitration. A device 110 operating in a master gateway regime simultaneously monitors all of the transport channels that are defined and is optimized for minimum network latency.

FIG. 1(b) illustrates RFID system 100 with various ones of devices 110 operating in endpoint regime (designated E), subcontroller regime (designated S), and gateway regime, designated by device 120. There can be any number of devices 110 operating in any of the regimes. FIG. 1(b) illustrates various dialog opportunities between types of devices 110. As shown in FIG. 1(b), device 110 in the gateway regime, device 120, can carry on a dialog with a device 110 in endpoint regime or a device 110 in subcontroller regime. Dialog 136 illustrates a dialog between gateway 120 and a device 110 in endpoint regime. Dialog 138 and dialog 140 illustrate dialogs between gateway device 120 and a device 110 in subcontroller regime.

As is further shown, device 110 operating in subcontroller regime can initiate dialogs between devices 110 operating either in the subcontroller regime or in the endpoint regime. Dialog 130 illustrates a dialog between two devices 110 each operating in subcontroller regime. Similarly, dialogs 142, 144, and 150 illustrate dialogs between devices 110 operating in subcontroller regime. Dialogs 134, 146, and 148 all illustrate dialogs operating between one device 110 operating in a subcontroller regime and one device 110 operating in an endpoint regime.

As shown in FIG. 1(b), device 110 operating in subcontroller regime can relay requests and responses from one device 110 in subcontroller regime to another of devices 110 in subcontroller regime. As such, a request originating from gateway device 120 can be relayed through dialog 140, dialog 142, and dialog 144 to another device 110 in subcontroller regime. Further, a device 110 operating in subcontroller regime can act as a network hub for system 100, providing requests and collecting responses from multiple other devices 110 operating in either subcontroller regime or endpoint regime. This feature is illustrated in dialogs 146, 148, and 150.

This type of processing, where requests and responses are routed through one or more third devices 110, can be referred to as multi-hop routing. In general, only devices 110 operating the subcontroller regime or the gateway regime can engage in the forwarding of data packets involved in multi-hop routing. Devices 110 that are in the endpoint regime can not forward packets.

As such, the operable range of gateway 120 to poll devices 110 can be greatly extended by the array of devices operating in subcontroller regime relaying requests and responses. This relaying can be referred to as hopping.

Further, a star topology is illustrated by dialogs 138, 140, and 136 where device 120 is communicating with others of devices 110. A tree topology is formed with dialogs 140, 142, and 144 where device 110 at the end of dialog 144 also engages in dialogs 146, 150, and 148. Further, a mesh topology is shown with dialogs 150, 144, and 142, for example.

In addition to the various regimes of operation, each of devices 110 supports various states of operation. For example, each device 110 can support states that include an off state, a sleep state, a listen state, a receive state, a transmit state, and a hold state. A device 110 can transition between states based on the condition of an external trigger (for example a sensor interrupt). Transitions between states are governed by the definition of the particular regime in which device 110 is operating.

In the off state, device 110 is not utilizing any of its components to receive or transmit a signal in any way. The off state is included in each regime. Device 110 transitions from the off state by an external trigger that is independent of the signals sent by the RFID system itself. The external trigger can be, for example, physically turning on a power switch or installing a battery.

In some embodiments, an idle state may be defined as the base state for a particular regime. In the endpoint regime, for example, the base state may be a sleep state. In the subcontroller regime, the base state may be a hold state. In the gateway regime, the base state may be a listen state.

In the sleep state, device 110 periodically monitors the channel space for a wake-up frame. While in the sleep state, all active transport channels may be monitored for wake-up frames at least once every sleep-scan period (SSP). The SSP can be any time frame, for example 2 to 3 seconds. In some embodiments, an SSP for a particular device 110 can be set to a default, for example 2.4 seconds. If a wake-up frame is detected, device 110 can transition a listen state. If a wake-up frame is not detected, then device 110 remains in the sleep state. If there are multiple active transport channels, in some embodiments device 110 may monitor one of the active channels each time that it wakes, and should monitor all of the active channels within the SSP. In which case, device 110 may wake up periodically within the SSP in order to successively check the active channels.

In the listen state, device 110 monitors one of the active channels for a request frame. In some embodiments, there may be a time-out period, referred to as the Maximum Guard Time (MGT), after which device 110 returns to an idle state. In some cases, the MGT may be very large or device 110 may remain in the listen state indefinitely. Otherwise, device 110 receives a Request Frame Sync Word and enters the Receive State.

In the receive state, device 110 actively receives and stores the signal on the selected transport channel. In some embodiments, or some regimes of operation, device 110 may remain in receive state for an arbitrarily long time. In some embodiments, or some regimes of operation, device 110 can transition from the receive state to the listen state, the transmit state, the sleep state, or the hold state after a successful reception of a packet.

In a transmit state, device 110 is involved in sending a Request, Response, or Data Frame. Before actually transmitting data, device 110 engages in collision avoidance. Collision avoidance may include, for example, non-arbitrated CSMA and arbitrated CSMA, which is described in further detail below. The transmit state may follow any prior state, but typically follows the Receive State after reception of a Request, Response, or Data Frame.

The hold state is similar to the sleep state but can result in lower latency channel access. Device 110 may enter the hold state after a successful dialog has transpired. The hold state may also provide a momentary period during which a device that is normally in an endpoint regime can seamlessly transition to a subcontroller regime. The network structure and order of communications may remain unaffected by the switchover if handled during a hold state.

The hold state can have two substates, asynchronous or synchronous. Which of the two substates to utilize depends on the device regime or on the protocol that is in use. The asynchronous hold state is almost identical with the sleep state, except that it may use a different set of channel scan parameters than does the sleep state. Typically, the asynchronous hold state scan period is shorter and scans fewer transport channels than does the sleep state. If the asynchronous hold state is entered from another state than the hold state, device 110 will immediately enter the listen state for a period of one MGT. Upon re-entry from listen, the scan periods begin. The hold scan period (HSP) is configurable and can be set to any time. For example, HSP can be set to a nominal value, for example 72 ms. In the endpoint regime, the asynchronous hold state can time out in a long time, for example 28.8 seconds. After the hold state times out, in the endpoint regime device 110 enters the sleep state. In the subcontroller regime, there is no time-out and therefore the asynchronous hold state effectively replaces the sleep state.

In a synchronous hold state, device 110 is expected to begin a discrete time-slotting process. The “number of slots” parameter can be communicated per a request according to the protocol. The value of a virtual ID (VID) of device 110 can be used to determine the slot that that device 110 utilizes to transmit a response. If no VID is defined, then device 110 may ignore the request. In some embodiments, a hashing algorithm can be utilized in circumstances where the number of devices in the population is greater than the number of slots allowed in the hold period. In some embodiments, the hold period times out when all slots have expired. When the hold period times-out, the device can enter the listen state for a period of one MGT.

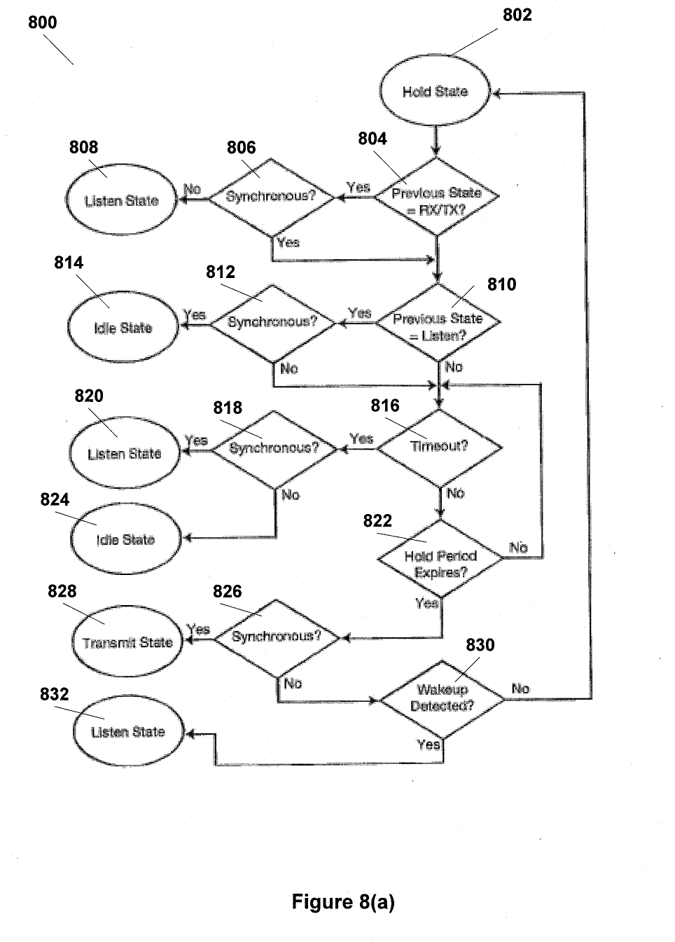

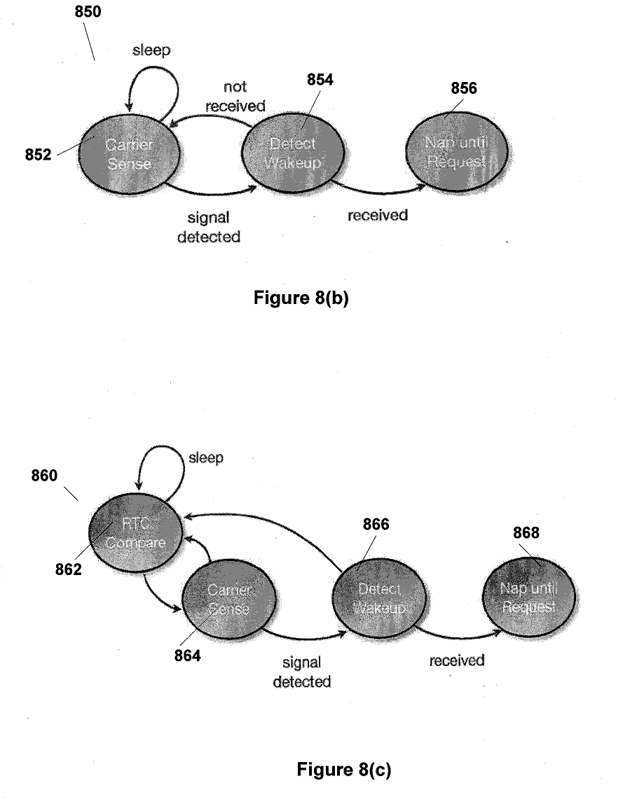

FIG. 8(a) illustrates an example of an operation of a hold state transition 800 according to some embodiments of the present invention. As discussed above, the hold state can be a complicated state and is available in the endpoint and the subcontroller regimes. From hold state 802, device 110 transitions to step 804. In step 804, if the previous state was a receive or a transmit state, then device 110 transitions to step 806. In step 806, if the hold state is an asynchronous hold state, then device 110 transitions to listen state 808. If the previous state is not a receive or transmit state or if the hold state is a synchronous hold state, then device 110 transitions to step 810. In step 810, if the previous state was a listen state then device 110 transitions to step 812. In step 812, if the hold state is a synchronous hold state, the device 110 transitions to idle state 814. Idle state 814 corresponds to a sleep state in the endpoint regime and the asynchronous hold state in the subcontroller regime.

If the previous state was not a listen state or the hold state is an asynchronous hold state, then device 110 transitions to step 816. In step 816, if the hold state has timed out then device 110 transitions to step 818. In step 818, if the hold state is a synchronous hold state then device 110 transitions to a listen state. In step 818, if the hold state is an asynchronous hold state then device 110 transitions to an idle state. In step 816, if there is no timeout, then device 110 proceeds to step 822. In step 822, if the hold period has expired, then device 110 returns to step 818. If the hold period has not expired, then device 110 proceeds to step 826. In step 826, if the hold state is a synchronous hold state then device 110 transitions to transmit state 828. However, if the hold state is an asynchronous state, then device 110 proceeds to step 830. In step 830, if a wake-up is detected, then device 110 transitions to listen state 832. Otherwise, device 110 returns to state 802.

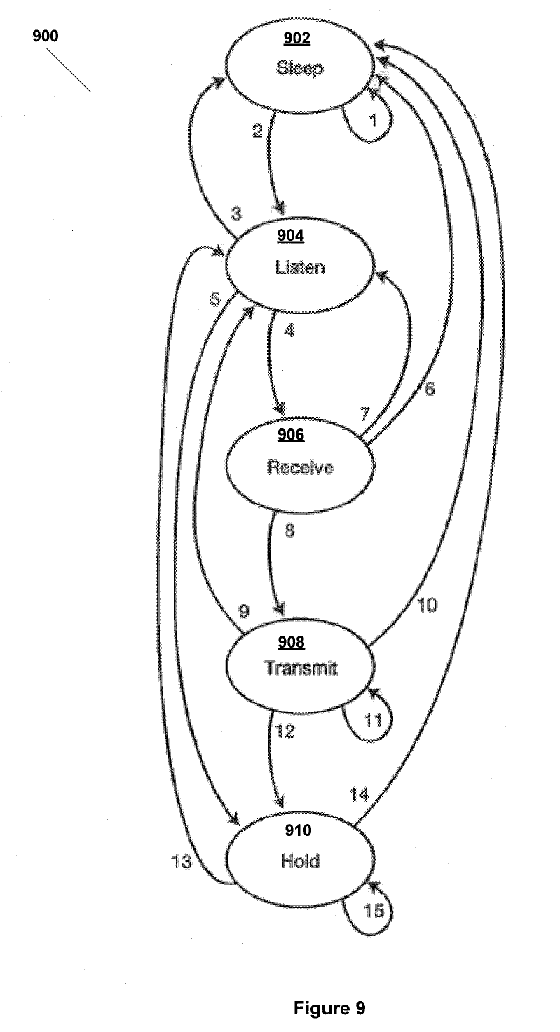

FIG. 9 shows a state diagram 900 illustrating operation of a device 110 in an endpoint regime. As shown in FIG. 9 as transition 1, from sleep state 902 device 110 transitions back to sleep state 902, which occurs if no incoming wake-up frame is detected. In transition 2, device 110 transitions from sleep state 902 to listen state 904, which occurs if a wake-up frame or some other wake-on event is detected. From listen state 904, transition 3 shows that device 110 transitions back to sleep 902, which occurs if no incoming request frame is detected after MGT. From listen 904, transition 4 shows that device 110 transitions to receive 906, which occurs when an incoming request frame sync word is detected. From listen 904, transition 5 shows that device 110 transitions to hold 910, which occurs when no incoming request frame is detected after MGT and listen 904 was entered from hold state 910 and not sleep state 902.

From receive state 906, transition 6 illustrates that device 110 transitions to sleep state 902, which occurs when an incoming request frame instructs device 110 to sleep and not form a response. Transition 7 illustrates that device 110 can transition from receive 906 to listen 904, which occurs when the incoming response frame leads to an incoming data frame. Transition 8 shows that device 110 can transition from receive 906 to transmit 908, which occurs when the incoming request frame leads to an outgoing response frame.

From transmit state 908, transition 9 shows that device 110 can transition to listen state 904, which occurs when the outgoing response frame leads to a subsequent incoming data frame. In transition 10, device 110 can transition from transmit 908 to sleep 902, which occurs when the incoming request frame includes instructions for device 110 to sleep followings its transmission of a response frame. As illustrated in transition 11, device 110 can transition from transmit state 908 back to transmit state 908, which occurs if the outgoing data frame is followed by an outgoing response frame. As illustrated in transition 12, device 110 can transition from transmit 908 to hold state 910 when the incoming request frame includes instructions to device 110 to enter hold state 910 following its transmission of a response frame.

As shown in transition 13, device 110 can transition from hold state 910 to listen state 904, which occurs when an incoming wake-up frame is detected or HSP becomes 0. Transition 14 illustrates that device 110 can transition from hold state 910 to sleep state 902, which occurs when hold state 910 times out. Finally, transition 15 illustrates that device 110 can transition from hold state 910 back to hold state 910, which occurs when no wake-up frame is detected and no time out has occurred.

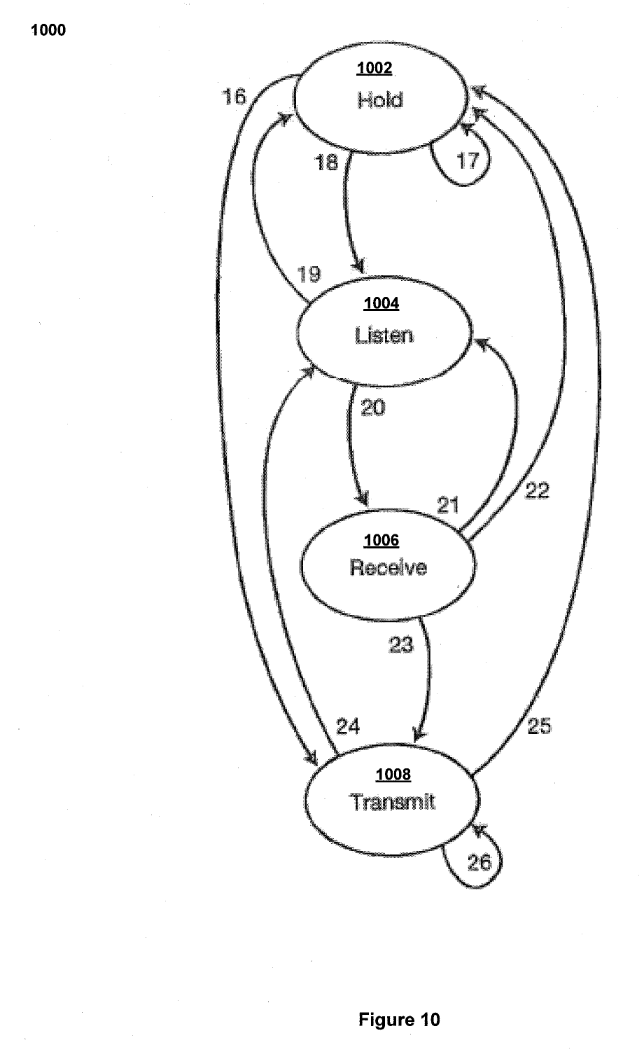

FIG. 10 illustrates a state diagram for operation of device 110 in a subcontroller regime according to some embodiments of the present invention. As shown by transition 16, device 110 can transition from a hold state 1002 to a transmit state 1008, which occurs when device 110 needs to send a wakeup or a request frame. Transition 17 shows that device 110 can transition from hold 1002 back to hold 1002, which occurs when no incoming wakeup frame is detected (asynchronous hold), or no appropriate slot is available (synchronous hold). Transition 18 illustrates that device 110 can transition from hold 1002 to listen 1004, which occurs after the first entrance to hold state 1002 if hold state 1002 is an asynchronous hold state or upon detection of an incoming wakeup frame or other wake-on event occurs.

Transition 19 shows that device 110 can transition from listen 1004 to hold 1002, which occurs if no incoming request frame is detected after MGT. Transition 20 illustrates that device 110 can transition from listen 1004 to receive 1006, which occurs when an incoming request frame sync word is detected.

Transition 21 shows that device 110 can transition from receive 1006 to listen 1004, which occurs when the received request frame leads to an incoming data frame. Transition 22 shows that device 110 can transition from receive 1006 to hold 1002, which occurs when the incoming request frame instructs device 110 to sleep or hold and not to form a response. Transition 23 shows that device 110 can transition from receive 1006 to transmit 1008, which occurs when the incoming request frame leads to an outgoing response frame.

Transition 24 shows that device 110 can transition from transmit 1008 to listen 1004, which occurs when the outgoing response frame leads to a subsequent incoming data frame or an incoming response frame. Transition 25 shows that device 110 can transition from transmit 1008 to hold 1002, which occurs when the incoming request frame instructs device 110 to sleep or hold following transmission of a response frame, or the outgoing request does not require a response. Transition 26 illustrates that device 110 can transition from transmit 1008 back to transmit 1008, which occurs when an outgoing data frame follows the outgoing response frame.

Devices 110 operating in either endpoint regime or subcontroller regime may include a wake-on radio. As shown in FIG. 3, device 110 includes antenna 308 and transceiver 310, which together can include the wake-on radio. Activation of device 110 involves initiation with a wake-on event, otherwise transceiver 310 is off in the sleep state. There are several wake-on events that can result in device 110 becoming capable of receiving or transmitting packets. For example, a wake-on event can result from the active scanning for wake-up frames, as described above. Additionally, a wake-on event can result from the passive scanning for external RF events, or can result from a sensor event.

As described above with respect to FIGS. 9 and 10, devices 110 in endpoint regime and in subcontroller regime periodically scan for a wake-up frame. Therefore, receipt of a wake-up frame in such a scan results in a wake-on event that can result in an extended dialog. The process of actively scanning transport channel for wakeup frames can include scanning a sleep channel scan period list or a hold channel scan period list of active transport channels to be scanned for wakeup frames.

Additionally, devices 110 may utilize the passive scanning of external RF events. In some embodiments, device 110 may initiate a dialog following the reception of an external RF event. The transmission of such a dialog can include, as data, a device ID, which may be compliant with ISO 15693, accurately identifying the device that transmitted the external RF event in addition to the device ID of device 110. These device IDs may be embedded in the protocols. Both passive scanning and external RF events can, for example, be based on passive RF described in ISO 18000-2, 18000-3, or 18000-4. The external RF event, can, for example, be a RF modulated signal or message that can be attributed to an ISO 15963 compliant device ID. Passive scanning can be any non-active method that can be utilized to receive and decode an incoming RF signal or message. In which case, as shown in FIG. 9 device 110 in endpoint regime may remain in the sleep state 902 and transmit a beacon signal in the event of an RF event resulting in a wake-on event. In FIG. 10, device 110 in subcontroller regime may remain in the hold state 1002 and transmit a beacon signal in the event of an RF event resulting in a wake-on event. The beacon signal can include as data the IDs of the device that transmit the beacon signal and the device that transmitted the external RF events, and other data.

In some embodiments, device 110 remains in the sleep or hold state and does not transmit any beacon signal upon receipt of an RF event. Device 110 will follow the state transition as defined in FIGS. 9 and 10. A dialog may be sent once device 110 transits to a transmit state.

In some embodiments, device 110 can initiate a dialog following the detection of a sensor event. Transmission of a dialog can contain, as data, sensor identification identifying the sensor that generated the sensor event in addition to the device ID of device 110 that transmitted the packet. For example, the sensor ID can be an ISO 21451-7 compliant sensor ID. In which case, as shown in FIG. 9 device 110 in endpoint regime may remain in sleep state 902 and transmit a beacon signal in the event of a sensor event resulting in a wake-on event. In FIG. 10, device 110 in subcontroller regime may remain in hold state 1002 and transmit a beacon signal in a sensor event resulting in a wake-on event. The beacon signal can include as data the IDs of the device that transmit the beacon signal and information related to the sensor event, and other data.

As discussed above, in some embodiments device 110 may remain in a hold or sleep state upon receipt of a sensor event in order to wait for a wake-up packet. As shown in FIG. 9, device 110 may transition to sleep state 902 to await a wake-up packet and may transmit once device 110 transitions to transmit state 908. In FIG. 10, device 110 may remain in hold state 1002 upon receipt of a sensor event and transmit data when device 110 transits to transmit state 1008.

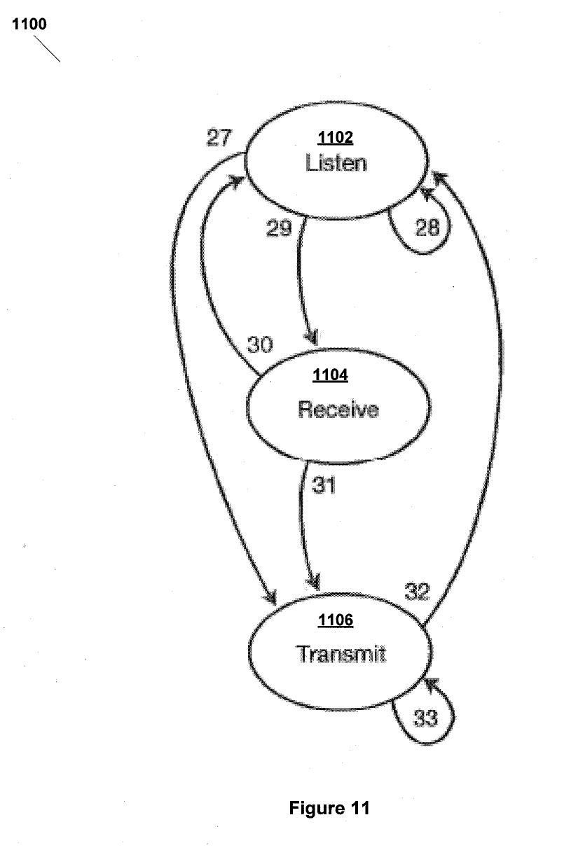

FIG. 11 illustrates an embodiment of a state machine for device 110 operating in a gateway regime. As shown in FIG. 11, transition 27 illustrates that device 110 can transition from a listen state 1102 to a transmit state 1106, which occurs when device 110 needs to send a wakeup frame or request frames. Transition 28 illustrates that device 110 can transition from listen 1102 back to listen 1102, which occurs when no incoming response frame is detected after MGT. Transition 29 illustrates that device 110 can transition from listen 1102 to receive 1104, which occurs when an incoming response frame sync word is detected.

Transition 30 indicates that device 110 can transition from receive 1104 to listen 1102, which occurs when an incoming response frame indicates that a data frame is coming. Transition 31 illustrates that device 110 can transition from receive 1104 to transmit 1106, which occurs when the incoming response frame precedes an outgoing data frame.

Transition 32 shows that device 110 can transition from transmit 1106 to listen 1102, which occurs when the outgoing response or data frame is completely transmitted. Finally, transition 33 shows that device 110 can transition from transmit 1106 back to transmit 1106, which occurs when an outgoing response frame is followed by an outgoing data frame.

As is illustrated above, transition between states occurs while receiving, transmitting, or responding to frames of data. As further illustrated above, in some embodiments there are distinct frame types, including a wakeup frame, a request frame, a response frame, and a data frame.

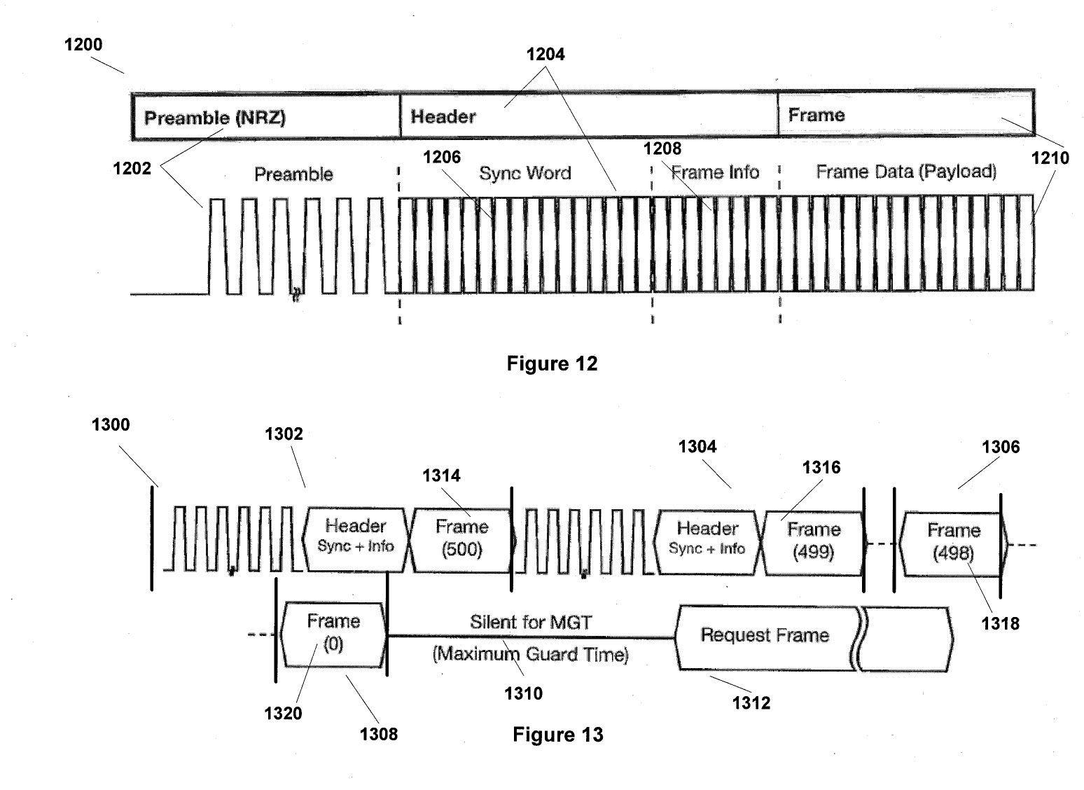

FIG. 12 illustrates a packet structure 1200 that is utilized for all frame packet types according to some embodiments of the present invention. In some embodiments, a cyclic redundancy check (CRC), for example a CRC-16 integer, is added to the packet, which can be utilized as a data verification method. As shown in FIG. 12, packet structure 1200 includes a preamble 1202, a header 1204, and frame data 1210. Header 1204 includes a sync word 1206 and frame information 1208. The payload for the packet is frame data 1210, which may be multiple bytes of data. As discussed before, a single chip rate is utilized for transmission of packet 1200. The packet size can be of any length.

In some embodiments, preamble 1202 is a non-return-to-zero (NRZ) signal. As shown in FIG. 12, in some embodiments preamble 1202 can be a square wave beginning with a rising edge. As such, preamble 1200 can be understood to be a NRZ encoded example of the recurring data pattern 0xAAAAA . . . . In some embodiments, preamble 1202 can be transmitted as a set number of NRZ bits, for example 32 NRZ bits. NRZ bits, including those of preamble 1202, can be referred to as chips. Frame sync 1206 can be a NRZ word utilized for data boundary detection and filtering. Frame ID 1208, or frame type, can be an NRZ word for identifying the nature of frame data 1210 (encoding, encryption, and frame content). Frame data 1210 (referred to as the “frame”) is encoded data, which may utilize an embedded protocol and may further utilize encapsulated protocols for the transmission of data.

A constant chip rate can keep the power-spectral-density (PSD) the same throughout a dialog process. As a result, signal reception can follow a predictable model. Further, there is a strong push towards a digital solution because modern chips have stronger digital capabilities than analog capabilities and digital implementations tend to be less expensive.

In the embodiment of header 1204 shown in FIG. 12, header 1204 includes a sync word 1206 and frame information 1208. Sync word 1206 can be a NRZ encoded synchronization word that can be utilized for packet filtering and frame boundary detection. Sync words can be selected for their run-length and autocorrelation properties. A wake-up packet, for example, may have a Sync word 0x821F. A sync word for a request or response packet may be, for example, 0xFBE0. Sync words for particular packet types are illustrated further below.

Frame information 1208 can be encoded as block-code, for example eight bits in length. Frame info 1208 describes the state of the following frame data concerning, for example, encoding, encryption, and frame subtype. In some embodiments, frame info 1208 can include redundant transmission and a parity bit. In some embodiments, the parity bit can be “0” if the parity is odd or “1” when the parity is even. Frame types can include, for example, request/response frames, ACK/NACK frames, sequence ID frames, Security or Authentication frames, addressing frames, sync frames, or beacon frames.

Frame information 1208 can be encoded as a block-code of particular length. In some embodiments, frame information 1208 can be eight (8) bits in length. Frame information 1208 describes the state of the following frame data 1210 concerning encoding, encryption, and frame subtype. Frame information 1208 can include a subtype bit that indicates the subtype of the frame data, an encoding bit which indicates the type of encoding utilizes, for example whether PN9 encoding or FEC encoding is present, a cryptography bit which indicates whether or not the frame data is encrypted, and the parity bit. In some embodiments, frame information 1208 is an 8 bit field where bit 7 indicates subtype, bit 6 indicates encoding, bit 5 indicates cryptography, bit 4 is a parity bit. Bits 3 through 0 can have the same designations as bits 7 through 4.

Packet frame 1210 can be transmitted as an encoded bitstream at the requisite modulation chip rate, continuous with preamble 1202 and header 1204. The data in packet frame 1210 is of arbitrary length and can be encoded as full rate or half-rate-byte-aligned. Encoding methods for packet frame 1210 are discussed further below.

As shown in FIG. 12, there is a single chip rate per packet. preamble 1202 and header 1204 are unencoded, for example, not PN9 or FEC encoding. However, frame 1210 can include an embedded encoding protocol. In some embodiments, a normal packet has a chip rate of 55.55 kcps while a high speed packet can have a bit rate of 200 kcps. In some embodiments, a normal packet can have a 32 bit preamble 1202, a 16 bit sync 1206, a one byte frame info 1208, and a variable length frame data 1210. In some embodiments, a high speed packet can have a 32 bit preamble 1202, a 24 bit sync word 1206, a one byte frame info 1208, and a variable length frame data 1210. Other sizes for the components of packet 1202 can be used. In some embodiments, there are several types of packets 1200. For example, there may be wakeup packets, request packets, response packets, and data session packets. Examples of each of these are discussed below.

FIG. 13 illustrates an example of a chain of wakeup packets 1300 (or wakeup packet train 1300). Packets 1302, 1304, 1306 and 1308 are shown. There may be any number of wakeup packets in chain of wakeup packets 1300 As shown in FIG. 13, each wakeup packet in the chain of wakeup packets 1300 includes a packet 1200 as shown in FIG. 12. FIG. 13 illustrates a wakeup chain 1300 with five hundred and one sequential wakeup packets, however any number of wakeup packets can be utilized. Each wakeup packet includes one wakeup frame. As shown in FIG. 13, wakeup packet 1302 includes wakeup frame 1314; wakeup packet 1304 includes wakeup packet 1316; wakeup packet 1306 includes wakeup frame 1318; and wakeup packet 1308 includes wakeup frame 1320. The chain of wakeup packets 1300 is followed by a period of silence 1310, which in some embodiments can be the maximum guard time (MGT) 1310 in duration. After MGT 1310, a request packet 1312 can be transmitted.

Each of wakeup frames 1314, 1316, 1318, and 1320 can include a fixed-length integer. In some embodiments, the fixed length integer indicates the number of wakeup frames that remain in chain of wakeup packets 1300, with the last frame, frame 1320, holding the integer 0.

When device 110 wants to send a request in order to initiate a dialog, then device 110 transmits wakeup packet chain 1300, which transmits a “train” of wakeup frames 1314 through 1320. Wakeup frames are of fixed length, and therefore of fixed duration. As shown in FIG. 13, each wakeup frame 1314 through 1320 includes a countdown packet. After all of the wake-up packets 1314 through 1320 have been received, then a request may be transmitted.

Each wake-up frame in packet chain 1300 can be a fixed number of bits, for example 16 bits. Table 7 indicates a particular implementation of a wake-up packet chain according to some embodiments of the present invention. One skilled in the art will recognize that other implementations fall within the scope of this disclosure.

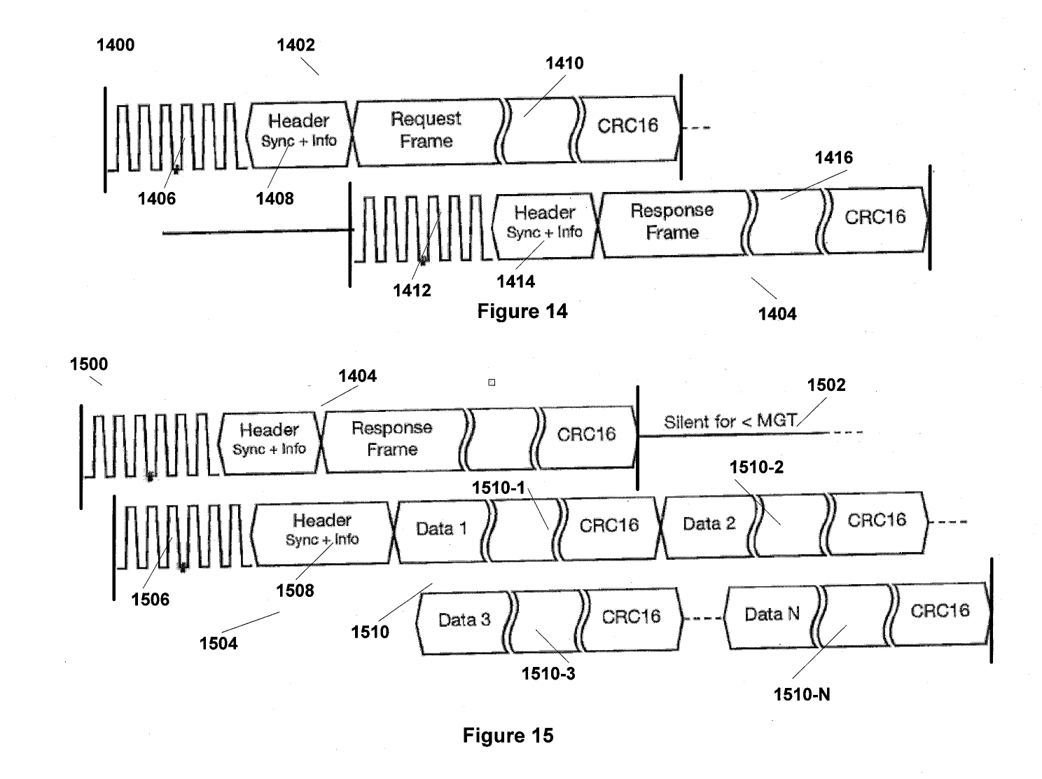

As suggested above, and discussed further below, reception of wakeup packet 1300 is one of the wake-on radio events that results in activation of a device 110. As such, device 110 periodically scans for detection of chain of wakeup packets 1300. In some embodiments, those scan events may be scheduled. In some embodiments, device 110 periodically scans the transport channels for a wakeup event. From the count-down value in each of wakeup frames 1314 through 1320 in wakeup packet 1300, a device 110 that detects wakeup packet 1300 knows the time before a request packet 1400, discussed with respect to FIG. 14 below, arrives.

FIG. 8(b) illustrates a state diagram for device 110 in a sleep state 850. As shown in FIG. 8(b), periodically device 110 checks one of the transport channels for a carrier in step 852. If none is detected, then device 110 returns to step 852 to continue periodically scanning. If a carrier is detected, then device 110 transitions to detect wakeup 854 where device 110 checks for the presence of wakeup packet 1300. If wakeup packet 1300 is not present, then detector returns to carrier sense 852 to continue periodically scanning. Otherwise, detector 110 transitions to nap step 856. In nap step 856, device 110 determines from the wakeup frame number held in the detected one of wakeup frames 1314 through 1320 the time until a request packet 1400 is expected. Device 110 then returns to an inactive (sleep) state until that time, reactivating in sufficient time to receive request packet 1400. In some embodiments, wakeup packet 1300 may indicate that a request will arrive at some future time by starting with a large countdown value and skipping most of the values. Device 110 can nap in nap state 856 until the expected time of arrival of the request packet 1400.

FIG. 8(c) illustrates a scheduled scan sleep state 860. In this case, device 110 remains in RTC compare state 862 until a real-time-clock (RTC) matches the scheduled time for a scan. When the RTC matches a scheduled event, then device 110 transitions to carrier sense 864, where if a carrier is not present device 110 transitions back to RTC compare state 862 to await the next scheduled time. If carrier sense 864 detects a carrier signal, then device 110 transitions to detect wakeup 866 where device 110 checks for a wakeup packet 1300. If wakeup packet 1300 is not detected, then device 110 transitions back to RTC compare 862. If wakeup packet 1300 is detected, then device 110 transitions to nap state 868. Again, in nap step 868 device 110 determines the amount of time before request packet 1400 will arrive and returns to an inactive state until the request packet 1400 is expected. Scheduling can be configured by a protocol, and can be different for each device 110. The scheduling can also be dynamically configured according to a predefined logic and the occurrence of events, for example, the number of carrier sense successes and failures. Further, in some cases a beacon or other action can be scheduled similarly to a wakeup scan.

In some embodiments, device 110 can scan multiple transport channels in an order and frequency that is configurable. As discussed above, each transport channel is associated with a channel ID. Each device 110 may then be loaded with a list of channel IDs to scan and how often to scan each of the channels on the list.

In some embodiments, real-time scheduling of wake-up events can be utilized. Devices 110 can be configured to align sleep scan cycles to a common clock so that the scheduled wake-up events can be utilized. Devices 110 that are operating in subcontroller or gateway regimes in scheduled networks may reliably utilize wake-up packet chains 1300 that are much shorter than the sleep scan period, as long as wake-up packet chain 1300 is of duration within the tolerance of the synchronization method.

FIG. 14 illustrates a sequence of packets 1400 that correspond to a request frame/response frame pair. Request frame 1402 is followed at a later time by response frame 1404. As shown in FIG. 14, and discussed with respect to FIG. 12, request frame 1402 includes a preamble 1406, a header 1408, and request frame data 1410. Similarly, response frame 1404 includes a preamble 1412, a header 1414, and response frame data 1416.

Request packet 1402 is an arbitrary-length packet that includes a formal template, data, and, in some embodiments, a CRC-16 component. These components are described further below. A single request packet 1402 follows wakeup packet train 1300 as shown in FIG. 13. In some embodiments, request packet 1402 can be transmitted without being preceded by a wakeup packet, although in that case there is a possibility that devices 110 that are intended to receive the request will actually not receive the request.

TABLE 7
Wakeup Packet Specification

| | |
|---|---|
| PHY type | Normal or Turbo |
| Preamble Length | 32 bits |
| Sync word | 16 bits 0x821F |
| Frame subtypes | A: |
| | B: |
| Frame Data Length | 4 bytes |
| Frame Encoding | PN9 or FEC |
| Frame Encryption | N/A |
| Frame CRC Polynomial | x¹⁶ + x¹² + x⁵ + x⁰(1021) |
| Frames per Packet | 1 |
| Wakeup Packet Duration | 0.44/0.60/1.584/2.16 ms, |
| | depending on encoding and |
| | symbol rate |
| Inter-Packet Delay | 0 ms |
| Extra-Packet Delay | 4.8 ms (MGT) |

Response packet 1404 includes responses and acknowledgement to request packet 1402. Response frame 1416 is structurally the same as request frame 1410. Response frame 1402 and request frame 1404 are not typically included in chains of frames. Table 8 illustrates a particular example implementation of a request frame 1402 and a response frame 1404.

FIG. 15 illustrates a data packet sequence 1500. As shown in FIG. 15, a data packet 1504 follows transmission of a response packet 1404. Response packet 1404 and data packet 1504 are separated by a silent period 1502. As shown in FIG. 15, data packet 1504, as discussed with respect to FIG. 12, includes a preamble 1506, a header 1508, and frame data 1510. Frame data 1510 can include any number of data frames 1510, depicted in FIG. 15 as data frames 1510-1 through 1510-N.

Data packets with multiple numbers of data frames 1510 (data frames 1510-1 through 1510-N being shown in FIG. 15) can utilize any protocol encapsulation. For example, a sensor standard such as ISO 21451-7 can be utilized as an encapsulated protocol. Having a large number of data frames 1510 in data packet 1500 can be useful for large data transfers, such as for transmitting sensor logs, reading or writing batch UDB elements quickly, or for firmware updates, for example.

TABLE 8
Request/Response Packet Specification

| PHY Type | Normal or Turbo |
|---|---|
| Preamble Length | 32 bits |
| Sync word | 16 bits (0xFBE0) |
| Frame Subtypes | A: Request (unsolicited) |
| | B: Response (solicited) |
| Frame Encoding | PN9 or FEC |
| Frame Encryption | Supported |
| Frame Data Length | Up to 256 bytes |
| Frame CRC Polynomial | x¹⁶ + x¹² + x⁵ + x⁰(1021) |
| Frames per packet | 1 |

Silent period 1502 can be of any duration, for example a duration that is less than MGT. Transmission of data packet 1504 follows a handshaking procedure managed through data frame commands provided in request frame 1402 and response frame 1404. Table 9 illustrates a particular implementation of data packet frame 1504.

TABLE 9
Data Packet Specification

| | |
|---|---|
| PHY type | Normal or Turbo |
| Preamble Length | 32 symbols |
| Sync Word | TBD 32 Symbols |
| Frame Subtypes | A: Standard Data Frame |
| | B: RFU |
| Frame Encoding | PN9 or FEC |
| Frame Encryption | Supported |
| Frame Data Length | Up to 256 bytes |
| Frame CRC Polynomial | x¹⁶ + x¹² + x⁵ + x⁰(1021) |
| Frames per Packet | 1 to 255 |

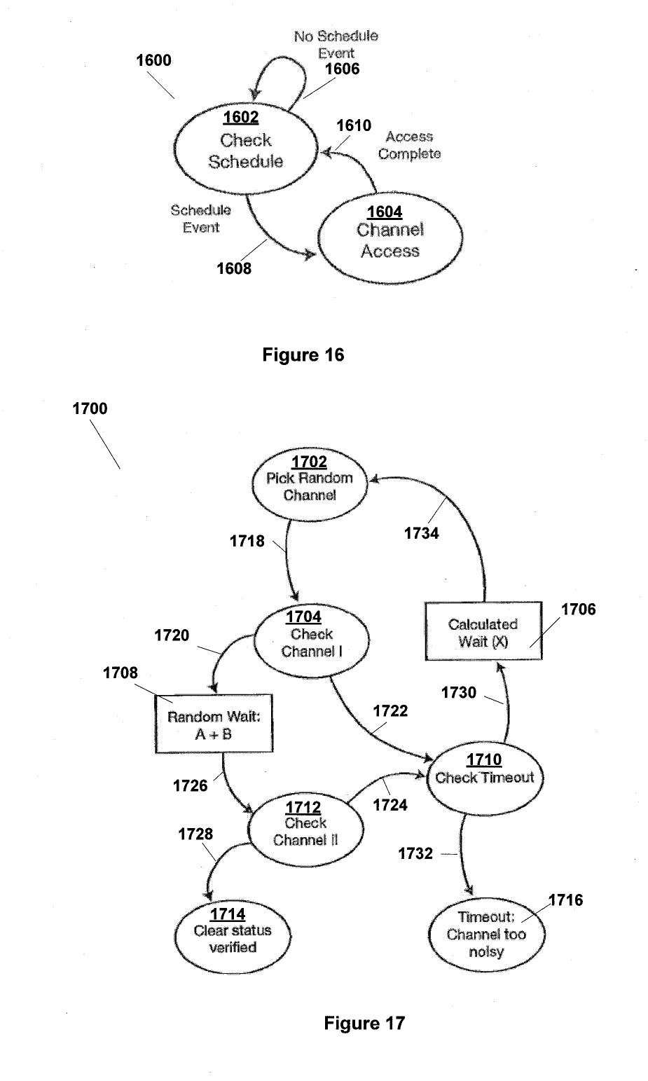

FIG. 16 shows a state diagram 1600 illustrate operation of a device 110 in a scheduled wake-up network. As shown in FIG. 16, device 110 starts in check schedule 1602, which occurs periodically in the sleep state. If there is no scheduled event, then transition 1606 transitions device 110 back to check schedule 1602. If there is a scheduled event, device 110 transitions in transition 1608 to channel access 1604. Channel access 1604 includes the detection of sync packet in the sleep and hold states, the detection of request packet in the listen stats, and the transmission of a packet in the transmit state. When the scheduled access is completed, device 110 transitions in transition 1610 from channel access 1604 back to check schedule 1602 to await the next scheduled access.

As discussed above, encoding of data in any of the packets can be accomplished in any fashion, for example FEC coding or data whitening (PN9) coding discussed above. In some cases, the data can be concatenated with a two byte CRC-16 field. The two byte CRC-16 field can conform to a CRC16 polynomial. The polynomial can be a CCITT CRC16 polynomial, or x₁₆+x¹²+x⁵+x⁰ (1021).

As in any network of interacting devices, RFID system 100 also includes procedures for collision avoidance. Some embodiments of the invention use a non-arbitrated carrier sense multiple access (CSMA) procedure. Some embodiments may also employee an arbitrated CSMA procedure. One skilled in the art may also recognize that other collision avoidance procedures can be utilized.

A guarded channel refers to a channel that is currently being transmitted upon or that has been transmitted on within the last MGT period. In some embodiments, transmission onto a guarded channel is not allowed. Devices 110 that initiate a transmission undergo a CSMA procedure prior to that transmission. In some embodiments, there may be transmissions that are undertaken without undertaking the CSMA procedure. For example, in some embodiments a CSMA procedure may not be required if device 110 is entering the transmission state from a synchronous hold state into a discreet time-slot; a CSMA procedure may not be required for device 110 that transmits a relevant follow-up packet within the MGT following the prior packet; and a CSMA procedure may not be required for device 110 that is acting as the arbitrator in an arbitrated CSMA dialog when transmitting into an arbitration request window.

As discussed above, the maximum guard time (MGT) is the maximum time a device 110 in the transmission state may be silent in the space between two adjacent frames in a dialog. After the MGT passes, the dialog channel is not guarded and is therefore not guaranteed to be clear. From another perspective, the MGT is the minimum time that device 110 has to remain in the listen state before transmitting into an arbitrary channel. Although the MGT can be set to any time, due to processing time and radio start-up time, the MGT should be a non-zero value. In some particular implementations of embodiments of the present invention, MGT can be set to 4.8 ms.

The minimum transmission time (MTT) refers to the shortest permitted duration during which device 110 may continuously transmit. As a particular example, in some embodiments the MTT can be set at the equivalent time duration for transmission of 184 bits, which can vary depending on the physical aspects of the transmission. In some cases, in normal mode MTT can be around 3.3 ms±1.5% and in turbo mode MTT can be around 0.92 ms±2%. However, MTT can be set at the duration for transmission of any number of bits of data.

FIG. 17 illustrates a state diagram for operation of devices 110 in a non-arbitrated CSMA procedure 1700. Non-arbitrated CSMA procedure 1700 can be managed independently on each device 110 that is entering the transmission state. Furthermore, non-arbitrated CSMA procedure 1700 may be conducted over one or more transport channels as device 110 is not necessarily forced to communicate on a one-to-one basis with another device occupying a fixed known channel.

As shown in FIG. 17, in step 1702, a random transport channel from a list of allowable transport channels is chosen by device 110 executing non-arbitrated CSMA procedure 1700. In transition 1718, device 110 then transitions to check channel 1704. If the chosen channel is clear, then transition 1720 takes device from check channel 1704 to a random wait 1708. The wait time is A+B, where A is the MGT and B is an arbitrary non-zero time less than or equal to MGT. At the end of the wait period in wait step 1708, device 110 then transitions in transition 1726 to a second channel check 1712. If the second channel check 1712 results in a clear channel, then device 110 transitions via transition 1728 to verify a cleared status in clear status verify 1714. At which point, device 110 can then transmit on the cleared channel.

If, in the first channel check 1704 or in second channel check 1712 the chosen channel is not clear, then device 110 transitions via transition 1722 or 1724, respectively, to check timeout 1710. If a timeout condition is detected, then device 110 transitions via transition 1732 to timeout 1716. Otherwise, device 110 transitions via transition 1730 to wait 1706. The timeout condition can be configurable for each device 110.

In wait 1706, device 110 delays for a period of time X and then transitions via transition 1734 back to pick channel step 1702. A new random channel may then be picked and arbitration process 1700 executed on the new random channel The amount of wait time X provided in wait 1706 can be, for example, a time equal to the duration time of the packet that device 110 is to transmit.

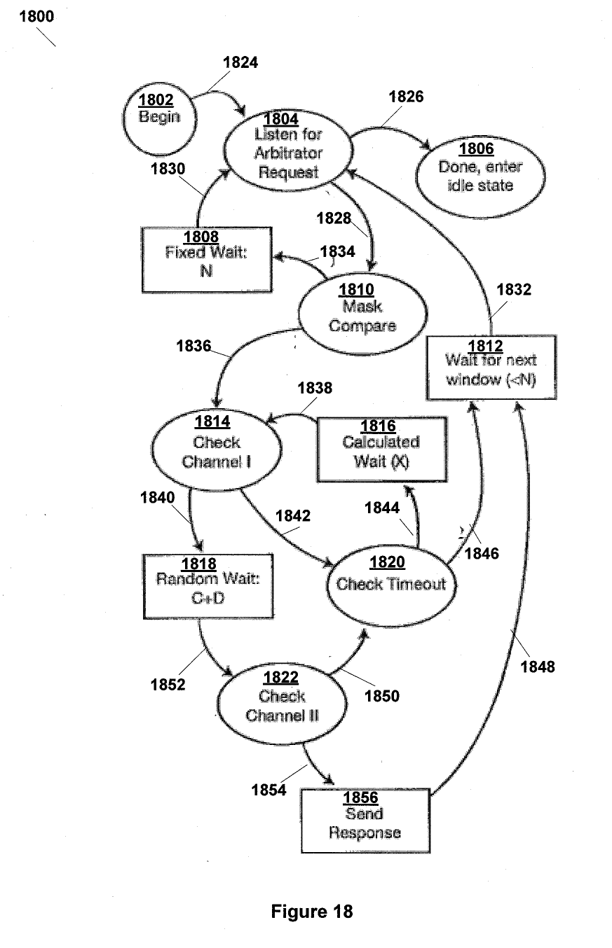

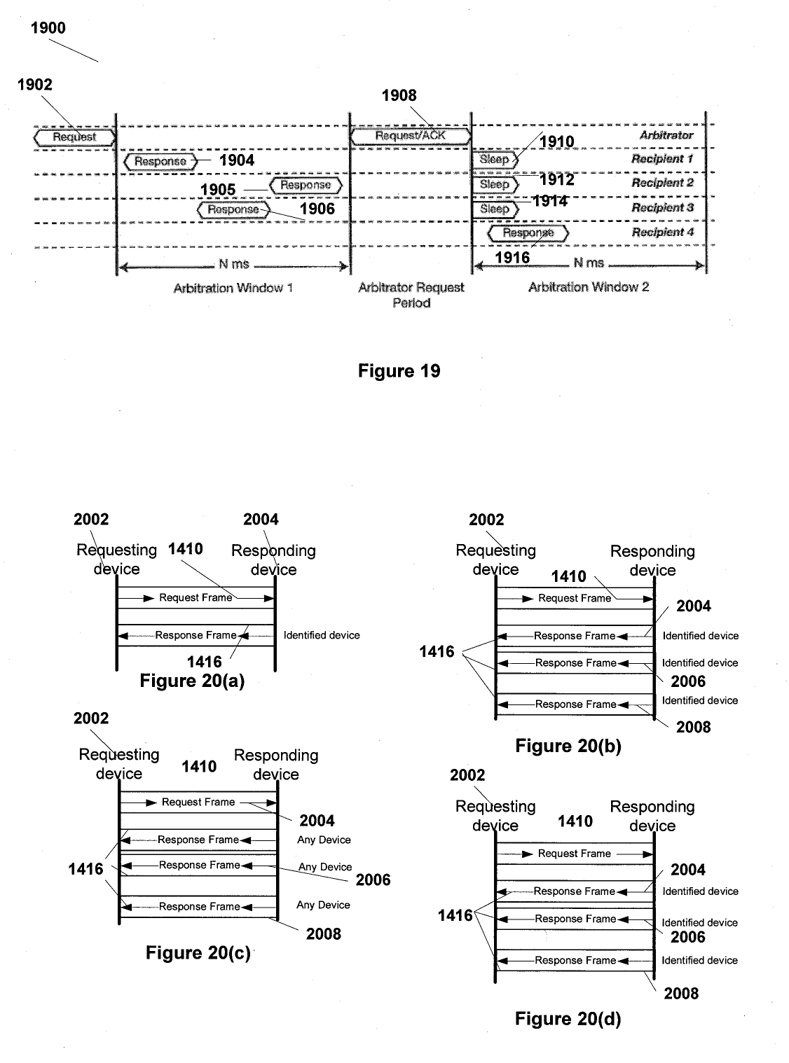

FIG. 18 illustrates state diagram for an embodiment of an arbitrated CSMA process 1800 that can be performed on a device 110 according to some embodiments of the present invention. In arbitrated CSMA process 1800, the particular transport channel is known and there is at least one other device occupying this transport channel. Arbitrated CSMA process 1800 can follow an ordered dialog behavior and can operated on a guarded channel. In some embodiments, the normal rules regarding MGT do not apply. FIG. 19 illustrates an example of frame traffic 1900 in an arbitrated CSMA process 1800 shown in FIG. 18. Arbitrated CSMA process 1800 is a structured, iterative query method suitable for collecting and acknowledging large populations of devices 110 while minimizing collisions and power use. As shown in FIG. 19, access is separated into a sequence of windows. Before each window, the arbitrator indicates which devices may respond during the window.

Further, request and response packets that are sent during the arbitration process are not preceded by a wake-up packet, so devices interested in receiving arbitrate response frames stay in the listen state for each N ms arbitration window. Devices interested in receiving arbitrator request frames enter the listen state immediately following each N ms arbitration window. As shown in FIG. 18, arbitrated CSMA process 1800 utilizes several parameters, including the following: C is the configurable window guard time; D is a random time less than or equal to C; N is the arbitration window timeout; M is the MGT; and X is the duration of the packet to be transmitted.

As shown in FIG. 18, device 110 starts in begin state 1802 and then, via transition 1824, enters step 1804. In step 1804, device 110 is in a listen state to receive an arbitrator request. As shown in frame traffic 1900, arbitrator request 1902 initiates an arbitration window. Upon receipt of arbitrator request 1902, device 110 transitions via transition 1828 to mask compare 1810. In mask compare 1810, device 110 checks to insure that arbitrator request 1902 is directed towards device 110. If not, then device 110 transitions via transition 1834 to fixed wait 1808. In fixed wait 1808, device 110 waits for time period N and then returns via transition 1830 to listen state 1804.

In mask compare 1810, if request 1902 is directed at device 110, then device 110 transitions to check channel 1814. In check channel 1814, device 110 checks to see if the transport channel is clear. If it is not clear, then device 110 enters transition 1842 to check timeout 1820. If the time out has not been exceeded, then device 110, through transition 1844, enters calculated wait 1816 where it waits for a time period X. After time period X, device 110 transitions through transition 1838 to check channel 1814.

In check channel 1814, if the channel is clear, then device 110 transitions through transition 1840 to wait 1818, where it waits for a period of time C+D. After the period of time C+D, device 110 then transitions via transition 1852 to second channel check 1822. If the channel is not clear, then device 110 transitions via transition 1850 to wait 1816. If the channel is clear, then device 110 transitions via transition 1854 to send response 1856 where a response is set. After sending the response, device 110 transitions via transition 1848 to wait 1812.

In FIG. 19, for example, a first device transmitted response 1904, a second device transmitted response 1905, and a third device transmitted response 1906 during arbitration window 1. However, a fourth device did not find a clear channel during arbitration window 1, and did not get an ACK in the Arbitrator Request Period after Arbitrator Window 1. The forth device then re-enters mask compare 1810 and transmits a response 1916 in the second arbitration window.

From timeout 1820, if the timeout period has expired device 110 transitions to wait 1812. In Wait 1812, device 110 waits for a time less than N in order to check the next window period. In other words, there is not sufficient time within the arbitration period to send a response, which is an elapsed time greater than or equal to N-x. After the wait, device 110 transitions via transition 1832 to listen state 1804. From listen state 1804, device 110 can transition via transition 1826 to idle state 1806 if device 110 is finished.

As shown in FIG. 19, a second arbitration request acknowledgment 1908 is transmitted during an arbitrator request period following the arbitration window. A second arbitration window follows the request period in which acknowledgment 1908 is transmitted. The first, second, and third recipients have entered the idle state 1806, which corresponds to sleep state 1910, sleep state 1912, and sleep state 1914, respectively, while the fourth recipient sends response 1916.

In some embodiments, a synchronized access with guaranteed time slots may be utilized. In that case, each device 110 is provided with a time slot for a response and each device 110 response to a request during its assigned time slot.

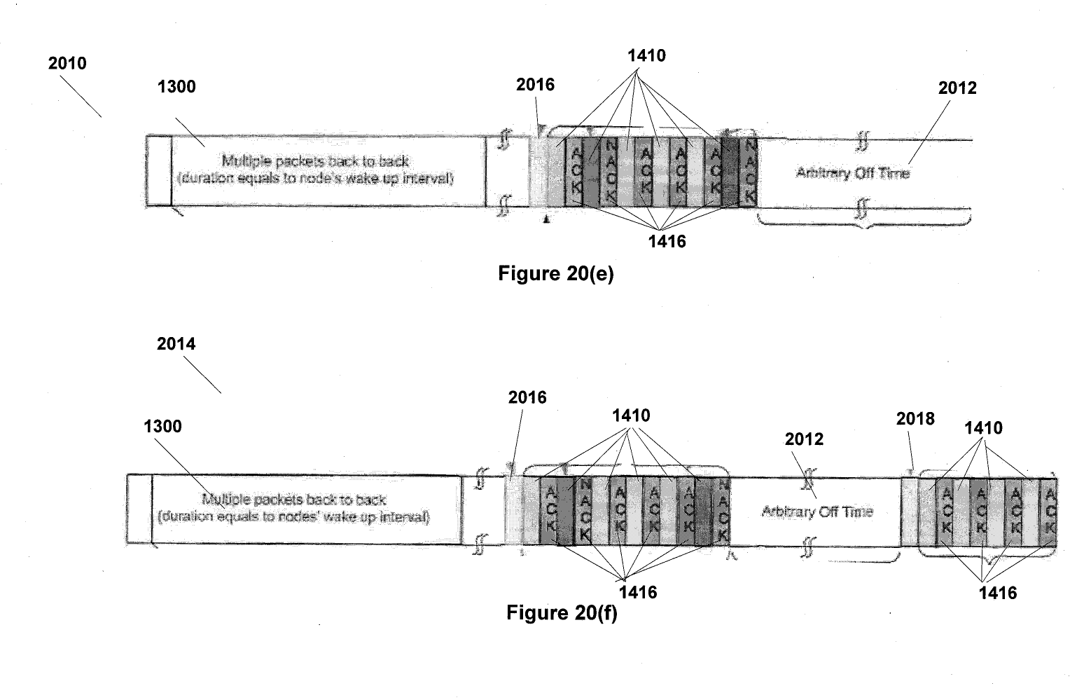

In communicating between devices 110 as shown in FIG. 1(a), there are several routing types. For example, there are unicast routing, multicast routing, broadcast routing, and anycast routing. FIGS. 20(a) through 20(d) illustrate dialogs between devices 110 utilizing each of these routing types.

FIG. 20(a) illustrates the dialog between a requesting device 2002 and a responding device 2004 in unicast routing. Both device 2002 and device 2004 are ones of devices 110 shown in FIG. 1(a). Unicast routing is a point-to-point dialog between device 2002 and device 2004. Request frame 1410 and response frame 1416 in a unicast dialog each contain routing information that is unique to one other device only. Therefore, as shown in FIG. 20(a), a request frame 1410 from the requesting device 2002 results in a response frame 1416 only from the uniquely identified responding device 2004.

FIG. 20(b) illustrates a dialog of multicast routing. In multicast routing, the dialog originates from one of devices 110, the requesting device 2002, but elicits responses from multiple other devices 110, responding devices 2004, 2006, and 2008. Request frame 1410 from one device contains routing information that is unique to an arbitrary number of responding devices 2004, 2006, and 2008. Response frames 1416 include routing information that can uniquely identify the originator of the multicast dialog. As shown in FIG. 20(b), a request frame 1410 from the requesting device 2004 results in response frames 1416 from all of the responding devices 2004, 2006, and 2008 that match a search criteria.

FIG. 20(c) illustrate a dialog of broadcast routing. Broadcast routing originals from one of devices 110, the requesting device 2002, and is responded to by all available other devices 110, the responding devices 2004, 2006, and 2008. As shown in FIG. 20(c) the requesting device request frame 1410 results in responses from any of the other devices 110, in this case devices 2004, 2006, and 2008. In some embodiments, it is also possible to send broadcast response frames 1416 that are received by any number of other devices 110. The request frame 1410 in broadcast routing does not include routing information that identifies particular ones of devices 110. Broadcast dialogs may or may not elicit responses.

FIG. 20(d) illustrates a dialog consistent with anycast routing. Anycast routing can be a subset of multicast routing, with the primary difference being that the goal of multicast routing is to receive responses from all of devices 110 that match the routing information, whereas the goal of anycast routing is to finish in a short period of time even if all of devices 110 that match the search criteria in the routing information have not successfully responded. As shown in FIG. 20(d), the request frame 1410 from the requesting device 2004 results in response frames 1416 from identified responding devices 2004, 2006, and 2008. In some embodiments, anycast routing can be utilize in multi-hop communications (involving transfers of request frames 1410 and response frames 1416 through multiple ones of devices 110).

Unicast, broadcast, and multicast routing can be useful for single-hop packet routing. Single-hop packet routing refers to dialogs between individual ones of devices 110. For example, in FIG. 1(b) dialogs 132, 134, and 130 illustrate single-hop routing. However, unicast and anycast can be utilized in multi-hop packet routing. Multi-hop routing occurs when request frame 1410 and response frame 1416 are transferred through at least one other device 110 between requesting device 2002 and responding device 2004. Multi-hop routing is illustrated in FIG. 1(b), for example, by dialog 140 and 142, 144, and any one of dialogs 146, 148, or 150.

FIG. 20(e) illustrates an extended dialog 2010 between requesting device 2002 and responding devices 2004 utilizing unicast routing. As shown in FIG. 20(e), a wakeup packet 1300 is sent. After the end of the wakeup packet, requesting device 2002 sends request packet 2016 to a particular identified device 110, which include the ID of the identified devices and other information. The identified device 110 sends one or more response packets 1410. The requesting device then sends ACK or NACK 1416 to the identified device after each response is received. A time off period 2012 extends from the end of the time period for dialog 2010. In some embodiments of the invention, responses 1410 can be arbitrated by arbitrated CSMA process 1700 as shown in FIG. 17, although slotted CSMA or some other scheme may be utilized. In some embodiments, responses 1410 and ACK/NACKs 1416 represent an extended dialog between requesting device 2002 and responding device 2004. In some embodiments, responses 1410 and ACK/NACK 1416 can represent multiple unicast dialogs with different devices 110.

FIG. 20(f) illustrates an extended dialog between requesting device 2002 and responding devices 2004, 2006, and 2008 in multicast routing 2014. As shown in FIG. 20(f), following wakeup packet 1300 requesting device 2002 and responding devices 2004, 2006, and 2008 can correspond utilizing arbitrated CSMA as shown in FIG. 19, or as shown in FIG. 20(f) into a slotted CSMA scheme where requesting device sends request 2016, followed by responses 1410 from responding devices 2004, 2006, and 2008, and then ACK or NACK 1416 from the requesting device. After a time out period 2012, requesting device 2002 can send another request 2018.

Devices 110 may support any number of data elements that are stored within device 110, some of which can be transmitted in frame data 1210 shown in packet 1200 of FIG. 12. Those elements can include, for example, un-addressable elements, a real time clock element, a key table element, a device ID element, a Protocol ID element, privileges and authentication elements, universal data block (UDB) elements, raw data block (RDB) elements, or any other data elements. For example, the RTC value can be in an un-addressable element. Data elements can include ISO 15963 device IDs such as a universal ID (UID) or a virtual ID (VID). An example UID can have an 8 bit AFT, an 8 bit Manufacturer ID, an 8 bit flex field, and a 40 bit serial number. A VID can be a shortened version of the VID and may be used within a network.

Data elements may include protocol IDs that identify an encapsulated protocol that may be included in a data frame 1510. Further, data elements may include authentication data, which may include cryptographic keys or access privileges. System configuration data elements can include lists of available features, lists of supported protocol IDs, lists of universal data block (UDB) type codes supported by device 110, scheduling configurations, or channel scan configurations. Other data elements can include received signal strength indication (RSSI) location data lists, IPv6 addressing data, ISO 21451-7 sensor and alarm lists, UDB legacy elements, or UDB extended elements.

Less structured data can also be utilized through a raw data block (RDB) system. An RDB can be implemented with a file system that defines the privileges and file lengths of the data. Reads and writes can be performed. The Coffee File System, for example, utilizes 64 kB ROM memory and 173 bytes of RAM in device 110 and stores the privileges for each file and allows dynamic allocation. Coffee was designed for flash memory systems.

Un-addressable data elements are data elements that are not addressable by a particular used protocols. Such data elements may be user defined data elements and may be utilized to pass any data between devices 110. Some examples may be inventory data, GPS location data, environmental conditions data, access history data, or any other data that may be utilized by the user to track an article to which device 110 may be attached. Such data may or may not be encrypted according to user specifications.

A real time clock (RTC) element indicates a time. In some embodiments, for example, the real time clock can be formatted as a 32 bit integer pertaining to the number of seconds since 1 Jan. 1970, 0:00 (UTC format). The real time clock may be accessible, for example, through a synchronization UDB data element.

In some embodiments, devices 110 can support encryption and authentication requirements, which may utilize a key table. The key table can include a cryptographic key for each device 110 that establishes authentication via an authentication comment, as well as a key lifetime field that can also be defined by the authenticate command. As such, the key table can include a key for each authenticated device and the level of authentication for each authenticated device. A particular key need not be retained indefinitely and may expire after a period of time. In embodiments where multiple encryption methods can be utilized, the key table element may include information regarding the type of cryptography that each key utilizes. In some embodiments, the key table may be implemented such that when device 110 is turned off it is deleted.

A device ID element may also be utilized. In some embodiments, the device ID structure may be compliant with ISO 15963. Further, the device ID structure may be a universal ID (UID) or a virtual ID (VID).

A UID element may include an application code (AC) field, a manufacturer ID, an extension field, and a serial number. In some embodiments, the UID can be arranged (from most significant bit (MSB) to least significant bit (LSB)) with the AC field having 8 bits, the manufacture ID having 8 bits, the Extension having 8 bits, and the Serial Number having 40 bits. However, other arrangements and sizes of UID fields can be utilized.

An application code (AC) field holds a value corresponding to the type of application for which device 110 is intended. In some embodiments, the AC can be consistent with the DASH7 Alliance definition. Some embodiments may be in compliance with ISO 159683, in which case the AC field is one byte encoded as 000xxxxx, where the variable bits are declared in ANS INCITS 256 and may be extended.

The manufacture ID field holds a value indicating the manufacturer of device 110. In some embodiments, manufacturer ID's are allocated by the DASH7 Alliance and uniquely identify the particular manufacturer of device 10. In some embodiments, the manufacture ID field can be two bytes in length.

An extension field can also be included. The extension field can be a two byte field which is set to 0x00, although in some cases the field may contain the upper 8 bits of the 16 bit manufacturer ID.

The serial number is unique to device 110. In some embodiments, the serial number may be the lower 8 bits of the manufacturer ID concatenated with a 32 bit ID associated with device 110. In some embodiments, the entire serial number can be assigned by the manufacturer, which when combined with the manufacturer ID and extension field results in a unique serial number for device 110.

A virtual ID (VID) is an ID that is unique to the local network, i.e. system 100, but may not be universally unique. Furthermore, the VID may be assigned to a device 110 by another device 110 of system 100. In some embodiments, the VID can be compliant with ISO 15963 and can be a truncated version of the UID. VID can be of any size, for example 16 bits.

The protocol element can identify which of the different protocols that are supported by device 110. In some embodiments, the protocol element field can be two bytes. In some embodiments of RFID system 100, device 110 may be required to support some protocols while not supporting other protocols. For example, Table 10 provides an example embodiment of an RFID system 100 indicating the protocol IDs for various protocols and which are mandatory, which are optional, and which are not supported (deprecated). Of particular interest in Table 10 is the ISO 18000-7 mode 2 protocol (mode 2), provided with protocol ID 0x51. The mode 2 protocol is particularly discussed herein as a specific example of embodiments of the present invention.

TABLE 10
Protocol ID Bytes

| | | Status in Mode 2 |
|---|---|---|
| ID | Description | devices |
| 0x31 | ISO 18000-7 Version 0 (Mode 1) | Deprecated |
| 0x40 | ISO 18000-7 Version 1 (Mode 1) | Optional |
| 0x51 | ISO 18000-7 Mode 2 Native Protocol | Mandatory |
| 0x52 | Mode 2 UDB Protocol | Mandatory |
| 0x53 | Mode 2 RDB Protocol | Mandatory |
| 0x54 | Mode 2 Private Key Protocol | Mandatory |
| 0x55 | Mode 2 Public Key Protocol | Optional |
| 0x56 | IPv6 | Optional |
| 0x57 | IEEE 1451.7 Protocol | Optional |
| 0x58-0x5F | Mode 2 RFU | Optional |
| 0x80 | ISO 18185 | Deprecated |
| 0xC0 | ISO 17363 Shipment Tag | Optional |

A privileges and authentication element can be utilized to identify privilege and authentication data. In some embodiments, data elements are specified with individual privilege and authentication information. For example, each UDB search code may include its own privilege code. Further, each UDB element may include its own privilege code. Further, each raw data block (RDB) element may contain its own privilege code. Data elements can be accessed by a user according to that user's type and according to the privilege code of the data element.

The user element can be utilized to support different users of the RFID system 100 network. Different data elements may be accessible to different users. Further, read/write privileges may be different for each user. In some embodiments, for example, user types may include root, admin, and user. A root user may be a super-user or device 110's internal system. A root user may read and write any data element in device 110. An admin user is an authenticated user and may read and write to specified data elements only. A user may read or write to a restricted set of specified data elements only. In some embodiments, a root user is authenticated by a root key and an admin user can be authenticated by an admin key. A general user may not require authentication.

In some embodiments, a privilege code can be stored in a byte that indicates access to a specific data element. Table 11 illustrates the format of a privilege code byte according to some embodiments of the present invention. As such, the privilege code is a 6 bit mask, stored as a mask, that declares the read and write status of a given data element. The root privileges are set to “11” to allow access to each data element to root type users. Other privileges are set for each data element according to user type.

TABLE 11
Mode 2 Privilege Code Structure

| | | | |
|---|---|---|---|
| Unused | Root | Admin | User |

| b7 | b6 | b5 | b4 | b3 | b2 | b1 | b0 |
|---|---|---|---|---|---|---|---|
| 0 | 0 | 1 | 1 | X | X | X | X |

There can be any number of universal data block (UDB) elements. UDB elements are defined and specifically identified. An example set of UDB elements and their ID codes is described in Table 12. The ID code, for example, can be a two byte code. Some embodiments of the invention can perform reads and writes to arbitrary UDB elements while referencing the ID code. These encapsulated data elements can define the capabilities, status, and settings of device 110. Further, utilization of UDB elements allows multiple ones of devices 110 to efficiently advertise their capabilities by being read. Further, new UDB elements can be identified.

The UDB codes themselves can include device proprietary data, standard device settings, PHY configuration, schedulers, time periods, protocol lists, code lists, RDB element identification, locations, addressing, sensor lists, alarm lists, authentication keys, routing codes, user IDs, hardware faults, and application data. The particular example of UDB element definitions provided in table 12 is one example only. Embodiments of the invention may include some of these and other elements that may be defined. UDB elements can further be associated with privilege code access as described above.

UDB elements can further be typed according to description. For example, UDB types can include transit data, hardware faults, device capabilities, location, and extensions. Table 13 provides an example of UDB type codes as described with the set of UDB elements shown in Table 12.

TABLE 12
Mode 2 UDB Elements

| ID | Description | Contents |
|---|---|---|
| 0x00 | Device Proprietary Data | Proprietary variables for configuration and |
| | | basic settings, such as UID and VID |
| 0x01 | Standard Device Settings | Features and capabilities supported by this |
| | | device |
| 0x02 | PHY Configuration | List of available transport channels in the |
| | | local network with link regulation data for |
| | | each |
| 0x03 | Real Time Scheduler | Handle to RTC value and scheduler mask |
| 0x04 | Sleep Scan Periods | SSP and sync offset for each active channel |
| 0x05 | Hold Scan Periods | HSP and sync offset for each active channel |
| 0x06 | Protocol List | ID string for supported protocol IDs |
| 0x07 | UDB type Code LIst | ID string for supported UDB type codes |
| 0x08 | RDB Element List | ID string of stored RDB elements |
| 0x09 | Location Data List | Coordinate list of Mode 2 devices and vertex |
| | | data for location calculation |
| 0x0A | IPv6 Addressing | IPv6 addresses |
| 0x0B | IPv6 Element 2 | Reserved for future IPv6 Addressing data |
| 0x0C | ISO 21451-7 Sensor List | List of IEEE 1451.7 sensors included on this |
| | | device formatted according to PID 0x57 |
| 0x0D | ISO 21451-7 Alarm List | List of IEEE 1451.7 sensor IDs with active |
| | | alarms |
| 0x0E | Root Authentication Key | Authentication key stored according to |
| | | supported private or public key protocols |
| | | (PIDs 0x54, 0x55) |
| 0x0F | Admin Authentication Key | Authentication key stored according to |
| | | supported private or public key protocols |
| | | (PIDs 0x54, 0x55) |
| 0x10 | Routing Code | See ISO 18000-7 Mode 1 |
| 0x11 | User ID | See ISO 18000-7 Mode 1 |
| 0x12-0x15 | Reserved | |
| 0x16 | Hardware Fault Status | See ISO 18000-7 Mode 1 |
| 0x17 | UDB Extended Services | Descriptor list for supported extended |
| | List | services |
| 0x18 | UDB Ext Services Alarm | List of extended services IDs with currently |
| | List | active alarm conditions |
| 0x19-0x7F | RFU | |
| 0x80-0xFE | UDB Extended Services | UDB Elements reserved for usage by the |
| | Elements | UDB extended services. |
| 0xFF | Application Extension | See ISO 18000-7 Mode 1 |

TABLE 13
Mode 2 UDB Type Codes

| Type Code | Description | UDB Element IDs |
|---|---|---|
| 0x00 | Transit Data | 0x10, 0x11, 0x18, 0xFF |
| 0x01 | Legacy Mode 1 | 0x12, 0x13, 0x14, 0x17, 0xFF |
| 0x02 | Legacy Mode 1 | 0x15, 0xFF |
| 0x03 | Hardware Fault Data | 0x16, 0xFF |
| 0x04-0x0F | Mode 1 RFU | |
| 0x10 | Device Capability | 0x01, 0x06, 0x07, 0x17 |
| | Information | |
| 0x11 | Location Data | 0x09, 0xFF |
| 0x12-0x7F | RFU | |
| 0x80-0x8F | UDB Ext. Service | Application-defined UDB |
| | Mailboxes | extended service |
| 0x90-0xFF | RFU | data element groups |

Device proprietary data UDB element includes the device addressing elements and can include the UID, the VID, and any additional proprietary variables that may be utilized for addressing purposes. As described above, the UID can be 8 bytes and the VID can be 2 bytes and therefore the UDB element can be 10+N bytes, depending on the size of the proprietary data. In some embodiments, the privilege settings for the proprietary data UDB can be root: rw, admin: rw, and user: r- (indicating that the root type user has read/write privileges, the admin type user has read/write privileges, and the user has read privileges but not write privileges).

The device settings UDB elements describe the features of device 110. In some embodiments, the device settings UDB element can be 11 bytes with one byte utilized to indicate the active regime, one byte utilized to indicate the supported regimes, one byte utilized to indicate the maximum subframe data length, one byte utilized to indicate the maximum frame length in terms of a number of subframes, two bytes utilized to indicate the maximum raw data block (RDB) block size, three bytes utilized to indicate the total available RDB memory, one bite utilized to indicate the maximum UDB type code length, and one byte utilized to indicate the maximum UDB type codes. The default user privileges for the device settings UDB element can be, for example, root: rw, admin: r-, user: r-.

The active regime and the supported regimes can, for example, be indicated by activating a bit in one of the three LSBs of one byte with bit 0 indicating the endpoint regime, bit 1 indicating the subcontroller regime, and bit 2 indicate the gateway regime. Similarly, the supported regimes byte can indicate which regimes are supported by device 110 by placing a “1” in the appropriate ones of the three LSBs of the byte.

The number of bytes utilized to designate a particular aspect of the device features dictates the values that can be indicated. The maximum data subframe length can be, for example, between 1 and 255 bytes. In some embodiments, a minimum, for example 64, for the size of the subframe length can be utilized. The maximum data frame length can be, for example, 1 to 255 subframes. The maximum RDB block size can be set between 0 and 65536 bytes. The total available RDB memory can be set between 0 and 16777216 bytes. The maximum UDB type code length can be set between 0 and 255 UDB element IDs. The maximum UDB type codes can be set between 0 and 255.

The PHY configuration lists the available transport channels in the local network formed by system 100 and the link regulations that apply to each transport channel. In some embodiments, the length of the PHY configuration can be six bytes per supported transport channel. The transport channel ID can be indicated with 1 byte; the channel power selector can be indicated in 1 byte, the maximum transmit duration can be set with two bytes, and the post transmit wait duration can be set with two bytes. The default privileges can be root: rw, admin: rw, and user: r-.

Examples of transport channel ID definitions are indicated above with respect to Tables 5 and 6. Maximum TX duration and Post TX duration, utilizing two bytes, can be set between 0 and 65535 ms. The channel power selector can be utilized to set the channel power to auto-select or between a minimum and maximum power output. For example, bits 5:0 of the byte can provide a power value such that the power output is given by Minimum+b5:0 dBm. The minimum power, for example, can be set at −40 dBm. In some embodiments, an autoscale feature can be utilized, for example by setting bit 7 of the channel power selector byte. The autoscale feature adjusts the power of device 110 according to the strength of the received signal.

The real time scheduler UDB element allows devices to schedule wake-up scan periods with relative accuracy. The scheduler UDB element includes a handle to a RTC element and dictates the scheduled duration. Devices 110 operating in the endpoint regime can apply scheduling to the sleep scan period in the sleep state, as illustrated, for example, in FIG. 8(c). Devices 110 operating in the subcontroller regime can apply scheduling to the hold scan period in the hold state. In some embodiments, the scheduler UDB element can be 22 bytes in length where a real-time clock (RTC) value is provided in four bytes, an RTC fractional value is provided in two bytes, a sleep scan period (SSP) sync mask is provided in four bytes, a SSP sync value is provided in four bytes, a hold scan period (HSP) sync mask is provided in four bytes, and a HSP sync value is provided in four bytes. The default privileges can be set as root: rw, admin: rw, and user: r-.

The RTC value can be a copy of the lower four bytes of the device RTC element discussed above. The RTC fractional value can, then, be a value between 0 and 65535, providing fractional seconds in 1/65535 intervals. The SSP sync mask can be a 32 bit mask for comparing the RTC with the sync value in a sleep scan of the sleep state. The SSP sync value is a 32 bit compare value for the sleep scan. The HSP sync mask is a 32 bit mask for comparing the RTC with the sync value in a hold state. The HSP sync value is a 32 bit compare value that can be utilized in a hold scan. Other values and bit sizes can be utilized for these fields.

The sync mask and sync value attributes align partly with the RTC value and partly with the RTC fractional value. The upper two bytes of the RTC value are not compared. When the masked RTC value compares identically to the Sync Value, the device begins its scan period. The default values for the Sync Mask and Sync Value attributes can be set for particular values. For example, the SSP can be set for 2.88 seconds while the HSP is set for 72 ms. Other values can be utilized.

The RTC value can be a shadow register of the RTC data element discussed above. When the synchronization UDB element is read, the RTC value can be copied from the RTC data element. When the synchronization UDB element is written, the RTC value can be written into the RTC data element.

The sleep channel scan period list can be an ordered list of channel scan period data elements. When device 110 begins its sleep scan period, the first transport channel in the list of the channel scan periods can be scanned for wake-up frames. If no wake-up frame is found, device 110 will wait for the period in the next scan before repeating the process on the next transport channel in the list. In the event that the sleep scan period occurs before all the listed channels can be scanned, device 110 restarts the sleep scan period from the initial channel scan period. In some embodiments, three bytes can be utilized for each transport channel in the scan list. The channel ID can be included in one byte and the next time scan can be two bytes that indicate the time to wait before scanning the next channel in the list. The default privilege can be root: rw, admin: rw, user: r-.

The hold channel scan period list can be identical to the sleep scan period list and is utilized in the hold state. The default privileges can be root: rw, admin: rw, user: r-.

The protocol list is a list of protocol IDs that are supported by device 110. In some cases, the protocol list can be sorted, for example in ascending order. The protocol list can be written once during the initial loading of firmware onto device 110. However, in some embodiments it may also be issued dynamically to activate or deactivate different protocols. The protocol list element can be one byte for each protocol ID. A list of example protocol IDs is provided in Table 10. The default privilege can be root: rw, admin: rw, and user: r-.

The UDB type code list element includes a list of UDB type code IDs supported by the device. The UDB type code list element includes one byte per supported type code IDs. A list of example type code IDs is provided in Table 13. The default privilege is root: rw, admin: r-, and user: r-.

The RDB element list provides a list of RDB elements that are currently active. The RDB element list can be automatically updated when RDBs are added or removed. The list can be managed as a typical stack, with the most recently accessed RDB element at the front of the list. The RDB element list can be one byte for each RDB element ID. The default privilege can be root: rw, admin: r-, and user: r-.

The location data list element is location data obtained from other of devices 110. In some embodiments, received signal strength indicator (RSSI) data is provided. In that case, the location data can be stored as a list of device IDs and RSSI data. For example, the captured device ID from a near-field device 110 can be conveyed by location coordinate and represented in the location data list as a single coordinate list. In some embodiments, the location data list can be 10 bytes per location coordinate. The origin ID can be two bytes or eight bytes, the RSSI captured on antenna 2 can be one byte, and the RSSI captured on antenna 2 can be one byte.

The IPv6 addressing data element in device 110 includes unicast, anycast, and multicast addressing parameters. In some examples, the addressing data element can include 48 bytes with the IPv6 unicast address being 16 bytes, the anycast address being 16 bytes, and the multicast address being 16 bytes. The unicast address is the address of device 110, the anycast address in the anycast address vector, and the multicast address is the multicast address vector. The default privilege can be root: rw, admin: rw, and user: r-. The IPv6 element 2 referred to in Table 12 is reserved and associated with the IPv6 addressing data element.

The ISO 21451-7 sensor list element includes a list of ISO 21451-7 sensor IDs that are included in device 110. The default privileges can be root: rw, admin: r-, and user: r-.

The ISO 21451-7 alarm list includes the alarm status of the ISO 21451-7 devices in the ISO 21451-7 sensor list element. The default privileges can be root: rw, admin: r-, and user: r-.

The root authentication key element in device 110 is the authentication key for root access. The key can be encrypted and, for example, stored in a private key protocol or public key protocol. The default privileges are root: rw, admin: --, and user: --.

Similarly, the admin authentication key is a key that enables admin access. The key can be encrypted and, for example, stored in the private key protocol or public key protocol. The default privileges are root: rw, admin: rw, and user --.

The routing code element can be that utilized in the ISO 18000-7 mode 1 protocol. The default privileges are root: rw, admin: rw, and user: r-. The routing code element is a user readable and writable memory whose purpose and size, in some cases up to 50 bytes, is user defined. The UDB element ID, as shown in Table 12, is 0x10. The length is N bytes.

The HW fault status element can be that utilized in ISO 18000-7 mode 1 protocol. The default privileges are root: rw, admin: r-, and user: r-. Examples of hardware faults include hardware reset count, watchdog reset count, and a hardware fault bitmap, which may include a low battery flag. The element may include three bytes of data: the lifetime count of hardware resets, the lifetime count of firmware resets, and the hardware fault bitmap. The hardware fault bitmap byte can include a low battery bit (e.g., bit 0) and a memory corruption bit (e.g., bit 1). The UDB extended services list element provides a way to integrate data formats and external technologies that are not explicitly supported by available protocols already defined. The length is variable. The extended services list element can provide a length N in one byte and then N bytes of individual information. The extended services list can provide a length M+1 in one byte, an extended services ID in one byte, and then a description of the services in M bytes. The default privileges can be root: rw, admin: r-, and user: r-.

The UDB extended services alarm list can provide interrupts or alarms. The length is variable. In some embodiments, a length N is provided in one byte and then N bytes each provide an extended service ID of the alarm. The default privileges can be root: rw, admin: rw, user r-.

The UDB extended service elements may be additional elements defined in a particular application. The length of the element is dependent on the particular element and application. The default privileges can be root: rw, admin: r-, and user: r-.

The UDB application extension can be the same as described in ISO 18000-7 mode 1. The default privileges can be root: rw, admin: rw, and user: r-. The Universal Data Block may include one or more UDB application extension blocks that encapsulate one or more type/length/data frames, which can be identified by an Application ID. Individual devices may support extensions defined by one or more vendors.

The Raw Data Block (RDB) element can be a 24 bit, byte-addressed virtual address space for unstructured data that includes a one byte RDB ID and a two byte block address. In some embodiments, the RDB data can be separated into individual blocks, for example 64 kB blocks, each administered by an RDB element including a privilege code, 16 bit max size attribute (the maximum data per the block), a 16 bit size attribute (the number of actual bytes written). The default privilege can be root: rw, admin: r-, and user r-.

Dialog between devices 110 is governed by a defined protocol. In some embodiments, a Mode 2 protocol layer is utilized. As discussed above with respect to FIGS. 12 through 14, there are specific types of frames. For example, there are wake-up frames, request frames, response frames, and data frames. Request frame, response frame, and data frames all include data payloads. The structure of a packet 1200 that includes a frame 1210 is discussed with respect to FIG. 12. A request frame 1410 is discussed with FIG. 14, a response frame 1416 is discussed with FIG. 14, and a data frame 1510 is discussed in FIG. 15. Wake-up frames can have a fixed structure and data type that are not relevant to a particular defined protocol.

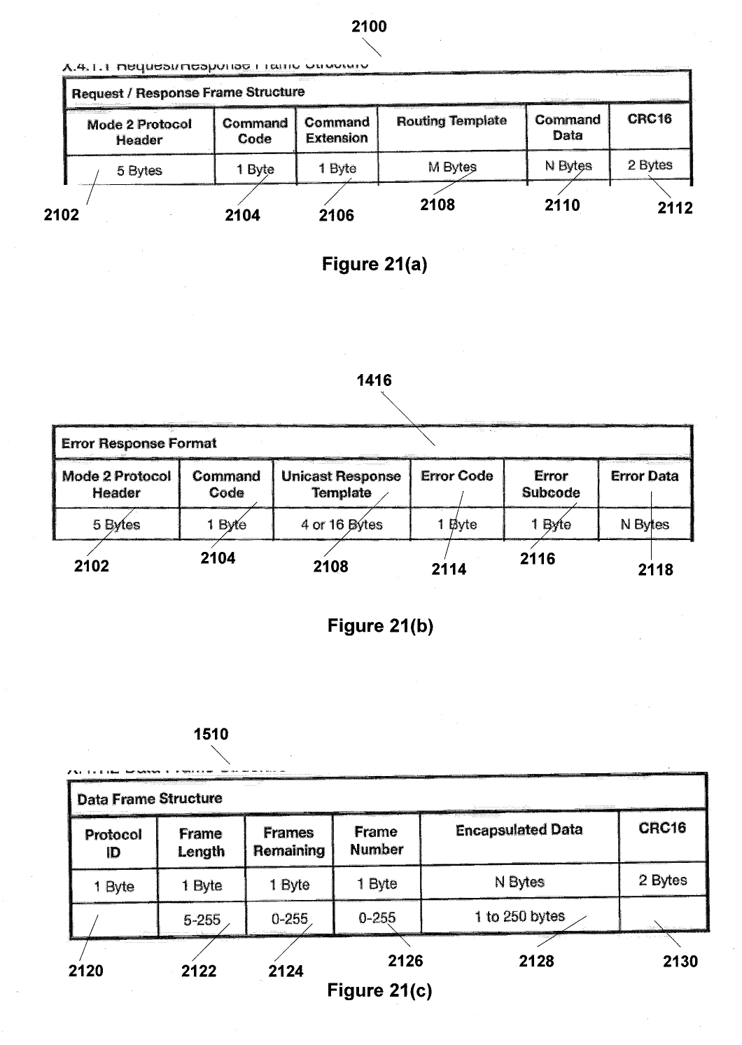

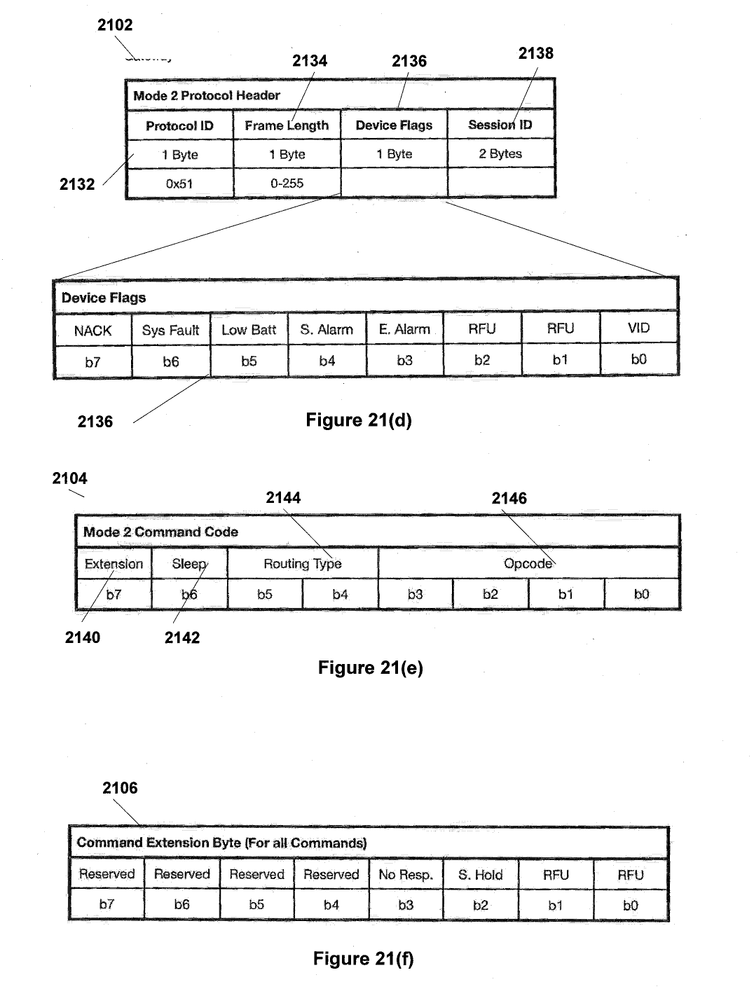

FIG. 21(a) illustrates a frame 2100, which can be either a request frame 1410 or a response frame 1416 as shown in FIG. 14. Frame 2100 is transmitted in a corresponding packet by one of devices 110. As shown in FIG. 21(a), frame 2100 includes a protocol header 2102, a command code 2104, may include a command extension 2106, a routing template 2108, may include command data 2110, and may include CRC16 data 2112. In some embodiments, some of the fields, for example command extension 2106 and command data 2110, may not be included. Although these fields can be of any length, in some embodiments protocol header 2102 can be 5 bytes, command code 2104 can be 1 byte, command extension 2106 can be 1 byte, routing template 2108 can be M bytes, command data 2110 can be N bytes, and CRC16 data 2112 can be 2 bytes.

Protocol header 2102 depends on the particular protocol utilized by sending device 110. A list of example protocols is provided as Table 10. For purposes of example, the ISO 18000-7 Mode 2 protocol (the Mode 2 protocol) is particularly discussed, however some embodiments of the invention can utilize other protocols as well. Other protocols may utilize different protocol headers and frame structures.

Depending on the particular protocol, a request/response frame structure 2100 may include control directives which instruct one or more devices to enter sleep state or stay active, provide an ACK or Negative ACK (HACK), provide responses to timeouts, or provide allowable response channels to utilize. Some protocols may provide for security authentication, for example cryptographic challenges and responses or key timeouts. Protocols may allow for batch read and write subprotocols, for example for UDB or RDB elements. Protocols may also allow for encapsulated protocols to utilize in data frames 1510.

In the Mode 2 protocol, protocol header 2102 can be 5 bytes in length. FIG. 21(d) illustrates protocol header 2102 for the Mode 2 protocol. As shown in FIG. 21(d), protocol header 2102 includes a one byte protocol ID 2132, a frame length 2134, a device flag 2136, and a session ID 2138. As shown, protocol ID 2132 may be given by the protocol ID (0x51 from Table 10 for mode 2). Protocol ID 2132 identifies the protocol to be utilized. If set to 0x51 as shown in Table 10, then a receiving device knows that a mode 2 protocol header will immediately follow.

Frame length 2134 provides the length of the frame in bytes, not including the one byte for protocol ID 2132. With one byte, the frame length can be set between 0 and 255 bytes.

Device flags 2136 provides one byte of alert flags regarding either requesting or responding device 110. In the mode 2 protocol, device flags 2136 is one byte given by bits b7 to b0 as illustrated in FIG. 21(d). Bit 7 is a NACK, which is set on negative-acknowledgement and utilized in a response. Setting the NACK flag may indicate that an error exists in the received frame and the response frame 1416 is an error response. Error responses are discussed further below.

Bit 6 of device flags 2136 is a system fault flag, which is set on the condition that device 110 should be replaced or serviced due to the appearance of a technical problem. The system fault flag can be cleared only after a cold boot of the sending device 110. Bit 5 of device flags 2136 is a low battery flag, which is set on the condition that the battery in device 110 is low. In some embodiments, the battery low flag conveys that device 110 has about 500 hours of usage remaining. Bit 5 can be cleared automatically when the battery in device 110 is no longer low in charge.

Bit 4 of device flags 2136 is set when an alarm-enabled sensor declares an alarm. Bit 4 is cleared automatically after all alarms in the sensor alarm UDB element are clear. Bit 3 of device flags 2136 is set when any alarm-enabled extended service declares an alarm. Bit 3 is cleared automatically after all alarms in the extended services alarm UDB element are cleared.

Bits 2 and 1 of device flags 2136 are currently unused. Bit 0 of device flags 2136 is set when any device IDs used in the frame are transmitted as 2 byte VIDs instead of 8 byte UIDs.

Session ID field 2138, which may be two bytes, identifies the session number of the current dialog. A response includes the same session ID value as the preceding request. After each request, the session ID value can be incremented. The session ID value can be re-computed as a new random number of device 110, for example if device 110 is in a subcontroller regime and enters the hold state or if device 110 is in a gateway regime and enters the listen state, unless it is currently managing an arbitrated CSMA dialog, as illustrated in FIGS. 18 and 19.

Following protocol header 2102 is command code 2104. As shown in FIG. 21(a), command code 2104 can be 1 byte. An example of command code 2104 is illustrated in FIG. 21(e). As shown in FIG. 21(e), command code 2104 can include an extension flag 2140, a sleep flag 2142, a routing type 2144, and an opcode 2146.

Extension flag 2140, bit 7, is set to indicate that command extension 2106 follows command code 2104 in frame 2100. If not set, there is no command extension 2106 following command code 2104, and all bits in command extension 2106 may be presumed to be set to 0. FIG. 21(f) illustrates an embodiment of command extension 2106. In some embodiments, only two bits, for example bits 2 and 3, are utilized. One bit of command extension 2106, for example bit 3, can be set to indicate that no response is required. Another bit of command extension 2106, for example bit 2, can be set to instruct the receiving device to enter a synchronous hold state rather than an asynchronous hold state following the dialog, which is valid for broadcast, multicast, and anycast routing types.

Sleep flag 2142 of command code 2104, bit 6, can be set to instruct the receiving device to enter the sleep state following the dialog. The routing type, bits 5 and 4, can be set to indicate routing type in routing type 2144. For example, broadcast may be indicated by“00”, anycast may be indicated by“01”, unicast may be indicated by “10”, and multicast may be indicated by“11”.

Opcode 2146, bits 3 through 0, can be set for an operation code. Examples of operational codes that can be utilized in device 110 are provided in table 14. and discussed in more detail below. Operational codes describe a set of operations inherent in the command and provide a method of instructing devices 110 to perform certain functions.

TABLE 14
OpCodes

| Opcode | Name | Br. | Un. | Mu. | An. |
|---|---|---|---|---|---|
| 0000 | Inventory from UDB Element | • | • | • | • |
| 0001 | Inventory from UDB Element | • | • | • | • |
| 0010 | Collection of UDB Element | • | • | • | • |
| 0011 | Collection of UDB Type | • | • | • | • |
| 0100 | Announcement of UDB Element | • | • | • | • |
| 0101 | Announcement of UDB Type | • | • | • | • |
| 0110 | RFU | | | | |
| 0111 | RFU | | | | |
| 1000 | Request Data Frame | | • | | |
| 1001 | Propose Data Frame | | • | | • |
| 1010 | Acknowledge Data Frames | | • | | • |
| 1011 | Authenticate | | • | | |
| 1100 | RFU | | | | |
| 1101 | RFU | | | | |
| 1110 | RFU | | | | |
| 1111 | Proprietary Command Extension | — | — | — | — |

As discussed above, if the NACK bit (bit 7) of device flags 2136 of protocol header 2102 is set, then an error response follows. FIG. 21(b) illustrates a response frame 1416 format for error responses. Error responses are transmitted following a problem with a request, whether it is an error in the protocol or an error in encapsulation, an error response is transmitted in a standard fashion. Error responses will be transmitted unless the request command included instructions not to response, e.g. the no response bit of the command extension 2106 is set. Encapsulated protocols may add additional error data to the error response.

As shown in FIG. 21(b), error response frame 1416 includes protocol header 2102, command code 2104, routing template 2108, and command data 2110 includes error code 2114, error subcode 2116, and error data 2118. Protocol header 2102 and command code 2104 are followed directly by routing template 2108. In this case, error messages can be always sent as unicast and so the unicast response template, discussed in further detail below with reference to FIG. 23(b), is provided. The unicast response template can be 4 or 16 bytes depending on whether the IDs utilized are UIDs or VIDs.

Following response template 2108 is the error code 2114. Error code 2114 can be one byte and specifically identifies the detected error. Following error code 2114 is the error subcode 2116, which may also be one byte in length. Following error subcode 2116 is error data 2116. Error data 2116 can be of any length and can include a detailed description of a particular error, for example a Mode 2 Native protocol error. An extended error data field may also be included for storage of information relating to errors with encapsulated data.

An example of a set of error codes that can be utilized is provided in Table 15. Other error codes and other errors may also be detected. The error codes listed in Table 15 are applicable to Mode 2 protocols.

As shown in Table 15, error code 0x01 is an invalid command code. An invalid command code indicates that the opcode provided in command code 2104 is not recognized by the receiving device. Error 0x02 indicates an invalid command parameter. An invalid command parameter indicates that a parameter provided is inconsistent with the command code provided.

As shown in Table 15, an opcode of 0x08 indicates an authorization failure. An authorization failure occurs when the requesting device does not have the appropriate privileges to access the requested data element, for example the UDB data elements, as provided in the request. For example, a multicast command where read protected UDB element is used for comparison. As another example, a read request to a read protected UDB element results in an authorization failure. In some embodiments, along with the error code, the privilege code is provided error subcode 2116.

TABLE 15
Error Codes

| Code | Description |
|---|---|
| 0x01 | Invalid Command Code |
| 0x02 | Invalid Command Parameter |
| 0x08 | Authorization Failure |
| 0x50 | Generic Encapsulated Protocol Error |
| 0x51 | VID Not Available |
| 0x52 | UDB Related Error |
| 0x53 | RDB Related Error |
| 0x54 | Private Key Cryptographic Error |
| 0x55 | Public Key Cryptographic Error |
| 0x56 | IPv6 Protocol Error |
| 0x57 | IEEE 1451.7 Protocol Error |

A generic encapsulated protocol error can occur if there is an error with a non-codified encapsulated protocol. In some embodiments, including the mode 2 example shown here, particular encapsulated protocols are encoded. In the mode 2 example, encoded encapsulated protocols include UDB, RDB, private key, public key, IPv6, and IEEE 1451.7. Each has its own specific error code, as shown in Table 15. The error code (0x50 from Table 14) is provided in error code 2114. Error subcode 2116 can provide the protocol ID, examples of which are shown in Table 10. Error data 2118, then; can be N bytes utilized to hold proprietary error data associated with the non-codified encapsulated protocol.

From Table 15, error code 0x51 indicates that the VID is not available. This error code is set when the VID bit of the device flags is set but the receiving device does not have VID functionality enabled, the receiving device has not been assigned a VID, or the VID of the receiving device has timed out. Error subcode 2116 may hold a reason code for the VID error.

Error code 0x52 is set to indicate an error in the data supplied in a request frame utilizing a UDB encapsulated protocol. Error data 2116 can be utilized to provide the specific UDB encapsulated protocol error data. Similarly, the RDB related error code, 0x53, is set to indicate an error with the data supplied in a RDB encapsulated protocol in a request frame. Error data 2116 can be utilized to provide the RDB encapsulated protocol error data.

A private key cryptographic error, set by setting error code 2114 to 0x54 as shown in Table 15, indicates that there is an error with the data supplied in a private key encapsulated protocol. Error data 2118 can be utilized to hold the RDB encapsulated protocol error data. Similarly, a public key cryptographic error, set by setting error code 2114 to 0x55 as shown in Table 15, indicates that there is an error with the data supplied in a public key encapsulated protocol. Again, error data 2118 can be utilized to provide the public key protocol error data.

The IPv6 error shown in Table 15 is set, for example by setting error code 2114 to 0x56, where there is an error with the IPv6 encapsulated protocol data. The IPv6 data error may be provided in error data 2118. Similarly, the IEEE 1451.7 error shown in Table 15 is set, for example by setting error code 2114 to 0x57, where there is an error with the IEEE 1451.7 encapsulated protocol data. The IEEE 1451.7 may be provided in error data 2118.

Returning to FIG. 21(a), if no error code is indicated by not setting the NACK bit of the device flag field of protocol header 2102, then a routing template 2108 follows command extension 2106 and command code 2104. As shown in Table 14, the operational codes included in the opcode portion of command code 2104 can be dependent on routing type, e.g. broadcast routing, unicast routing, multicast routing, or anycast routing. Routing template 2108 is consistent with the routing type identified the routing type bits (e.g., bits 5 and 4) of command code 2104. The format of routing template 2108 depends on whether frame 2100 is a request frame or a response frame.

As described above, broadcast routing involves one of devices 110 initiating a dialog or response to all available devices. Broadcast dialogs contain no routing compare information. A broadcast request may be acknowledge by a unicast or broadcast response on any of the channels specified in routing template 2108. Responses to broadcast requests can be conducted via non-arbitrated CSMA procedure 1700 as discussed with respect to FIG. 17.

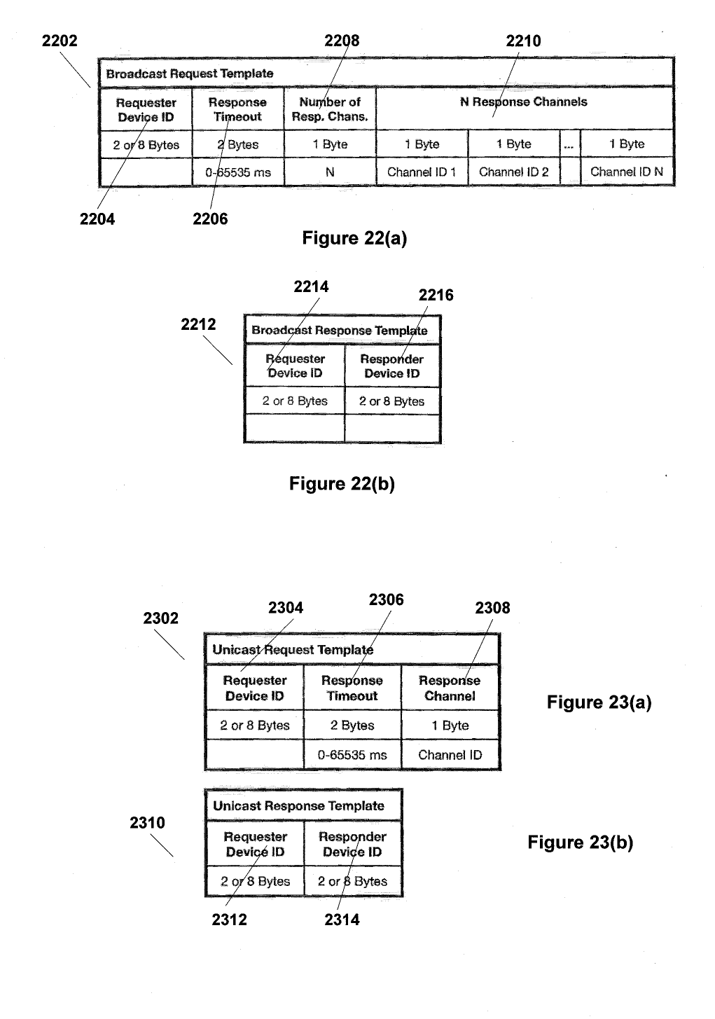

FIG. 22(a) illustrates an embodiment of a broadcast request routing template 2202. Broadcast request routing template 2202 can include a 2 or 8 byte requester device ID 2204, a 2 byte response timeout 2206, a 1 byte number of response channels 2208 holding value N, followed by N 1 byte transport channel identifications 2210. Requester ID 2204 is either the VID or UID of the requesting one of devices 110. Again, indication of which ID is provided in header 2102. The response timeout 2206 allows the requester to set a time between, for example, 0 and 65535 ms for a timeout. The response timeout indicates the amount of time the responding ones of devices 110 will spend engaged in the non-arbitrated CSMA process 1700 before giving up in step 1716.

The number of channels 2208 indicates the number of individual transport channels, N, over which responding devices 110 can transmit responses. Identification of the N identified channels is then provided in response channels 2210. As discussed above, examples of transport channel identification codes are provided in Tables 5 and 6 above. As devices enter non-arbitrated CSMA procedure 1700 as shown in FIG. 17, the random channels chosen in step 1702 are chosen from the list of response channels provided in routing template 2108.

FIG. 22(b) illustrates a response broadcast routing template 2212. As shown, template 2212 includes a requester ID 2214, which can be one 2 or 8 byte field holding the requester device ID, followed by a responder ID 2216, which is a second 2 or 8 byte field holding the responder device ID. If the responding device is responding to a requesting device through a third device, then a third field, which may be a 2 or 8 byte, holding the forwarder's device ID can also be included.

FIG. 23(a) illustrates a requester unicast routing template 2302 that can be utilized as routing template 2108. As discussed above, a unicast routing is between two particular ones of devices 110. As such, routing template 2302 is a request frame that uniquely describes one other device 110. As shown in FIG. 23(a), template 2302 includes a requester device ID 2304, a response timeout 2306, and a response channel 2308. Requester device ID 2304 holds the requester identification, which is 2 or 8 bytes depending on utilization of the UID or VID. Response timeout 2306 provides a timeout for utilization in arbitration, for example the response timeout to be used in non-arbitrated CSMA process 1700 (after the MGT time has not been met). Response channel 2308 indicates the transmission channel ID on which to respond.

The response to a unicast request may be acknowledge by a unicast response or a broadcast response. FIG. 23(b) illustrates a response unicast routing template 2310. Template 2310 includes a requester device ID 2312 and a responder device ID 2314. Requester device ID 2312 holds the identification of the requesting device while responder device ID 2314 holds the identification of the responding device. Each of the identifications may be 2 or 8 byte fields, depending on whether the device ID is a UID or a VID.

The response delivery mechanism for a unicast dialog can be non-arbitrated CSMA process 1700 unless the response channel is the same as the request channel, in which case responding device 110 may forgo using any kind of CSMA as long as it transmits within the MGT (e.g., 6 ms) of the conclusion of the request packet. If the response device 110 cannot manage to transmit a same channel response within the MGT, it then may use the non-arbitrated CSMA process 1700.

As discussed above, multicast routing is initiated by a requesting device 110 and elicits responses from multiple identified devices 110. If frame 2100 is a request frame, it includes routing information that may be unique to an arbitrary number of devices 110. If frame 2100 is a response frame, it contains routing information that can uniquely identify the requesting device 110.

In order to sufficiently transmit a request to multiple, identifiable devices 110 and expect to receive responses from the identifiable devices 110 can utilize a mask and compare technique for identification. Further, responses from multiple devices 110 that match the mask can be handled through arbitrated CSMA process 1800 as described in FIG. 18. Devices 110 that compare successfully to the mask and value in the request frame 2100 enter arbitrated CSMA process 1800. After each window expires, the request device, which is the arbitrator as well, transmits an arbitration request, which acknowledges those devices 110 that have successfully responded and refines the value from the initial request.

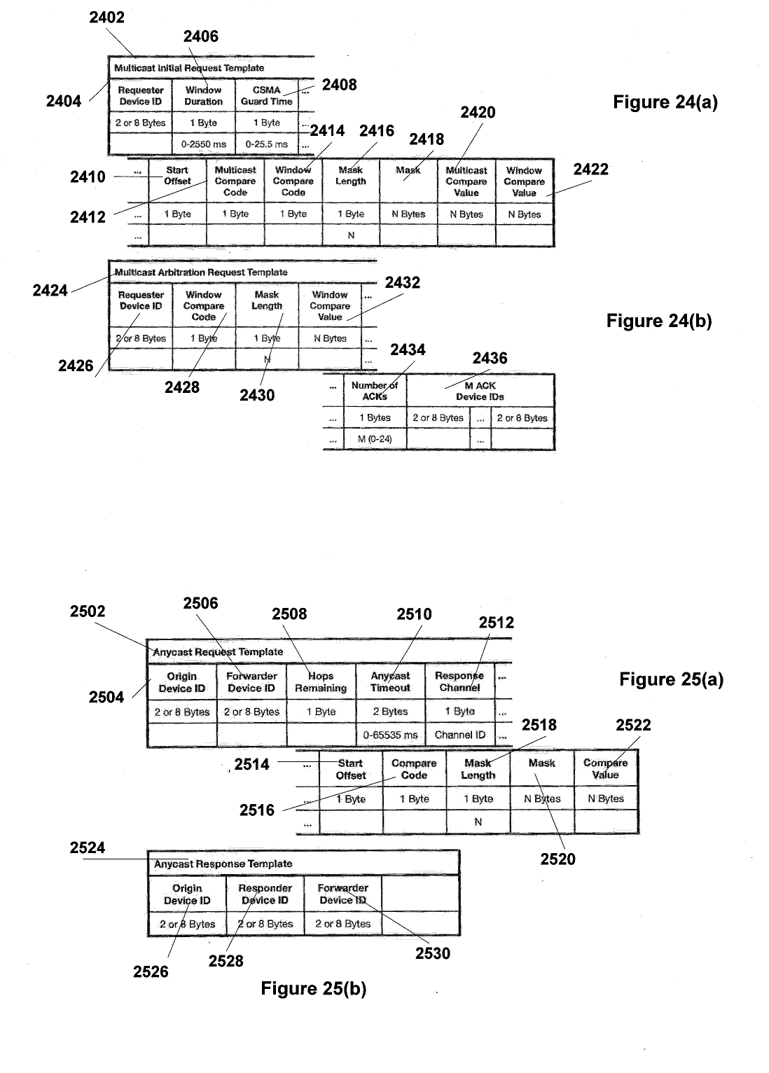

FIG. 24(a) illustrates a routing template 2402 appropriate for template 2108 if frame 2100 is the initial request frame, shown as request 1902 in FIG. 19. As shown in FIG. 24(a), template 2402 includes a requester device ID 2404, a window duration 2406, a CSMA guard time 2408, a start offset 2410, a multicast compare code 2412, a window compare code 2414, a mask length 2416, a mask 2418, a multicast compare value 2420, and a window compare value 2422. As discussed above, requester device ID 2404 can be a 2 or 8 byte requester ID. As before, the 2 or 8 byte requester ID is the ID (either the UID or VID) of the requesting device 110. Window duration 2406 provides the amount of time, usually in units of ms, for the arbitration window illustrated in FIGS. 18 and 19. The CSMA guard time 2408 is the guard time, usually in units of 100 μs, which corresponds to the value C shown utilized in arbitrated CSMA process 1800 shown in FIG. 18. The start offset byte 2410 indicates the byte offset into the data element that is being masked.

The compare codes, both the multicast compare code 2412 and window compare code 2414, can be defined to relate to a comparison between a compare value held in multicast compare value 2420 and window compare value 2422 and a masked value generated by device 110 with mask 2418. The masked value is the data element value in the receiving device 110, offset by the start offset in start offset 2410, and masked by the mask in mask 2418. The compare code can be set, for example, as follows: 0x00: compare value≠masked value; 0x01: compare value=masked value; 0x02: compare value<masked value; 0x03: compare value≦masked value; 0x04: compare value>masked value; and 0x05: compare value≧masked value. Multicast compare code 2412, window compare code 2414, multicast compare value 2420, and window compare value 2422 allow for particular devices within the overall multicast criteria to be chosen for response within the window.

The mask length 2416 provides the length N, in bytes, of the mask 2418. In some embodiments, the mask 2418 can be between 0 and 64 bytes. The multicast compare value 2420 is the N byte compare value for the multicast as a whole. The window compare value 2422 is the N byte compare value for the next arbitration window. As discussed further below, the data element that is to be compared is identified in command data 2110 following routing template 2108.

As shown in FIG. 19, after responses are received in the arbitration window, then the request device 110 transmits an arbitration request 1908. FIG. 24(b) illustrates a multicast arbitration request template 2424. Template 2424 includes a requester device ID 2426, a window compare code 2428, a mask length 2430, a window compare value 2432, a number of ACKs 2434, and ACK device IDs 2436. Requester device ID 2426 includes a 2 or 8 byte requester device ID. Window compare code 2428 can be a one byte window compare code as discussed above. Mask length 2430 provides the length N of the mask. Window compare value 2432 is an N byte window compare value. Number of ACKs 2434 can be a one byte number of ACKS M. ACK device IDs 2436 can be M 2 or 8 byte ACK device IDs. The number of ACKS indicates the number of devices 110 that have responded within the previous window period and the ACK device IDs holds the IDs of the devices 110 that have responded.

As before, if frame 2100 is a multi-cast response frame 1404, then routing template 2108 includes a 2-8 byte requester device ID and a 2 or 8 byte responder device ID, as illustrated in the unicast response routing template 2310. Because multi-cast routing uses arbitrated CSMA process 1800, multi-cast routing cannot be involved in multi-hop routing.

FIGS. 25(a) and 25(b) illustrate an anycast request routing template 2502 and an anycast response routing template 2524, respectively. As discussed above, anycast routing is a non-guaranteed version of multi-cast routing. Anycast routing can utilize non-arbitrated CSMA process 1700. As a result, anycast routing can be well suited for management of multi-hop communications. As discussed above, devices 110 in gateway regime and devices 110 in subcontroller regime can forward packets in responsive to anycast routing, but devices 110 operating in the endpoint regime can not forward such packets.

In most embodiments, devices 110 only manage a single anycast dialog sequence at a time. Therefore, if one of devices 110 receives an anycast message of a differing session ID and requester ID than its active log, it may choose to ignore the new message. In some embodiments, each device 110 involved in an anycast dialog sequence keeps its own timeout, based on the value received in routing template 2108 of the request frame 1410. After the timeout expires, the anycast dialog sequence may be reset.

When forwarding an anycast request in a multi-hop routing sequence, the timeout may be reduced to account for the elapsed time of the forwarding process, including the duration of the forwarded wakeup packet 1300 and request packet 1410 itself. In some embodiments, deliverance of anycast command acknowledgements, if enabled, precedes the forwarding of the request. A device 110 that has previously forwarded an anycast request does not forward any further anycast requests bearing the same session ID until the anycast timeout expires. Similarly, a device that has forwarded an anycast response cannot forward another anycast response with the same response device ID and session ID until the anycast timeout has expired.

Forwarding a response frame back to the requesting device can be subject to some interpretation, depending on the sophistication of the routing algorithm. In some embodiments, response forwarding performs a recursive tracing of the routing path on which the request has traversed. However, if a device determines that it may skip one or more hops back to the requesting device, it may opt to do so.

If frame 2100 is a request frame 1410, then anycast request routing template 2502 utilized for template 2108 include an originating device ID 2504, a forwarded device ID 2506, hops remaining 2508, anycast timeout 2510, response channel 2512, start offset 2514, compare code 2516, mask length 2518, mask 2520, and compare value 2522. As discussed previously, origin device ID 2504 can be a 2 or 8 byte device ID of the original requester. Forwarder device ID 2506 can be a 2 or 8 byte device ID of a forwarding device in a multi-hop routing. As before, the origin device ID can be the VID or UID of requester device 110. The forwarder device ID is the ID of a device 110 that forwarded the request. Hops remaining 2508 indicates the number of transfers yet to occur before forwarding ceases. Timeout 2510 can be a 2 byte anycast timeout. The anycast timeout is the number of ms until the entire anycast dialog sequence times out and should be decremented in every forwarding. Response channel ID 2512 includes the response channel to utilize. Start offset 2514 can be a one byte Start offset. Compare code 2516 can be a one byte compare code defined as discussed above. Mask length 2518 can be one byte indicating the length N of the mask. Mask 2520 then can be an N byte mask. Compare value 2522 can be an N byte compare value to use in the comparison. As discussed above, the compare code can be, for example, given by 0x00: compare value≠ masked value; 0x01: compare value=masked value; 0x02: compare value<masked value; 0x03: compare value≦masked value; 0x04: compare value>masked value; and 0x05: compare value≧masked value. The start offset provides the byte offset into the data element being masked. The mask length N is the number of bytes in the mask and the compare value. In some embodiments, N can be from 0 to 64. The mask is an N byte bitmask. The compare value is an N byte value that provides a relationship to the masked data element. As discussed below, the data element can be identified in command data 2110.

FIG. 25(b) illustrates an anycast response routing template 2524. As shown in FIG. 25(b), template 2524 includes an origin device ID 2526, a responder device ID 2528, and a forwarder device ID 2530. The origin device ID 2526 is the one of devices 110 which initiated the request. The responder device ID 2528 is the ID for the device 110 the responded to the request. The forwarder device ID 2530 is the ID for the device 110 that forwarded the response frame 1416 between the responding device and the requesting device.

Command operational codes (opcodes) are provided above with respect to Table 14 above. As discussed above, the opcode field can be provided in the lower four bits of command code 2104 of frame 2100, as shown in FIG. 21(e). These commands are commands that elicit specific responses from devices 110, in addition to the other template responses. As shown in frame 2100, command data 2110 provides data associated with carrying out the commands provided in command code 2104.

CRC16 2112 is the CRC16 code described above. In some commands, command data 2110 and CRC16 2112 may not be included in frame 2100.

In some cases, a response packet 1404 is followed by an associated data packet 1504 as shown in FIG. 15. FIG. 21(c) illustrates a data frame 1510, which is one of frames 1510-1 through 1510-N shown in FIG. 15. As shown in FIG. 21(c), data frame 1510 includes a protocol ID 2120, a frame length 2122, a frames remaining 2124, a frame number 2126, encapsulated data 2128, and CRC16 2130. Protocol ID 2120 provides the identification of the protocol, for example 0x51 for the mode 2 protocol. Frame length 2122 provides the length of the frame less one byte, or N+5 where N is the number of bytes in encapsulated data 2128. Frames remaining 2124 indicates the number of frames the follow frame 1510. Frame number 2126 is the number of frame 1510 in the sequence of frames 1510. Encapsulated data 2128 is the data that is being transmitted in frame 1510.

As shown in Table 14 above, there are various types of command codes that can be executed. In particular, Table 14 shows inventory commands, collection commands, and announcement commands.

Inventory commands request short responses that include device IDs of responding devices 110. For broadcast, unicast, anycast, and multicast routing types, inventory commands use the templates provided in the command code with a command extension in the form of an UDB element ID. In broadcast routing all devices respond, in unicast routing only the addressed device responses (essentially in acknowledgement), and in multicast/anycast routing devices 110 that pass the comparison test respond. The responses bear no data additional from that included in the default response templates and therefore do not utilize data packets.

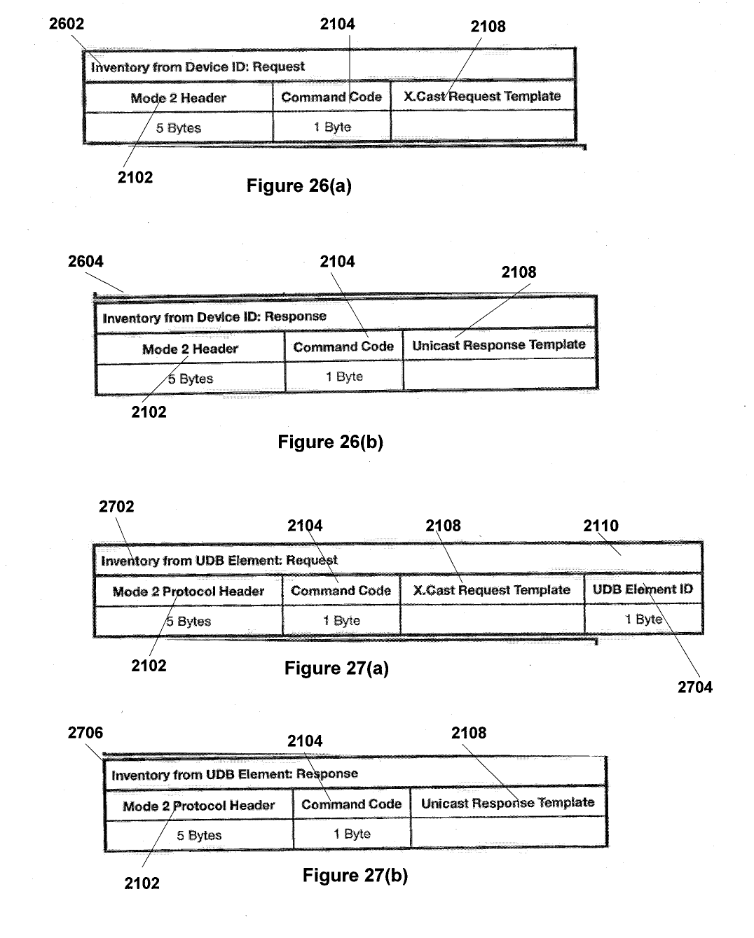

FIG. 26(a) illustrates an example of an inventory request frame 2602, which is an example of request frame structure 2100. As show in FIG. 26(a), inventory request frame 2602 includes header 2102, command code 2104, and routing template 2108. An inventory from device ID performs a comparison on the device ID and therefore, for any routing mode, the comparison is with the device ID element (2 bytes for VID and 8 bytes for UID). As a result, request frame 2602 does not include command data 2110. Routing template 2108 can be any of the routing modes discussed above.

FIG. 26(b) illustrates an inventory response frame 2604. Response frame 2604 includes header 2102, command code 2104, a routing template 2108 where routing template 2108 is a unicast routing template 2310.

FIG. 27(a) illustrates an inventory from UDB element request frame 2702. In an inventory from a UDB data element, the comparison takes place with respect to the specific UDB element, so the maximum length of masks and value is less than or equal to the length of the specified UDB element. With broadcast or unicast request, there is no explicit comparison, so the recipient device will respond only if it contains the specified UDB element and its length is greater than 0. As such, inventory from UDB element request frame 2702 includes protocol header 2102, command code 2104, command extension 2106, routing template 2108, and command data 2110. Command data includes UDB element ID 2704 that identifies the particular UDB data element.

FIG. 27(b) illustrates an inventory from UDB element response frame 2706. Response frame 2706 includes header 2102, command code 2104, and routing template 2108 that holds uncast routing template 2310.

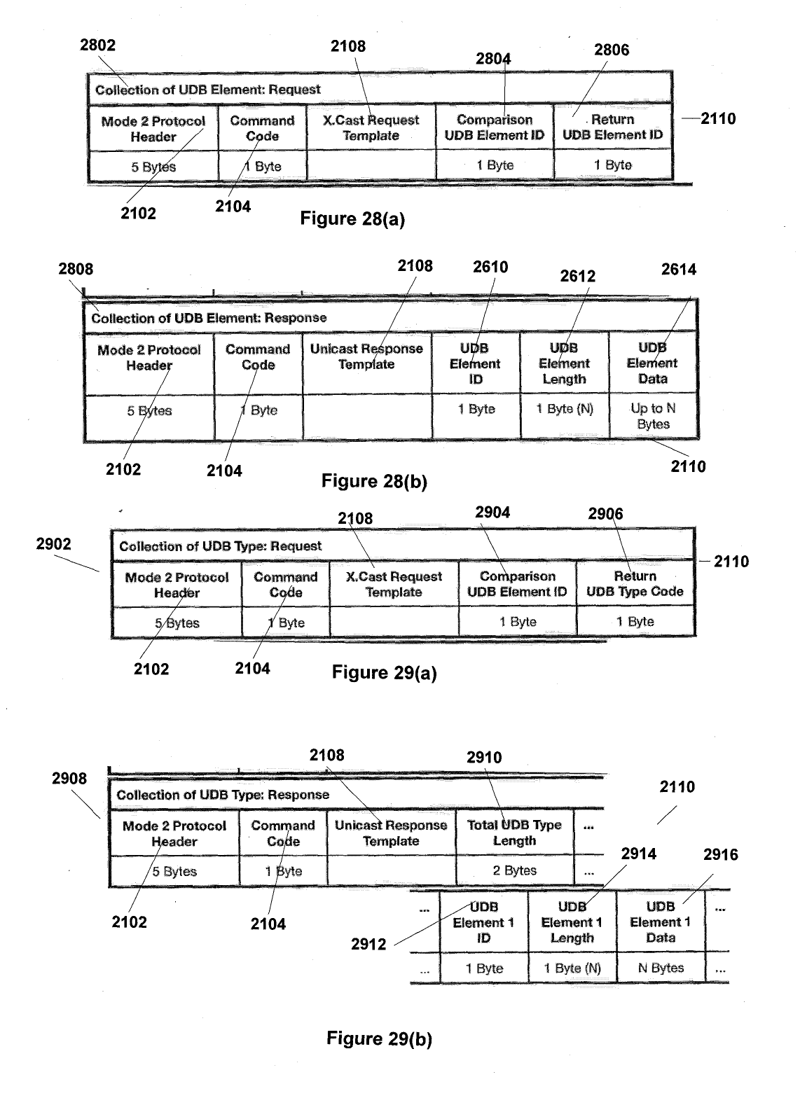

FIG. 28(a) illustrates a collection of UDB element request frame 2802. Collection commands are requests that return responses with either single UDB elements or multiple UDB elements in the form of UDB type codes. There can be several types of collections, for example collections commands can return the device ID, a UDB element, or a UDB type code. Searches can include any device in range or a selected device in the range. Collection commands take a UDB element ID as a comparison input. With multicast collection request, the comparison takes place on the specified UDB element, so the maximum length of masks and value is less than or equal to the length of the UDB element. With broadcast, anycast, or unicast request there is no explicit comparison, so the reception device responds only if it includes the specified UDB element and its length is greater than 0.

As such, a collection of UDB element request frame 2802 includes protocol header 2102, command code 2104, routing template 2108, and command data 2110. Command data 2110 includes a one byte comparison UDB element ID 2804 and a one byte return UDB element ID 2806. The comparison UDB element ID 2804 is utilized to perform a comparison if in multicast or anycast routing. The return UDB element ID 2806 is the UDB element to be returned.

A collection of UDB element response frame 2808 is illustrated in FIG. 28(b). As shown in FIG. 28(b), frame 2808 includes protocol header 2102, command code 2104, routing template 2108 holding a unicast routing template, and command data 2110. Command data 2110 includes a one byte UDB element ID 2610, a one byte UDB element length 2612 holding value N, and up to N bytes of UDB element data 2614. The UDB element ID 2610 holds the UDB element requested to collect in request frame 1410. The UDB element length 2612 is a value N that is the length of the UDB data element. The UDB element data 2614 is the data in the UDB element.

FIG. 29(a) illustrate a collection of UDB type request frame 2902. A collection of UDB type also specifies a UDB element type code that is to be returned in the response. As such, request frame 2902 for a collection of UDB type includes a protocol header 2102, a command code 2104, routing template 2108, and command data 2110. Routing template 2108 can be any of the available templates. Command data 2110 includes a comparison UDB element ID 2904 and a return UDB type code 2906. The comparison UDB element ID 2904 identifies the UDB element to use in a comparison if routing template 2108 is a multicast or anycast routing template. Return UDB type code 2906 identifies the UDB type codes to return.

FIG. 29(b) illustrates an example of a collection of UDB type response frame 2908. In a collection of UDB type response, multiple UDB elements are transferred in series utilizing a type-length-data stream. As such, response frame 2908 includes protocol header 2102, command code 2104, routing template 2108 set to a unicast routing to the requesting device, and command data 2110 that includes a total UDB type length 2910, and a stream of UDB element ID 2912, UDB element length 2914, and UDB element data 216. The total UDB type length 2910 indicates the number of UDB elements to be returned. The UDB element ID 2912 identifies one of the UDB elements to be returned. UDB element length 2914 provides the length N of the data to be included in the UDB element data for the UDB element to be returned. UDB element data 2916 includes the N bytes of the UDB element data.

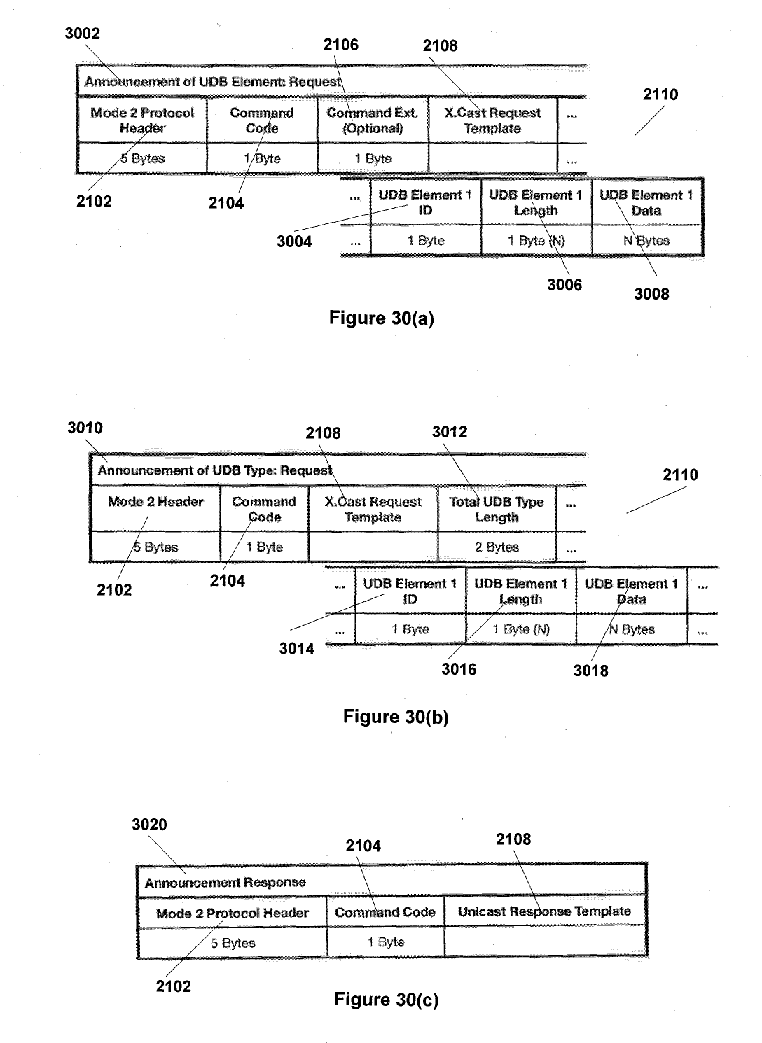

FIGS. 30(a) and 30(b) illustrate an announcement of UDB element request frame 3002 and an announcement of UDB type request frame 3010, respectively. Announcement commands are unsolicited packets that include UDB data. Announcement commands can only be transmitted by devices 110 in subcontroller or gateway regimes. Responses to an announcement command, an example of which is illustrated in announcement response frame 3020 in FIG. 30(c), can be by simple acknowledgement or can be suppressed by setting the no response bit in command extension 2106 in request frame 3002 or 3010.

As shown in FIG. 30(a), request frame 3002 can include protocol header 2012, command code 2104, command extension 2106, routing template 2108, and command data 2010. Command data 2110 includes, for each UDB element data included, a UDB element ID 3004, a UDB element length 3006, and UDB element data 3008. In some embodiments, request frame 3002 can be truncated, for example at 255 bytes.

Similarly, as shown in FIG. 30(b), request frame 3010 for an announcement of UDB type can include protocol header 2102, command code 2104, routing template 2108, and command data 2110 that includes total UDB type length 3012, and for each UDB element a UDB element ID 3014, UDB element length 3016, and UDB element data 3018.

Data frame commands are requests that initiated extended dialogs. The data frames themselves are utilized with encapsulated protocols. FIG. 21(c) illustrates a data frame 1510 according to some embodiments of the present invention. FIG. 15 illustrates a packet sequence with a response packet 1404 that includes a response frame 1416 followed by one or more data packets 1504 that contain data frames 1510.

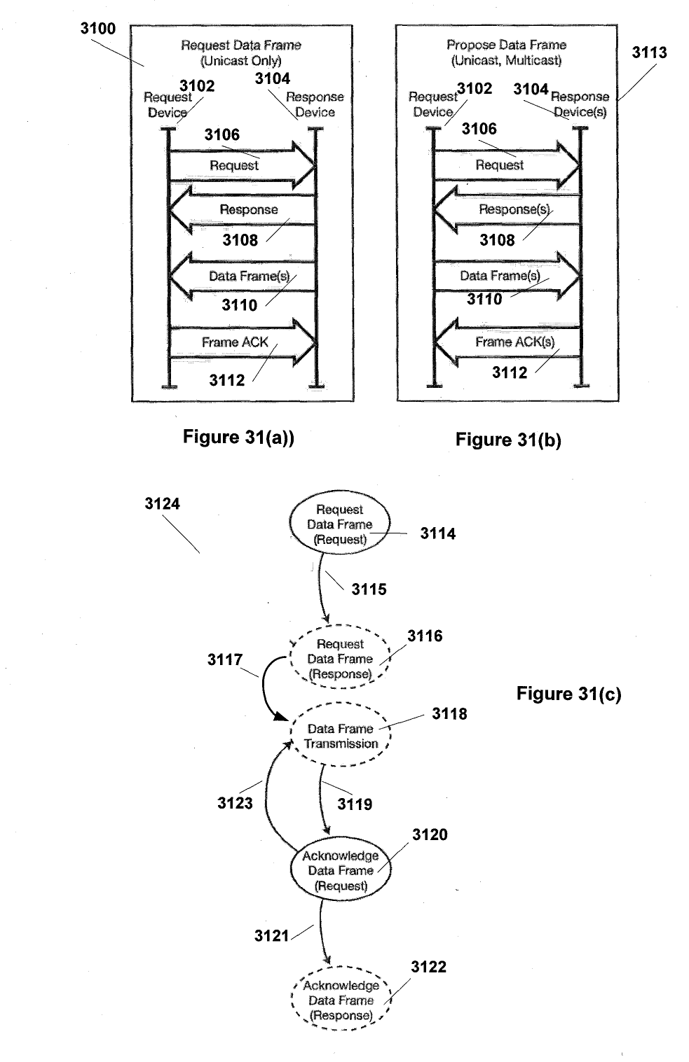

FIG. 31(a) illustrates a request data dialog 3100 according to some embodiments of the present invention. The example of request data dialog 3100 in FIG. 31(a) utilizes unicast routing. Requesting device 3102, which can be any of devices 110 operating in subcontroller or gateway regimes. Responding device 3104 can be any of devices 110 other than requesting device 3102. As shown in FIG. 31(a), request device 3102 transmits a request packet 3106, which can be request packet 1402 as shown in FIG. 14 with a request frame 1410 that is described with respect to frame 2100 of FIG. 21(a). Response device 3104 responds with a response 3108, which can be response packet 1404 as shown in FIG. 14. Following response 3108, response device 3104 provides a data packet 3110 as shown in FIG. 15 with one or more data frames 1510 as described in FIG. 21(c). Once data packet 3110 is received in request device 3102, then request device 3102 can transmit an acknowledgment 3112.

FIG. 31(b) illustrates a dialog 3113 where data is being transmitted from requesting device 3102 to one or more response devices 3104. Dialog 3113 can be either unicast or multicast routing. As shown in FIG. 31(b), request device 3102 transmits a request 3106. One or more response devices 3104 respond to request 3106. Request device 3102 then transmits data 3110. Following receipt of data 3110, each of response devices 3104 provides an acknowledgment 3112.

As shown, the request and response of the data frame commands is the same as in any other command. Data frames 1510 are transmitted utilizing the guidelines discussed above. Transmission of data frames 3110 is preceded by non-arbitrated CSMA process 1700 as discussed above unless data 3110 is being transmitted on the same transport channel as response 3108 within the MGT.

Acknowledgments 3112 is a request frame or response frame as illustrated in FIG. 21(a). Acknowledgments 3112, then, can be transmitted utilizing non-arbitrated CSMA process 1700 as discussed above.

FIG. 31(c) illustrates a state diagram 3124 describing data dialog 3100 and 3113 as illustrated in FIGS. 31(a) and 31(b). As shown in FIG. 31(c), state diagram 3124 begins in request state 3114, where request device 3102 transmits request 3106 and diagram 3124 transitions to state 3116 through transition 3115. In state 3116, response device 3104 transmits response 3108 to request device 3102. State diagram 3124 then transitions to state 3118 through transition 3117. In state 3118, data 3110 is sent and diagram 3124 transitions to acknowledge state 3120 through transition 3119. As shown in FIGS. 31(a) and 31(b), data may be sent by either request device 3102 or response device 3104. In acknowledge state 3120, if data 3110 was successfully transferred, then acknowledgment 3112 is transmitted and state diagram 3124 transitions to state 3122 through transition 3121. However, if an error is detected in data 3110, then an acknowledgement 3112 with an error code is sent and state diagram 3124 transitions back to state 3118 through transition 3123 to resend the data that was corrupted on receipt.

Both request and propose data frames (request frame 3106) may use command extension 2106, which is described in FIG. 21(f). If the EXT bit in command code 2104 (see FIG. 21(e)) is set, then command extension 2106 is enabled. If the EXT bit in command code 2104 is not set, then command extension 2106 is disabled and all bits in command extension 2106 are assumed to be 0. Requester device 3100 expects a response from responder device 3104, and the recipient of data 3110 is expected to transmit an acknowledgment 3112 following the conclusion of data 3110. The NACK bit of command extension 2106 can be set to disable the acknowledge data frame process. As discussed above, No Response bit (b5) can be set to disable the request data frame response.

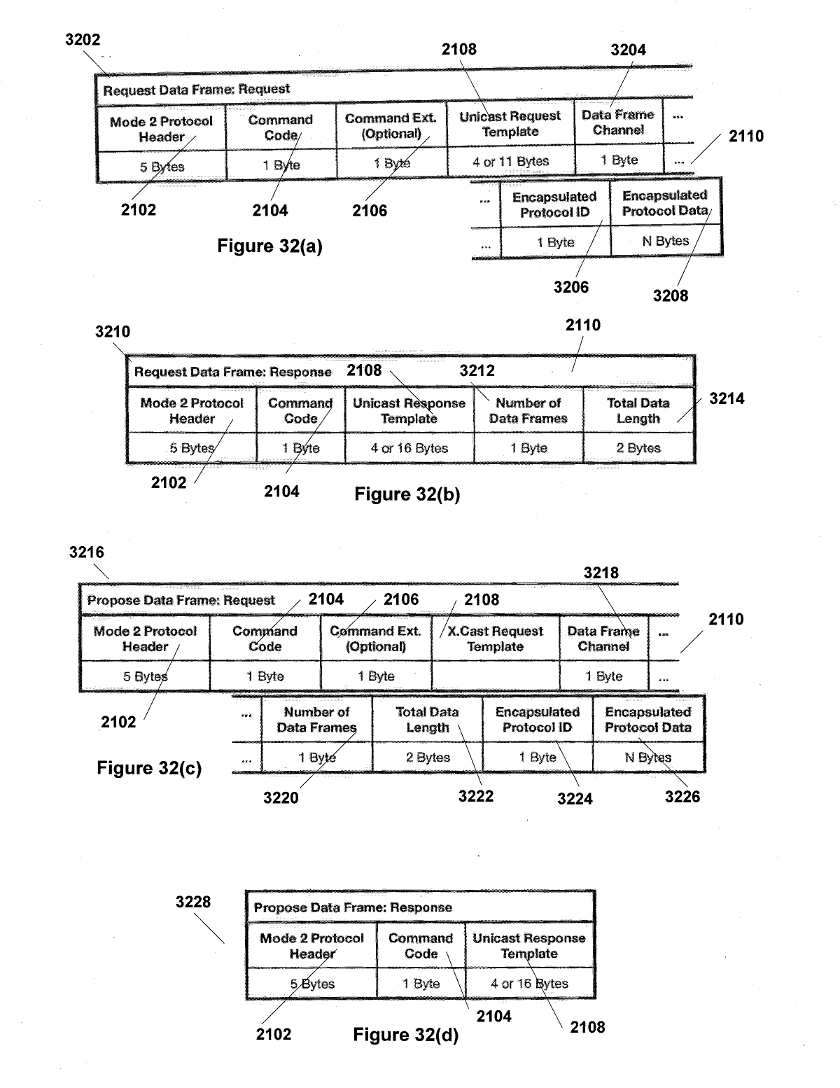

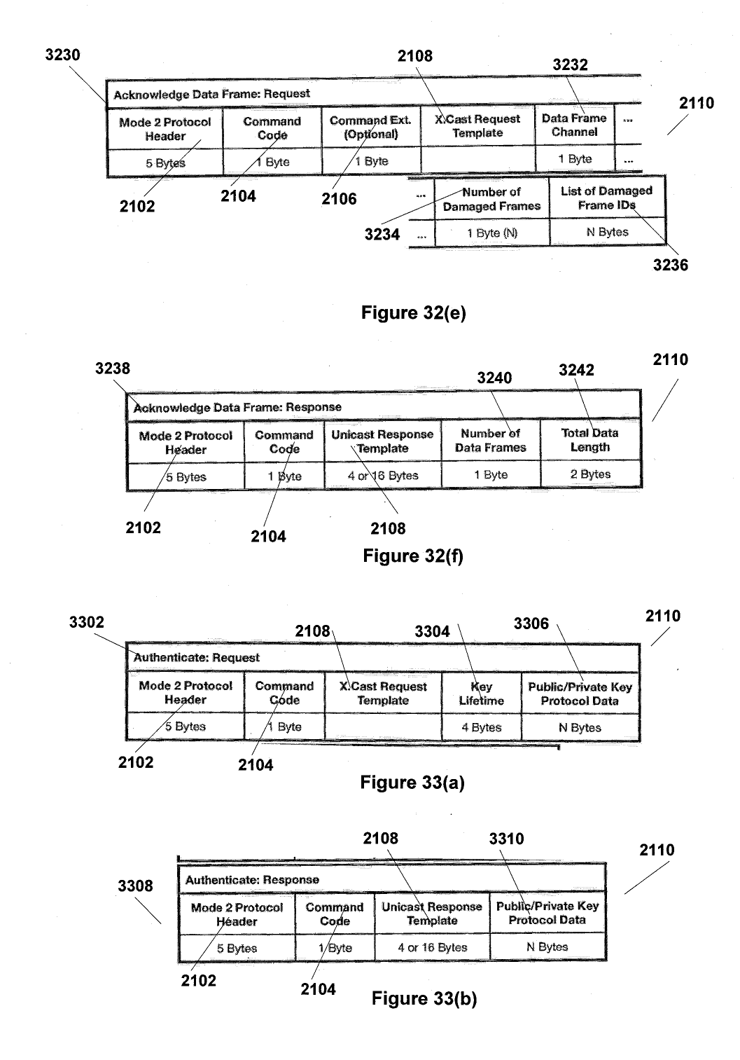

FIG. 32(a) illustrates a request data frame 3202. As shown in FIG. 32(a), request data frame 3202 includes, as illustrated in FIG. 21(a), protocol header 2102, command code 2104, command extension 2106, routing template 2108 provided as a unicast request template 2302 as shown in FIG. 23(a), and command data 2110. Command data 2110 includes data frame channel 3204 which provides the transport channel ID where data is expected to be transmitted, encapsulated protocol ID 3206 and encapsulated protocol data 3208.

FIG. 32(b) illustrates a response data frame 3210 responsive to request data frame 3202. As shown in FIG. 32(b), response data frame 3210 includes protocol header 2102, command code 2104, routing template 2108, and command data 2110. Routing template 2108 is unicast response template 2310 illustrated in FIG. 23(b). Command data 2110 includes a number of data frames 3212 and total data length 3214. Number of data frames 3212 indicates the number of data frames 1510 that will be transmitted. The total data length 3214 provides the number of bytes of data that will be transmitted.

If the no response bit in command extension 2106 is set in request data frame 3202, then response device 3104 will be unable to report memory allocation errors in advance of the data frame reception. That is similarly true for propose data frame 3216 shown in FIG. 32(c).

As shown in FIG. 32(c), propose data frame 3216 can include protocol header 2102, command code 2105, command extension 2106, routing template 2108, and command data 2110. In some embodiments, routing template 2108 can be either of unicast routing template 2302 or multicast routing template 2402. Command data 2110 includes a data frame channel 3218, number of data frames 3220, total data length 3222, encapsulated protocol ID 3224, and encapsulated protocol data 3226. Data frame channel 3218 indicates the transport channel ID on which data is to be transmitted. The number of data frames 3220 indicates the number of data frame 1510 that will be transmitted. The total data length 3222 provides the total number of bytes of data to be transmitted. Encapsulated protocol ID 3224 and encapsulated protocol data 3226 provides information regarding the encapsulated protocol within which data frames 1510 will be transmitted.

FIG. 32(d) illustrates the response frame 3228 that is responsive to propose data frame 3216. As shown in FIG. 32(d), response frame 3228 includes protocol header 2102, command code 2104, and routing template 2108. Routing template 2108 in response frame 3228 can be a unicast response template 2310.

FIG. 32(e) illustrates an acknowledgment request frame 3230. As illustrated in FIGS. 31(a) and 31(b), after receive of data frames 3110, the recipient of data frames 3110 (request device 3102 in dialog 3100 and response device 3104 in dialog 3113) sends an acknowledgment 3112 that the data was received or that some of the frames of the data have not been correctly received. Acknowledgment request frame 3230 provides the recipient of the data frames to restart the dialog, but with only the frames that where not correctly received.

As shown in FIG. 32(e), acknowledgment request frame 3230 includes protocol header 2102, command code 2104, command extension 2106, routing template 2108, and command data 2110. Command extension 2106 can be utilized to terminate the dialog, even if all of the frames are not correctly sent. As shown in FIG. 21(f), bit 7 for example of command extension 2106 can be utilized as a scrap flag. Any unused bit can be utilized for this purpose.

Routing template 2108 can be any routing template, but is typically unicast routing template 2302 or multicast routing template 2402. Command data 2110 includes data frame channel 3232, number of damaged frames 3234, and list of damaged frame IDs 3236. Data frame channel 3232 is the transport channel ID over which the undamaged data frames will be sent. The number of damaged frames 3234 indicates how many damaged frames will be sent. Damaged frame IDs 3236 indicates the identity of the damaged frames.

FIG. 32(f) illustrates a response frame 3238 that responsive to acknowledgment request 3230. As shown in FIG. 32(f), response frame 3238 includes a protocol header 2102, command code 2104, routing template 2108, and command data 2110. Routing template 2108 can be, for example, unicast routing response template 2310 or multicast routing response template 2424. Command data 2110 includes number of data frames 3240 and total data length 3242. Number of data frames 3240 indicates the number of data frames 1510 that will be transmitted. The total data length 3242 provides the number of bytes of data that will be sent.

FIGS. 33(a) and 33(b) illustrate an authentication command. In some embodiments, authentication can be performed using either public key encryption (also known as public/private key encryption) or private key encryption. The encapsulated protocol is utilized in order for a requester device to authenticate itself as the root or admin of a responder device. After authenticating, all frame data transmitted between the authenticating device and the authenticated device can be encrypted using the methods provided by the encryption system. When the key utilized between the devices expires, the authentication can reset, and further frame traffic between these devices will be unencrypted until re-authorization. As discussed above, devices 110 can keep a table of different keys and key lifetimes that correspond to different other devices 110.

As shown in FIG. 33(a), authentication request frame 3302 includes protocol header 2102, command code 2104, routing template 2108 and command data 2110. Command data 2110 includes key lifetime 3304 and key protocol data 3306. Key lifetime 3304, for example, can be a 4 byte field providing the UTC value describing the time the key in key protocol data 3306 expires. Key protocol data 3306 may include, for example, public/private key protocols data or private key protocol data.

FIG. 33(b) shows an example of authentication response frame 3308. As shown, response frame 3308 includes protocol header 2102, command code 2104, routing template 2108, and command data 2110. Routing template 2108 is a unicast response template 2310. Command data 2110 includes key protocol data 3310, which can be public/private key protocols or private key protocols.

Encapsulated protocols are subprotocols used primarily in the data frame, but also can be utilized in certain other commands. System 100 can support any number of subprotocols. Some examples of subprotocols are provided here.

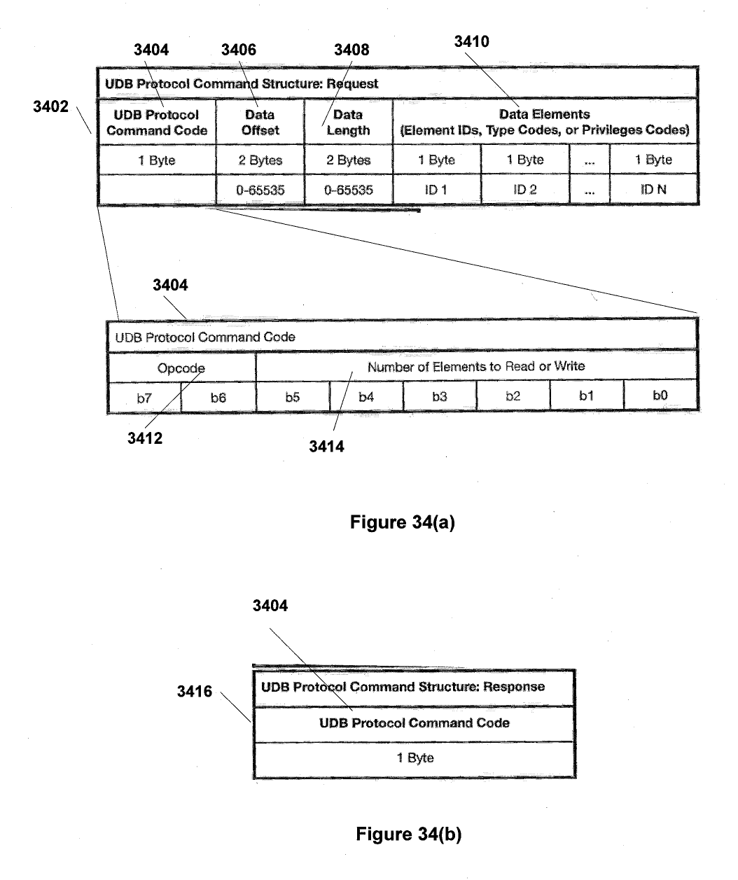

FIG. 34(a) illustrates a UDB protocol request or response frame 3402. The UDB protocol is a read/write mechanism that can be used exclusively with data frame commands. For example, the UDB protocol can be utilized for batch reading and writing of UDB elements. The UDB protocol can also be utilized for the reading and writing of UDB type strings. Further, the UDB protocol can be utilized for batch altering of UDB element and type string privileges.

The UDB protocol request and response is initiated in the request and response of data frame controls. The UDB protocol can be encapsulated into data frames 1510, which is structured as discussed above with respect to FIGS. 31 and 32. As shown in FIG. 34(a), UDB protocol request 3402 includes a UDB protocol command code 3404, a data offset 3406, a data length 3408, and then data elements 3410. As is further shown, UDB protocol command code 3404 includes an opcode 3412, shown in bits 7 and 8 in FIG. 34(a), and a number of elements 3414 occupying bits 5 through 0 that indicates the number of elements to read or write.

An implicit command behavior can also be utilized, for example in a request data frame as illustrated in FIG. 32(a) the implicit behavior is to read UDB data objects. Conversely, in a propose data frame as illustrated in FIG. 32(c) the implicit behavior is to write UDB data objects. Opcode 3402 provides further behavior in addition to the implicit behavior and identifies the element to be read or written. For example, opcode 3412 can be set to “00” for UDB elements; “01” for UDB type string; “10” for UDB element privileges; or “10” for UDB type string privileges. Other opcode definitions may be utilized. The number of elements 3414 indicates the number N of UDB element IDs or UDB type codes to access. Although N can be of any size, in some embodiments N is between 1 and 64.

Data offset 3406 provides an offset into the total data element string to start the read or write operation. In some embodiments, data offset 3406 can be two bytes in length, thereby indicating a value between 0 and 65535. Data length 3408 provides the number of bytes to read or write after the offset value in data offset 3406. Data length 3408 may be two bytes as well. Data elements 3410 provides the element IDs, type codes, or privilege codes for each of the N elements that are indicated in number of elements 3414.

FIG. 34(b) illustrates the UDB protocol response 3416, which includes the command code 3404.

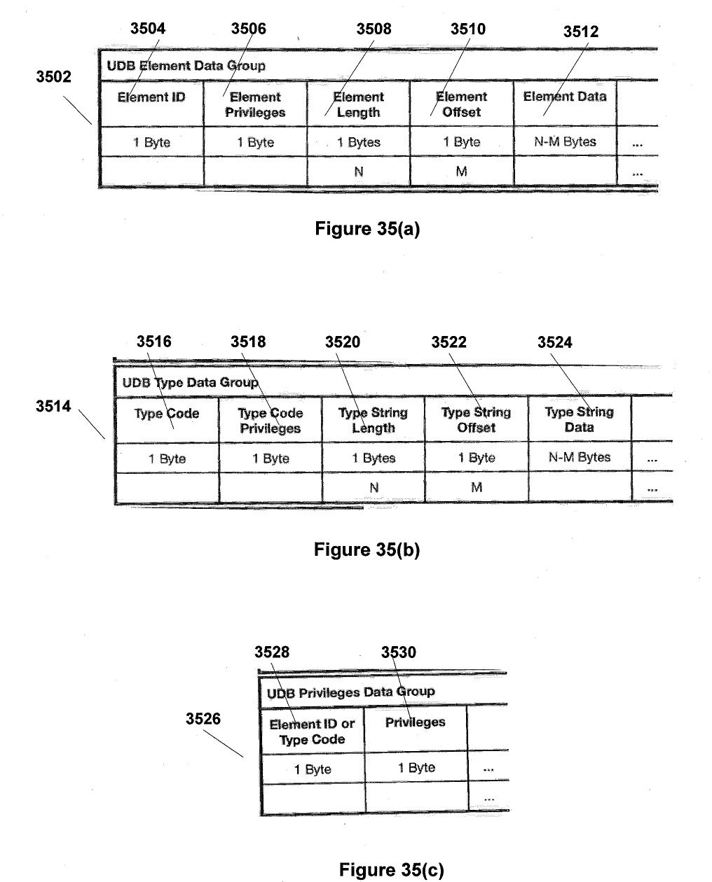

Data frames conveying UDB protocol data can include one or more data groups. A series of data groups in a single data frame dialog may be all of the same kind. FIG. 35(a) illustrates a UDB element data group 3502. UDB element data group 3502 includes element ID 3504, element privileges 3506, element length 3508, element offset 3510, and element data 3512. Element ID 3504 provides the ID of the element. Element privileges 3506 shows the privilege code for that element. As discussed above, the privilege code can occupy the lower 6 bits of the one byte field and provide the read and write privileges for the root, admin, and user types. Element length 3508 provides the length N of the element. Element offset 3510 provides the offset M after which the element should be written or read. Element data 3512 is an N-M byte field that holds the element data.

FIG. 35(b) illustrate a UDB type data group 3514. As shown in FIG. 35(b), UDB type data group 3514 can include type code 3516, type code privileges 3518, type string length 3520, type string offset 3522, and type string data 3524. As above, type code 3516 holds a code that indicates the type of the UDB. The type code privileges 3518 provide the privileges indication for root, admin, and user types. Type string length provides the length N of the string. Type string offset 3522 provides the offset M after which the type string should be written or read. Type string data 3524 is an N-M field that holds the string data.

FIG. 35(c) illustrates a UDB privileges data group 3526. Privileges group 3526 includes the element ID or type code 3528 and a privileges field 3530. Element or type code identifies the element or type of UDB data. Privileges 3530 is the privileges to be read or written.

An RDB protocol can be utilized for accessing the RDB blocks. The RDB protocol is similar to the UDB protocol in form and function, except that it accesses RDBs instead of UDBs. The RDB protocol can allow for batch random-offset reads or writes to a single RDB element. Further, the RDB protocol can allow for altering of RDB element privileges.

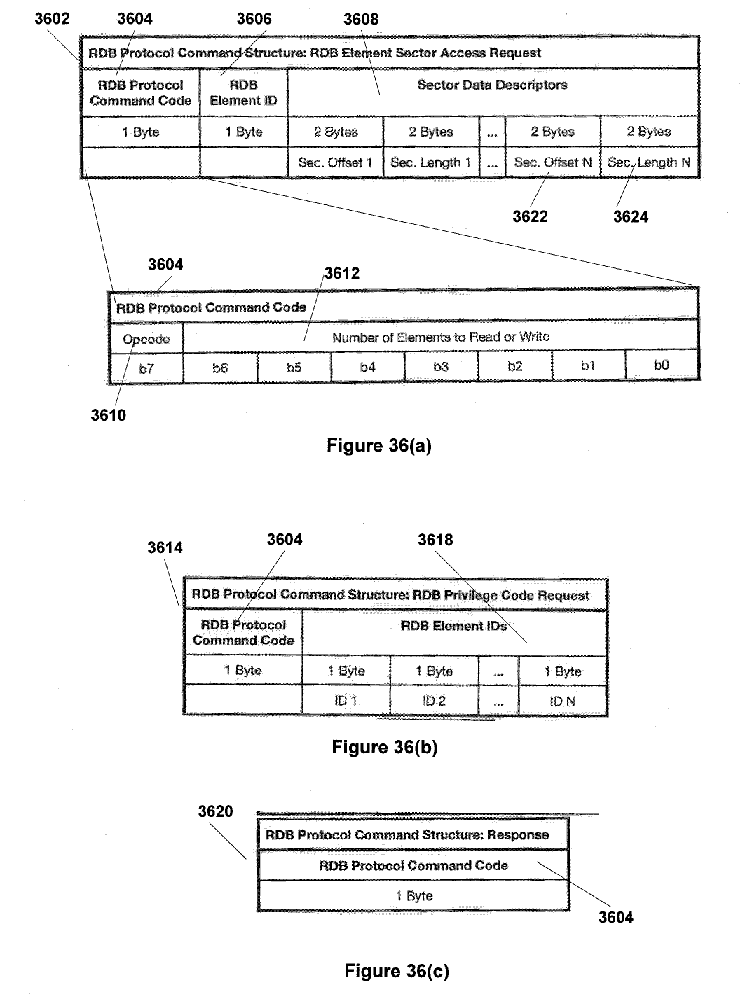

FIG. 36(a) illustrates the RDB protocol command structure 3602. Again, implicit behavior indicates that read RDB data objects is implemented in a request data frame command structure 3602 included in a request data frame 3210 and write RDB data objects is implemented in a request frame command structure 3602 included in a proposal data frame 3216.

As shown in FIG. 36(a), command structure 3602 includes an RDB protocol command code 3604, an RDB element ID 3606, and selector data descriptors 3608. RDB protocol command code 3604 includes an opcode 3610 and a number of elements 3612. Opcode 3604 can be a one bit field that is set to indicate either an RDB element or an RDB element privilege code (e.g., “0” for RDB element and “1” for RDB element privilege code). Number of elements 3612 indicate the number of elements to access. In some embodiments, the number of elements can be between 0 and 127, although any number or range can be utilized. If opcode 3610 indicates an RDB element, number of elements 3612 indicates the number of random sector accesses. If opcode 3610 indicates an RDB element privilege code, then number of elements 3612 indicates the number of privilege codes to access.

RDB element 3606 provides the identification of the RDB element. Sector data descriptors provides, for each of the elements indicated in number of elements 3612, an offset 3622 and length 3624.

FIG. 36(g) illustrates a RDB protocol command structure 3614 for a privilege code request. Structure 3614 includes RDB protocol command code 3604 and RDB element IDs 3618, one for each of the elements indicated by the number of elements 3612.

FIG. 36(c) indicates a response 3620 to structure 3614. As shown, structure 3620 includes RDB protocol command code 3604.

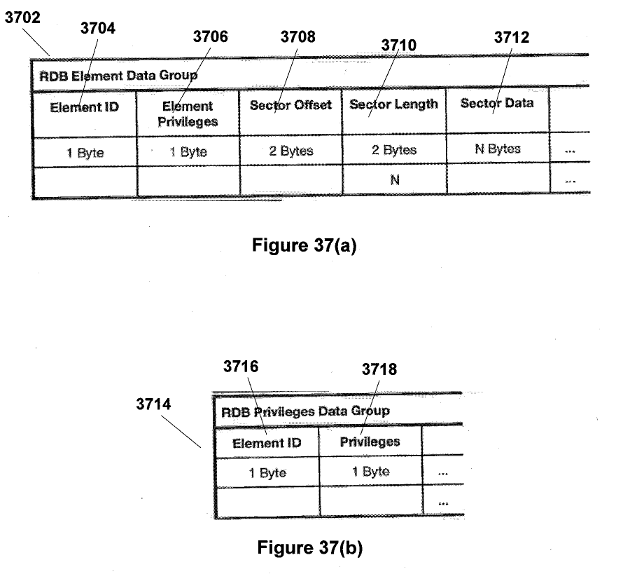

FIGS. 37(a) and 37(b) indicate RDB protocol data groups. Data frames conveying RDB protocol data include one or more data groups. A series of data groups in a single data frame dialog should be of the same kind. FIG. 37(a) illustrates an RDB element data group 3702. Group 3702 includes an element ID 3704, element privileges 3706, sector offset 3708, sector length 3710, and sector data 3712. Element ID 3704 identifies the RDB element, element privileges 3706 indicate the user type privileges, sector offset 3708 provides an offset into the element data, sector length 3710 provides the length of the sector data, and sector data 3712 provides the sector data.

FIG. 37(b) illustrates an RDB privileges data group 3714. Group 3714 includes an element ID 3716 and privileges 3718.

Other protocols can be implemented. For example, a private key protocol, a public key protocol, an IPv6 protocol, or an IEEE 1451.7 protocol can be implemented. Other protocols may be established for implementation with system 100 as well.

The examples provided above are exemplary only and are not intended to be limiting. One skilled in the art will recognize various modifications that can be affected to various aspects of the described embodiments of the invention. Those modifications are intended to be within the scope of this disclosure. As such, the invention is limited only by the following claims.

What is claimed is:

1. A device, comprising:
a memory capable of storing data and program instructions;
a processor coupled to the memory; and
a transceiver coupled to the processor to receive digital data and control signals, the control signals including a transport channel signal, the transceiver coupled to transmit data over one or more transport channels, the transport channels being defined as a combination of one or more physical channels chosen from a plurality of physical channels.

2. The device of claim 1, wherein the transceiver performs forward error correction encoding.

3. The device of claim 1, wherein the transceiver encodes the digital data utilizing data whitening.

4. The device of claim 1, wherein the transceiver is configured to transport data utilizing a modulation and an encoding.

5. The device of claim 4, wherein the encoding includes forward error correction.

6. The device of claim 4, wherein the encoding includes data whitening.

7. The device of claim 4, wherein the modulation includes frequency shift modulation (FSK).

8. The device of claim 7, wherein the modulation includes gaussian filtered frequency shift modulation (GFSK).

9. The device of claim 4, wherein the modulation and the encoding can be dynamically chosen from a group of supported modulation and encoding.

10. The device of claim 1, wherein the plurality of physical channels are channels positioned within a defined band.

11. The device of claim 10, wherein the defined band is a 433 MHz ISM band.

12. The device of claim 10, wherein the plurality of physical channels includes eight physical channels of width 216 kHz spanning the 433 MHz ISM band.

13. The device of claim 10, wherein the plurality of physical channels includes six physical channels of width 290 kHz spanning the 433 MHz ISM band.

14. The device of claim 10, wherein the plurality of physical channels includes seven physical channels of width 248 kHz spanning the 433 MHz ISM band.

15. The device of claim 10, wherein the set of defined transport channels includes one or more combinations of adjacent ones of the physical channels.

16. The device of claim 15, wherein a turbo transmission data rate can be performed utilizing one of the set of defined transport channels having the combination of adjacent physical channels.

17. The device of claim 15, where a normal transmission data rate can be performed utilizing transport channels that are defined with only one of the physical channels.

18. The device of claim 10, wherein at least one of the defined transport channels provides compatibility with a legacy device.

19. The device of claim 10, wherein the processor chooses a transport channel dynamically.

20. The device of claim 10, wherein the processor sets transport channels according to a preset rule.

21. The device of claim 10, wherein two or more transport channels are simultaneously utilized to transport data, wherein the data is split between the one or more transport channels and bonded.

22. The device of claim 1, wherein the transmission data rate of each of the transmission channels is adaptively chosen.

23. The device of claim 1, wherein the transmission data rate for each of the transmission channels is fixed.

24. A device, comprising:
a transceiver capable of communicating wirelessly with other devices;
a processor coupled to a memory and to the transceiver, the processor operating such that the device is in one of one or more regimes, the one or more regimes chosen from a group consisting of a gateway regime, a subcontroller regime, and an endpoint regime.

25. The device of claim 24, wherein the device in states, the states including one or more of an off state, a sleep state, a listen state, a receive state, a transmit state, a hold state, and an idle state

26. The device of claim 25, wherein the device operating in the endpoint regime
transitions from the sleep state to the listen state on a wake-on event;
transitions from the listen state to the receive state if a wake-up frame is detected or the RFID device is expecting a request frame and otherwise transitions to the sleep state;
transitions from the receive state to the transmit state after receiving a request frame and formulating a response frame for transmission, and otherwise transitions to the sleep state; and
transitions from the transmit state to the hold state upon instructions received in the request frame.

27. The device of claim 25, wherein the device operating in the subcontroller regime
transitions from the hold state to the listen state upon receipt of a wake-on event;
transitions from the hold state to the transmit state in order to transmit a request frame;
transitions from the listen state to the receive state in response to detection of an incoming frame;
transitions from the receive state to the transmit state if the incoming frame is a request frame to transmit a response frame;
transitions from the receive state to the hold state if the incoming frame is a response frame;
transitions from the transmit state to the listen state if an outgoing request frame is transmitted; and
transitions from the transmit state to the hold state upon completion of a dialog with another device.

28. The device of claim 25, wherein the device operating in the gateway regime
transitions from a listen state to a receive state upon receipt of a response frame;
transitions from the listen state to a transmit state to transmit a request frame; and
transitions from the transmit state to the listen state after transmission of the request frame.

29. The device of claim 24, wherein the device is configured with other devices in a star network.

30. The device of claim 24, wherein the device is configured with other devices in a tree network.

31. The device of claim 24, wherein the device is configured with other devices in a mesh network.

32. The device of claim 24, wherein the device is configured with other devices in a network that allows hopping of requests and responses through the network.

33. The device of claim 25, wherein the device in the off state is off and the device transitions from the off state by receipt of an external trigger.

34. The device of claim 25, wherein the sleep state is a low power state and the device exits the sleep state on detection of a wake-on event, wherein a wake-on event includes a wake-up frame in a wakeup packet, a sensor alarm, a RF transmission, or a scheduling event.

35. The device of claim 34, wherein the device in the sleep state
activates from a low power operation periodically to check for a carrier;
returns to the lower power operation if the carrier is not detected;
checks for a wake-up frame if the carrier is detected;
returns to the low power operation of the wake-up frame is not detected;
returns to the low power operation for a nap period indicated if the wake-up frame if the wake-up frame is detected; and
exits the sleep state at the end of the nap period if the wake-up frame is detected.

36. The device of claim 35, wherein if more than one transport channel is activate then the device activates periodically such that each active transport channel is scanned during a scan time period.

37. The device of claim 36, wherein each active transport channel is scanned on a configurable frequency.

38. The device of claim 35, wherein the device activates from the lower power state according to a schedule and a real-time clock.

39. The device of claim 38, where each active transport channel is scanned on a configurable schedule.

40. The device of claim 25, where the device is in a hold state
transitions to the listen state if the hold state is asynchronous and a previous state was the transmit or the receive state;
transitions to the idle state if the hold state is asynchronous and the previous state was the listen state;
transitions to the listen state if the hold state is asynchronous and a timeout condition has occurred or transitions to the idle state if the hold state is synchronous and the timeout condition has occurred;
transitions to the transmit state if a hold period has expired and the hold state is synchronous; and
transitions to a listen state if the hold period has expired and a wake-up frame is detected.

41. The device of claim 25, wherein in the transmit state the device performs an arbitration.

42. The device of claim 41, wherein the arbitration is a scheduled transmission slot and the device
checks a schedule against a real-time clock for the scheduled transmission slot, and
transmits on one of the transport channels on the scheduled transmission slot.

43. The device of claim 41, wherein the arbitration is a non-arbitrated carrier sense multiple access procedure.

44. The device of claim 43, wherein the device
picks a transport channel;
checks to determine whether the transport channel is clear;
if the transport channel is clear, the device then waits a period of time and rechecks the transport channel to determine whether the transport channel is still clear;
if the transport channel is still clear, then clear the channel for transmission;
if the transport channel is not clear on either the check or the recheck, determine whether a time-out has occurred, otherwise wait a second period of time and then pick a second transport channel.

45. The device of claim 41, wherein the arbitration is an arbitrated carrier sense multiple access procedure.

46. The device of claim 45, wherein the device
listens for a request from an arbitrator
compares with the request to determine if the device is being addressed;
returns to listen for another arbitrator request after a fixed wait if the device is not being addressed;
checks a transport channel indicated by the request to see if it is clear;
if the transport channel is clear, waits a period of time and then rechecks the transport channel to see if it is still clear and responds if the transport channel is still clear;
if the transport channel is not clear, then check for a time out and waits for a wait period.

47. The device of claim 46, wherein if there is insufficient time to respond or if the time out has occurred, then the device waits for a next window.

48. A device, comprising:
a processor coupled to a memory; and
a transceiver coupled to the processor,
wherein the device wirelessly communicates with other devices utilizing packets, wherein each of the packets includes a preamble, a header that includes a sync and a frame info, and a frame.

49. The device of claim 48, wherein the preamble is a recurring data pattern of non-return-to-zero signal.

50. The device of claim 48, wherein the header includes a frame sync and a frame identification.

51. The device of claim 50, wherein the frame sync is a non-return-to-zero signal configured for data boundary detection and filtering.

52. The device of claim 50, wherein the frame ID indicates the type of frame and includes flags indicating one or more of the following: encoding, encryption, frame sub-type, and parity.

53. The device of claim 48, wherein the packet is wake-up packet and the frame is a wake-up frame.

54. The device of claim 53, wherein the wake-up packet is one of a plurality of wake-up packets transmitted in a wake-up chain and the wake-up frame includes an integer indicating the number of wake-up packets yet to be transmitted before a request packet is transmitted.

55. The device of claim 48, wherein the packet is a request packet and the frame is a request frame.

56. The device of claim 55, wherein the request frame includes a protocol header, a command code, a routing template, and command data.

57. The device of claim 56, wherein the request frame further includes a command extension.

58. The device of claim 56, wherein the request frame further includes a CRC16 integer.

59. The device of claim 56, wherein the command code includes an extension flag, a sleep flag, a routing type, and an opcode.

60. The device of claim 59, wherein the extension flag indicates presence of a command extension.

61. The device of claim 59, wherein the routing type can be one of a unicast routing, a multi-cast routing, a broadcast routing, or an anycast routing.

62. The device of claim 61, wherein the routing type is the unicast routing and the routing template includes a requester device ID, a response timeout, and a response channel.

63. The device of claim 61, wherein the routing type is the multicast routing and the routing template is a multicast initial request template that includes a requester device ID, a window duration, an arbitration guard time, a start offset, a multicast compare code, a window compare code, a mask length, a mask, a multicast compare value, and a window compare value.

64. The device of claim 63, wherein the routing type is the multicast routing and the routing template is a multicast arbitration request template that includes a requester device ID, a window compare code, a mask length, a window compare value, a number of ACKs and one or more ACK device IDs.

65. The device of claim 61, wherein the routing type is the broadcast routing and the routing template includes a requester device ID, a response timeout, a number of response transport channels, and identification for each of the response transport channels.

66. The device of claim 61, wherein the routing type is the anycast routing and the routing template includes an origin device ID, a forwarder device ID, a number of hops remaining, an anycast timeout, one or more response transport channel IDs, a start offset, a compare code, a mask length, a mask, and a compare value.

67. A device, comprising:
a processor coupled to a memory; and
a transceiver coupled to the processor,
wherein the device wirelessly communicates with other devices utilizing packets, wherein each of the packets includes a preamble, a header that includes a sync and a frame info, and a frame, the packets being characterized as a request packet that includes a request frame, a response packet that includes a response frame, or a data packet that includes one or more data frames.

68. The device of claim 67, wherein the request frame includes a protocol header, a command code, a routing template, and command data.

69. The device of claim 68, wherein the request frame further includes a command extension.

70. The device of claim 68, wherein the request frame further includes a CRC16 integer.

71. The device of claim 68, wherein the command code includes an extension flag, a sleep flag, a routing type, and an opcode.

72. The device of claim 71, wherein the routing type is a unicast routing, a multicast routing, or a broadcast routing and the routing template includes a requester ID and a responder ID.

73. The device of claim 71, wherein the routing type is the anycast routing and the routing template includes an origin device ID, a responder ID, and a forwarder device ID.

74. The device of claim 67, wherein the response frame is an error response frame, the routing template is a unicast routing template, and the command data includes an error code, an error subcode, and error data.

75. The device of claim 67, wherein each data frame includes a protocol ID, a frame length, a number of frames remaining, a frame number, and encapsulated data.

76. The device of claim 75, wherein the data frames further includes a CRC16 integer.

77. The device of claim 75, wherein the encapsulated data includes data elements that are stored in the memory.

78. The device of claim 75, wherein the frame includes a protocol header, the protocol header including a protocol ID, a frame length, device flags, and a session ID.

79. The device of claim 78, wherein the device flags include one or more of the following: a NACK, a system fault, a low battery, and a sensor alarm.

80. The device of claim 68, wherein the frame includes command data.

81. A device, comprising
a processor;
a memory coupled to the processor, wherein the memory stores data elements and programming; and
a transceiver coupled to the processor, the transceiver allowing wireless communications with one or more other devices.

82. The device of claim 81, wherein data elements includes one or more the following: universal data block (UDB) elements, raw data block (RDB) elements, un-addressable elements, real-time clock elements, key table elements, device ID elements, protocol ID elements, privileges and authentication elements.

83. The device of claim 82, wherein the device ID elements can be a universal ID or a virtual ID.

84. The device of claim 82, wherein the un-addressable elements are user-defined elements.

85. The device of claim 82, wherein the protocol element provides for the protocols supported by the device.

86. The device of claim 82, wherein the privileges and authentication element includes privilege and authentication data.

87. The device of claim 82, where in the UDB elements includes one or more of device proprietary data, standard device settings, PHY configurations, real time scheduler, sleep scan periods, hold scan periods, protocol lists, UDB type code lists, RDB element lists, Location data lists, IPv6 addressing, IPv6 elements, sensor lists alarm lists, authentication keys, routing codes, user IDs, hardware faults, and extended services lists.

88. A device, comprising:
a processor coupled to a memory;
a transceiver that wirelessly communicates with one or more other devices, wherein the device transmits and receives packets that include frames to the one or more other devices, the frames including request frames or response frames and that include:
a header that includes a protocol ID, a frame length, device flags, and a session ID;
a command code that includes an extension flag, a sleep flag, a routing type, and an opcode; and
a routing template consistent with the routing type.

89. The device of claim 88, wherein the routing type is one of a unicast routing, a multi-cast routing, a broadcast routing, or an anycast routing.

90. The device of claim 89, wherein the opcode indicates an inventory from device ID.

91. The device of claim 90, wherein
the request frame includes the header, the command code, and wherein the routing template can be appropriate for the unicast routing, the multi-cast routing, the broadcast routing, or the anycast routing.

92. The device of claim 90, wherein the response frame includes the header, the command code, and the routing template is appropriate for the unicast routing.

93. The device of claim 89, wherein the opcode indicates an inventory from UDB element.

94. The device of claim 93, wherein the request packet includes the protocol header, the command code, the routing template, and a UDB element ID.

95. The device of claim 93, wherein the response packet includes the protocol header, the command code, and the routing template is appropriate for the unicast routing.

96. The device of claim 89, wherein the opcode indicates a collection of UDB element.

97. The device of claim 96, wherein the request packet includes the protocol header, the command code, the routing template, a comparison UDB element ID, and a return UDB element ID.

98. The device of claim 96, wherein the response packet includes the protocol header, the command code, the routing template appropriate for the unicast routing, a UDB element ID, a UDB element length, and a UDB element data.

99. The device of claim 89, wherein the opcode indicates a collection of UDB type.

100. The device of claim 99, wherein the request template includes the protocol header, the command code, the routing template, a comparison UDB element ID, and a return UDB type code.

101. The device of claim 99, wherein the response template includes the protocol header, the command code, the routing template appropriate for the unicasts routing, a total UDB type length, a UDB element ID, a UDB element length, and a UDB element data.

102. The device of claim 89, wherein the opcode indicates an announcement of UDB element.

103. The device of claim 102, wherein the request frame includes the protocol header, the command code, the routing template, a UDB element ID, a UDB element length, and a UDB element data.

104. The device of claim 102, wherein the response frame includes the protocol header, the command code, and a routing template appropriate for the unicast routing.

105. The device of claim 89, wherein the opcode indicates an announcement of UDB type.

106. The device of claim 105, wherein the request frame includes the header, the command code, the routing template, a total UDB type, an UDB element ID, an UDB element length, an UDB element data.

107. The device of claim 105, wherein the response frame includes the header, the command code, and the routing template appropriate for the unicast response template.

108. The device of claim 89, wherein the opcode is a request data.

109. The device of claim 108, wherein the request frame includes the header, the command code, the routing template appropriate for the unicast routing, a data frame channel, an encapsulated protocol ID, and encapsulated protocol data.

110. The device of claim 108, wherein the response frame includes the header, the command code, the routing template appropriate for the unicast routing, a number of data frames, and a total data length.

111. The device of claim 110, wherein the response frame is followed by data frames consistent with the number of data frames and the total data length.

112. The device of claim 89, wherein the opcode is a propose data frame.

113. The device of claim 112, wherein the request frame includes the header, the command code, the routing template appropriate for the unicast routing or the multicast routing, a data frame channel, a number of data frames, a total data length, a encapsulated protocol ID, and encapsulated protocol data.

114. The device of claim 113, wherein the response frame includes the header, the command code, and the routing template appropriate for the unicast routing.

115. The device of claim 114, wherein the device receives a data packet consistent with the request frame.

116. The device of claim 89, wherein the opcode is an acknowledge data frame.

117. The device of claim 116, wherein the request frame includes the header, the command code, the routing template, a data frame channel, a number of damaged frames, and a list of damaged frame IDs.

118. The device of claim 116, wherein the response packet includes the header, the command code, the routing template appropriate for the unicast routing, the number of data frames, and the total data length and is followed by data frames consistent with the number of data frames.

119. The device of claim 89, wherein the opcode is an authentication request.

120. The device of claim 119, wherein the request frame includes the header, the command code, the routing template, a key lifetime, and a key protocol data.

121. The device of claim 119, wherein the response frame includes the header, the command code, the routing template appropriate for the unicast response, and key protocol data.

122. The device of claim 89, wherein the request frame includes a UDB protocol command structure, the UDB protocol command structure includes a command code, a data offset, a data length, and data elements.

123. The device of claim 122, wherein a corresponding UDB protocol command structure includes the command code.

124. The device of claim 89, wherein the request frame is a UDB protocol command structure and further includes a command code, a data offset, a data length, and data elements.

125. The device of claim 89, wherein the request frame is a UDB element data group and further includes an element ID, element privileges, element length, element offset, and element data.

126. The device of claim 89, wherein the request frame is a UDB type data group and further includes a type code, type code privileges, type string length, type string offset, and type string data.

127. The device of claim 89, wherein the request frame is a UDB privileges data group and further includes an element ID and privileges.

128. The device of claim 89, wherein the request frame is an RDB protocol command structure and further includes an RDB command code, an element ID, and sector data descriptors.

129. The device of claim 89, wherein the request frame is a RDB protocol command structure and further includes an RDB command code and RDB element IDs.

130. The device of claim 89, wherein the request frame is an RDB element data group and further includes an element ID, element privileges, a sector offset, a sector length, and sector data.

131. A method of activating a RFID device from a sleep state, comprising:
receiving a wake-on signal on a wake-on radio;
transitioning the RFID device to a listen state or a transmit state in response to the wake-on signal.

132. The method of claim 131, wherein the wake-on signal is detection of a wake-up frame upon periodic scanning of one or more transport channels, and further including:
determining a time duration until receipt of a request frame from data received in the wake-up frame;
napping for the time duration;
transitioning to a listen state.

133. The method of claim 132, wherein the data received in the wake-up frame is a count-down integer indicating the number of wake-up frames yet to be sent and determining the time duration includes calculating the time duration based on the number of wake-up frames yet to be sent and a duration of each wake-up frame.

134. The method of claim 131, wherein the wake-on signal is detection of a sensor alarm, and further including:
transitioning to a transmit state;
transmitting an unsolicited request frame reporting the sensor alarm.

135. The method of claim 131, wherein the wake-on signal is a scheduled time determined by comparing a real-time clock with a schedule.

136. A method of activating an RFID device from a hold state, comprising:
transitioning to a listen state if the hold state is asynchronous and a previous state was a transmit or receive state;
transitioning to an idle state if the hold state is asynchronous and the previous state was a listen state;
transitioning to a listen state if the hold state is asynchronous and a timeout condition has occurred or transitions to an idle state if the hold state is synchronous and the timeout condition has occurred;
transitioning to a transmit state if a hold period has expired and the hold state is synchronous; and
transitioning to a listen state if a hold period has expired and a wake-up frame is detected.

137. A method of performing a dialog between a requesting RFID device and one or more responding RFID devices, comprising:
the requesting RFID device providing a chain of wake-up packets and transmitting a request frame in a request packet on one of a plurality of transport channels;
the responding RFID devices activating upon receipt of a wake-up frame from the chain of wake-up packets and receiving the request packet;
the responding RFID devices each transmitting a response packet to the requesting RFID device.

138. The method of claim 137, further including the responding RFID devices transmitting a data packet to the requesting RFID device.

139. The method of claim 137, wherein the chain of wake-up packets include a plurality of wake-up packets, each of the wake-up packets including a wake-up frame that provides an indication of the time in which the request packet will arrive.

140. The method of claim 139, wherein the indication includes a count-down integer indicating the number of wake-up packets yet to be received.

141. The method of claim 137, wherein the request packet in includes a request frame that provides instructions to the responding RFID device regarding how to respond and providing an indication of which of a number of RFID devices are responding RFID devices.

142. The method of claim 141, wherein the request frame identifies a unicast routing where a single responding RFID device based on an ID of the RFID device to be the responding RFID device.

143. The method of claim 141, wherein the request frame identifies a multicast routing where a plurality of single responding RFID devices based on a data element stored in the responding RFID devices, wherein responding devices and further including synchronously arbitrating transmission of response frames from each of the responding RFID devices.

144. The method of claim 141, wherein the request frame identifies an anycast routing where a plurality of single responding RFID devices based on a data element stored in the responding RFID devices and further including asynchronously arbitrating transmission of response frames from each of the responding RFID devices.

145. The method of claim 141, wherein the request frame identifies a broadcast routing, where all of the available RFID devices are identified as responding RFID devices, and further including asynchronously arbitrating transmission of response frames from each from the responding RFID devices.

146. The method of claim 145, wherein asynchronously arbitrating transmission of response frames, comprises:
choosing a potential transport channel from the plurality of transport channels;
performing a first check on the potential transport channel to determine whether it is clear;
if the potential transport channel is clear, waiting a set time and performing a second check on the potential transport channel;
if the second check on the potential transport channel is clear, then clearing the state and allowing transmission on the potential transport channel; and
if either the first check or the second check is not clear, waiting a period of time, choosing a different potential transport channel.

147. The method of claim 143, wherein synchronously arbitrating comprises:
from a listen state, listening for an arbitrator request;
performing a mask compare to determine if the responding RFID device is to respond in a next window and, if not, returning to the listen state;
performing a first check on the potential transport channel identified in the arbitrator request to determine whether it is clear;
if the potential transport channel is clear, waiting a set time and performing a second check on the potential transport channel;
if the second check on the potential transport channel is clear, then clearing the state and allowing transmission of a response frame on the potential transport channel; and
if either the first check or the second check is not clear, waiting a period of time, returning to the listen state.

148. A method of receiving data from a responding device, comprising:
sending a request frame to the responding device;
receiving a response frame from the responding device;
receiving one or more data frames from the responding device; and
acknowledging receipt of the one or more data frames.

149. The method of claim 148, wherein the acknowledging receipt indicates defects in the one or more data frames and further including:
receiving one or more corrected data frames from the responding device; and
acknowledging receipt of the one or more corrected data frames.

150. A method of transmitting data to a responding device, comprising:
sending a request frame to the responding device;
receiving a response frame from the responding device;
sending one or more data frames to the responding device; and
receiving an acknowledgement from the responding device.

151. A method of communicating with another device, comprising:
defining one or more transport channels as combinations of a plurality of physical channels; and
transmitting or receiving signals on the one or more transport channels.

152. A method of operating a low power device, comprising:
operating in one of one or more regimes, the one or more regimes chosen from the group consisting of a gateway regime, a subcontroller regime, and an endpoint regime.

153. The method of claim 152, wherein operating in the endpoint regime includes
transitioning from a sleep state to a listen state on a wake-on event;
transitioning from the listen state to a receive state if a wake-up frame is detected or the RFID device is expecting a request frame and otherwise transitioning to the sleep state;
transitioning from the receive state to the transmit state after receiving a request frame and formulating a response frame for transmission, and otherwise transitioning to the sleep state; and
transitioning from the transmit state to a hold state upon instructions received in the request frame.

154. The method of claim 152, wherein operating in the subcontroller regime includes
transitioning from a hold state to a listen state upon receipt of a wake-on event;
transitioning from the hold state to a transmit state in order to transmit a request frame;
transitioning from the listen state to a receive state in response to detection of an incoming frame;
transitioning from the receive state to the transmit state if the incoming frame is a request frame to transmit a response frame;
transitioning from the receive state to the hold state if the incoming frame is a response frame;
transitioning from the transmit state to the listen state if an outgoing request frame is transmitted; and
transitioning from the transmit state to the hold state upon completion of a dialog with another device.

155. A method of claim 152, wherein operating in the gateway regime includes:
transitioning from a listen state to a receive state upon receipt of a response frame;
transitioning from the listen state to a transmit state to transmit a request frame; and
transitioning from the transmit state to the listen state after transmission of the request frame.

156. A method of communicating with a device, comprising:
exchanging packets from the device, the packet including a preamble, a header that includes a sync and frame info, and a frame.

157. The method of claim 156, where exchanging packets includes transmitting a request packet and receiving a response packet from the device.

158. The method of claim 156, wherein exchanging packets includes receiving a request packet and transmitting a response packet to the device.

159. The method of claim 156, wherein exchanging packets further includes transmitting or receiving data packets that includes one or more data frames.

160. The method of claim 156, wherein exchanging packets includes communicating data elements and further including storing data elements.

161. The method of claim 156, wherein exchanging packets includes transmitting a request packet that includes a command chosen from an inventory from device ID request, an inventory from UDB element; a collection of UDB element; a collection UDB type, an announcement of UDB element, an announcement of UDB type, a request data, a propose data, an acknowledge data frame, or an authentication.
